(19) United States
(12) Patent Application Publication
(10) Pub. No.: US 2003/0081769 A1
(43) Pub. Date: May 1, 2003

(54) Non-algebraic method of encryption and decryption

(76) Inventor: Jon W. Hamilton, Austin, TX (US)

Correspondence Address: ROBERTS ABOKHAIR & MARDULA, SUITE 1000, 11800 SUNRISE VALLEY DRIVE, RESTON, VA, 20191, US

(21) Appl. No.: 10/232,435

(22) Filed: Aug. 30, 2002

Related U.S. Application Data
(60) Provisional application No. 60/316,020, filed on Aug. 31, 2001.

(51) Int. Cl. H04L 9/00

(52) U.S. Cl. 380/28

(57) ABSTRACT

A non-algebraic method of encrypting and decrypting data. A cryptographic algorithm based on the properties of certain nonlinear equations is used to encrypt and decrypt data without algebraic computations. In particular, the present invention utilizes those nonlinear equations for which the solution space includes attractors to obtain intractable quantities and then operates on clear text data and the intractable quantities to produce secure cipher text. Data needed or desirable for decryption are retained during the encryption process, thus optimizing the decryption process of the present invention.

### CROSS REFERENCE TO RELATED APPLICATIONS

This application claims priority under 35 U.S.C. §119(e) from provisional application No. 60/316,020, filed Aug. 31, 2001. The No. 60/316,020 provisional application is incorporated by reference herein, in its entirety, for all purposes.

### FIELD OF INVENTION

The present invention relates generally to data protection. More particularly, the present invention relates to a method for protecting digital data by a non-algebraic method of encryption and decryption.

### BACKGROUND OF THE INVENTION

The science of keeping messages and data secure is broadly referred to as cryptology. Once an art practiced by government agencies and a few academics, cryptology has become an essential element of the digital age. The reasons for this interest in cryptology result from the consequences of going digital. Advances in digital technology has enhanced our ability to distribute and store content in digital form. However, because digital data is readily transported and copied, it is inherently insecure in its raw form. Thus, to protect the content represented by digital data, a means of making the content inaccessible without interfering with the transportability or storage of the data must be found. The answer is to encrypt the digital data thus protecting the content represented by the data.

Cryptology has evolved with personal computers, so it should not come as a surprise that the large majority of cryptology solutions are designed for a computer. In its current state, cryptology has developed cryptographic algorithms based on algebraic equations and mathematical operations that can be readily performed on a computer. Computational complexity of algorithms is sometimes measured in terms of the computing power needed to execute it for a given sized input. The larger the input, the slower the computation time. Algebraically strong algorithms, such as exponential algorithms, are not feasible for large data inputs.

Secure protection by a cryptographic algorithm means that it is not breakable by cryptanalytic techniques, which would allow one to decrypt the encrypted version without prior knowledge of the cryptographic key. A secure cryptographic algorithm that is not breakable can be attacked only by an exhaustive search of all combinations of its cryptographic keys, i.e., the “brute force attack”. In this method of attack, adversaries use all combinations of the cryptographic key together with knowledge of the cryptographic algorithm and encrypted text.

One approach to securing an algorithm is to increase the key length to increase the number of possible combinations of keys that must be attempted in a brute force attack. The current “gold standard” for the length of a cryptographic key to protect financially sensitive data is 128 bits. Wideband data protected by a secure 128 bit cryptographic algorithm requires an adversary to examine over 3.4×10³⁸ potential keys. This is not technically feasible now, and is unlikely to be feasible within the next ten years given the current rate of progress in digital data processing systems.

In the algebraic cryptographic world, the cryptographic process is optimized on the speed of the encryption function. Additionally, the size of the block of data is generally limited to the key length to enhance the security of the encrypted data by reducing the possibility of redundancies and statistical relationships between the data being encrypted (the plaintext) and the encrypted output (the ciphertext). These two limitations of the algebraic approach to encryption of data must be overcome when protecting large bandwidth blocks of data that must be decrypted in real-time. To give this observation perspective, if the content of a video produced by a digital video camera were encrypted using a 128-bit key, to match the quality of the unencrypted content would require a decryption speed on the order of 10⁷ bits per second. An HDTV-quality image encrypted with a 128-bit key would require a decryption speed of between 10⁷ and 10⁸ bits per second. A digital movie of theater-quality so encrypted would require at least 5×10⁹ bits per second decryption speed and probably closer to 10¹⁰ bits per second. Today, assuming a 128-bit key, the best encryption speed is about 2×10⁸ bits per second and the best decrypt speed is about 2×10⁷ bits per second. For this reason, large digital files are not encrypted, the key length is kept short to increase speed, or the key to decrypt them is entrusted to a third party.

Additionally, commercially available algorithms fail to be block cipher cryptographic algorithms with the appropriate feedback cipher characteristics. Wideband digital data has a high entropic value that requires block cipher encryption as opposed to streaming cipher encryption. In the streaming cipher approach, every block is encrypted in the same manner. Thus, for example, ‘cat’ is always encrypted to be ‘dog’. With wideband digital data, especially imagery data, this gives the cryptanalyst a large choice of clear text versus encrypted text. The result is that a skillful cryptanalyst can use this information to substantially reduce the cryptographic key space, that is, the number of cryptographic keys that need to be considered.

What is needed is a very secure method for encrypting and decrypting both small and large blocks of digital data using a non-algebraic algorithm wherein block size is not limited to the length of the key, wherein the decryption process can, if desired, be optimized for real-time usage, and wherein the speed of decryption can approach at least 10¹¹ bits per second assuming a key length of 128 bits.

### SUMMARY OF THE INVENTION

An embodiment of the present is a secure method of encrypting and decrypting digital data using a non-algebraic algorithm.

It is an object of the present invention to provide a secure method for the encryption and decryption of digital data using a non-algebraic algorithm.

It is a further object of the present invention to have variable cryptographic key lengths of from 128 bits to 2048 bits.

It is yet another object of the present invention to encrypt and decrypt at speeds at least 10 times faster than algebraic cryptographic algorithms with a cryptographic key length of 128 bits.

It is yet another object of the present invention to encrypt and decrypt at speed in excess of 10¹⁰ bits per second, using a custom hardware implementation.

It is yet another object of the present invention to use a block cipher cryptographic algorithm with feedback cipher products in the generation of encrypted text data and in the generation of exchanged cryptographic keys.

It is yet another object of the present invention to uniquely use systems of nonlinear differential equations with strange attractors in their solution space as a nonlinear mathematically intractable segment of its cryptographic engine for both encryption and decryption.

It is yet another object of the present invention for the methods of encryption and decryption to be designed for the implementation within a non von Neumann processor system architecture. A non von Neumann processor architecture for a processor or custom chip based implementation of the present invention will allow the implementation to take full advantage of the inherent parallelism within the present invention's cryptographic algorithms.

These and other objectives of the present invention will become apparent from a review of the general and detailed descriptions that follow.

A secure method of protecting digital data embodied according to the present invention uses nonlinear equations and analysis, instead of the algebraic equations, to generate cipher products to encrypt digital data. Certain classes of these equations have properties referred to as “attractors” that evolve from nonlinear differential equations, nonlinear partial differential equations, and nonlinear difference equations. “Routes” generated by a route constructor using random numbers are used to determine a time history along a trajectory of an attractor. The route parameters are computed for a specific route by using the time domain history contained in a route to find solution points on an attractor. These solution points are unique and intractable. In an algebraic algorithm, the intractable quantity is typically calculated using nonlinear algebraic operations over fields of polynomials. In the present invention, the intractable quantity is derived using mathematical analysis, which analysis can be performed prior to the encryption of the clear text data.

These solution points are used as cipher products in the encryption/decryption process. In an embodiment of the present invention, the encryption engine of the present invention performs simple XOR operations on the data to be encrypted, a cryptographic key and the cipher products to produce encrypted text. Unlike the computations required by the algebraic algorithms of the current art, the XOR operation is inherently fast and resource efficient. In an embodiment of the present invention, the solution points are precalculated prior to the encryption and/or decryption process thus enhancing the speed of those processes. In another embodiment of the present invention, speed is further enhanced by partitioning the unencrypted data into blocks and operating on each block simultaneously. Thus, the present invention provides a method of encryption and decryption that does not rely on algebraic algorithms, is inherently secure, open to variable key and block size, and extremely fast.

In an embodiment of the present invention, two cryptographic keys are used. A primary cryptographic key is used to generate a file of exchanged primary cryptographic keys. An ancillary cryptographic key is used to create a file of exchanged ancillary cryptographic keys. The exchanged primary cryptographic key is used in the encryption process in the encryption engine segment of the process and in a linear smoothing segment. The exchanged ancillary cryptographic keys are used in deriving the route parameters of the nonlinear equations that in turn are used in conjunction with the exchanged primary key in the encryption process performed by the encryption engine segment and used to encrypt ancillary data. Ancillary data is data that is generated during the encryption process that is necessary for the decryption process. In this embodiment of the present invention, the exchanged primary and ancillary cryptographic key files are precalculated, thus enhancing the speed of the encryption/decryption processes.

The encryption process operates on clear data (unencrypted). A nonlinear cryptographic engine segment (ES) operates on the clear data to produce encrypted data or cipher text. The ES also utilizes an exchanged primary cryptographic key stored in the file of exchanged cryptographic keys and the route parameters. In an alternate embodiment of the present invention, ancillary data generated during the encryption process is stored for use in the decryption process. In another embodiment of the present invention, the ancillary data is encrypted using an exchanged ancillary cryptographic key and stored in an encrypted data file.

In an embodiment of the present invention, prior to encryption, the clear data is partitioned into blocks of extended data. The extended data blocks are subjected to a first linear smoothing segment and a first nonlinear smoothing segment. (“Smoothing” improves the entropy of the algorithm.) Following the ES process, the encrypted data is subjected to a second linear smoothing segment) and a second nonlinear smoothing segment. The resulting in encrypted extended block data.

The decryption process reverses the encryption process to arrive at the original clear text. The ancillary data is obtained (and is decrypted if previously encrypted) and the data necessary for decryption is captured. In particular, the route parameters used in the encryption process are extracted and used in the decryption process.

The decryption process begins with the input of the encrypted data files. The cryptographic engine for the decryption process, denoted DS, corresponds to ES. If the smoothing processes were used, then the processes are reversed with the second linear and non-linear smoothing processes performed before decryption and the first linear and non-linear smoothing processes performed after decryption. Further, the nonlinear cryptographic engine segment used in the decryption segment, “DS”, uses a nonlinear function that “reverses” the function used in the encryption segment, “ES”.

### BRIEF DESCRIPTION OF THE DRAWINGS

FIGS. 1A and 1B are a block diagram illustrating an encryption method for wideband data.

FIG. 2 is a block diagram illustrating an cryptographic keys and their nomenclature that are used in an encryption method for wideband data.

FIG. 3 is a block diagram illustrating the concepts of block data, extended block data, and frame data for an encryption method.

FIG. 4 is a block diagram illustrating a protocol for an exchange of cryptographic keys within an encryption method for wideband data.

FIG. 5 is an illustration of Lorenz strange attractors that are solutions to the Lorenz system of nonlinear differential equations that are used in the encryption method according to one embodiment of the present invention.

FIG. 6 is a block diagram for an ancillary data encryption method of the encryption method for wideband data.

FIG. 7 is a block diagram illustrating nonlinear feedback shift registers.

FIG. 8 is flow diagram illustrating the processing of the ES module of an encryption method.

FIGS. 9A and 9B are a block diagram illustrating a decryption method for wideband data.

FIG. 10 is a block diagram illustration a decryption method for ancillary data.

FIGS. 11A and 11B are a block diagram illustrating an encryption method according to one embodiment of the present invention.

FIG. 12 is a flow diagram illustrating the generation of seed data according to one embodiment of the present invention.

FIGS. 13A and 13B are a flow diagram illustrating the generation of exchanged primary cryptographic keys according to one embodiment of the present invention.

FIGS. 14A and 14B are a flow diagram illustrating the generation of exchanged ancillary cryptographic keys according to one embodiment of the present invention.

FIG. 15 is a flow diagram illustrating the processing of the random number generator according to one embodiment of the present invention.

FIGS. 16A and 16B are a flow diagram illustrating the processing of the route constructor module according to one embodiment of the present invention.

FIGS. 17A, 17B, 17C, and 17D are a flow diagram illustrating the processing of the Runge-Kutta method of numerical integration according to one embodiment of the present invention.

FIG. 18 is a flow diagram illustrating the generation of route parameters according to one embodiment of the present invention.

FIGS. 19A and 19B are flow diagram illustrating the processing of the ancillary data encryption module according to one embodiment of the present invention.

FIGS. 20A, 20B, 20C, 20D, 20E, 20F, 20G, and 20H are a flow diagram illustrating the processing of the encryption mode's cryptographic engine according to one embodiment of the present invention.

FIG. 21 is a block diagram illustrating the permutation transformation, σELS1, according to one embodiment of the present invention.

FIG. 22 is a block diagram illustrating the bit nomenclature used in the discussions of the encryption method.

FIG. 23 is a block diagram illustrating the rotational transformation, ρELS1, according to one embodiment of the present invention.

FIG. 24 is a block diagram illustrating the nonlinear feedback shift register, τ_{ENLS1}, according to one embodiment of the present invention.

FIG. 25 is a block diagram illustrating the rotational transformation, ρENLS1, according to one embodiment of the present invention.

FIG. 26 is a block diagram illustrating the permutation transformation, σELS2, according to one embodiment of the present invention.

FIG. 27 is a block diagram illustrating the rotational transformation, ρELS2, according to one embodiment of the present invention.

FIG. 28 is a block diagram illustrating the nonlinear feedback shift register, τENLS2, according to one embodiment of the present invention.

FIG. 29 is a block diagram illustrating the rotational transformation, ρENLS2, according to one embodiment of the present invention.

FIGS. 30A and 30B are a block diagram illustrating the details of the decryption mode according to one embodiment of the present invention.

FIGS. 31A, 31B, 31C and 31D are a flow diagram illustrating the processing of the ancillary data decryption module of the encryption method according to one embodiment of the present invention.

FIGS. 32A and 32B are a flow diagram illustrating the processing of the protocol for the generation of exchanged primary cryptographic keys for the decryption mode according to one embodiment of the present invention.

FIGS. 33A and 33B are a flow diagram illustrating the processing of the protocol for the generation of exchanged ancillary cryptographic keys for the decryption mode according to one embodiment of the present invention.

FIG. 34 is a flow diagram illustrating the processing of the random number generator module for the decryption mode of the encryption method according to one embodiment of the present invention.

FIG. 35 is a block diagram of the decryption cryptographic engine according to one embodiment of the present invention.

FIG. 36 is a flow diagram illustrating the processing of the DNLS2 module of the decryption method according to one embodiment of the present invention.

FIG. 37 is a block diagram illustrating the rotational transformation, ρDNLS2, according to one embodiment of the present invention.

FIG. 38 is a block diagram illustrating the nonlinear feedback shift register, τDNLS2, according to one embodiment of the present invention.

FIG. 39 is a flow diagram illustrating the processing of the DLS2 module of the decryption method according to one embodiment of the present invention.

FIG. 40 is a block diagram illustrating the rotational transformation, ρDLS2, according to one embodiment of the present invention.

FIG. 41 is a block diagram illustrating the permutation transformation, σDLS2, according to one embodiment of the present invention.

FIG. 42 is a flow diagram illustrating the processing of the DNLS1 module of the decryption method according to one embodiment of the present invention.

FIG. 43 is a block diagram illustrating the rotational transformation, ρDNLS1, according to one embodiment of the present invention.

FIG. 44 is a block diagram illustrating the nonlinear feedback shift register, τDNLS1, according to one embodiment of the present invention.

FIG. 45 is a flow diagram illustrating the processing of the DLS1 module of the decryption method according to one embodiment of the present invention.

FIG. 46 is a block diagram illustrating the rotational transformation, ρDLS1, according to one embodiment of the present invention.

FIG. 47 is a block diagram illustrating the permutation transformation, σDLS1, according to one embodiment of the present invention.

### DETAILED DESCRIPTION OF THE INVENTION

A method of encrypting and decrypting digital data embodied according to the present invention uses the properties of certain nonlinear equations. In one embodiment of the present invention, a method of encryption and decryption uses the properties of nonlinear differential equations to achieve hard security (keys of at least 128 bits) and fast processing speeds (speeds in excess of 10⁷ bits per second).

The present invention employs a mathematical approach to real time protection of content of wideband digital data. For the sake of clarity, a general overview of several embodiments according to the present invention is provided. These embodiments use a strong cryptographic algorithm and comprise both an encryption process and a decryption process. Each of these processes will be discussed separately.

The description of the present invention that follows utilizes a number of terms and phrases the definitions of which are provided below for the sake of clarity and comprehension.

Ancillary data—data that is saved during the encryption process that is necessary or desirable for the decryption process. Ancillary data comprises seed data; random numbers; parameters from the solution of the non-linear differential equations; and route construction data.

Attractor—a topologically closed set which has the following properties: (1) A is an invariant set, any trajectory x(t) that begins in A stays in A for all t>0; (2) A attracts an open set of initial conditions, in that there exists an open set U containing A such that if x(0) is in U, then the metric distance from x(t) to A tends to 0 as t approaches infinity(A attracts all trajectories that start sufficiently close to it), with the largest such open set U called the basin of attraction; and (3) A is minimal in that there is no proper subset of A that satisfies both conditions (1) and (2).

Clear text (or clear data)—raw data that has not been encrypted.

Cyphertext—data that has been encrypted.

Exogenous seed data (or seed data)—data used to initialize a pseudo random number generator.

Feedback cipher product—a product of the process of encryption that is used in a subsequent encryption process

Liapunov exponent—an exponent that measures the strength of the exponential convergence of two trajectories in phase-space.

Lorenz strange attractor—a strange attractor associated with a Lorenz equation.

Non-tractable (or intractable)—a problem for which no algorithm can exist that computes all instances of it in polynomial time.

Routes—a sequences of numbers which comprise a time history along a trajectory of a strange attractor.

Route parameter—solution points on a strange attractor.

Route constructor—a process by which cipher bits for each clear text bit are selected from intersections of a route with a pre-computed strange attractors. A route constructors uses secure pseudo random number generators and seed data to generate routes whose independent variable is t, the time domain

Smoothing segment—an operation performed on digital data that results in improved entropy when such data is encrypted.

Solution space—a set of solutions to a non-linear equation that comprises strange attractors.

Strange attractor—an attractor that has a sensitive dependence on initial conditions, in the strict sense that nearby trajectories separate exponentially and therefore the system that produced them has a positive Liapunov exponent.

Trajectory—a path along a strange attractor.

XOR—the exclusive “OR” operation. The XOR function is a standard operation on bits and produces the following results:

0 XOR 0=0

0 XOR 1=1

1 XOR 0=1

1 XOR 1=0

XORing or XORed—the verb form of XOR, meaning to apply the XOR operation to a set of bits.

### Overview of the Encryption Process

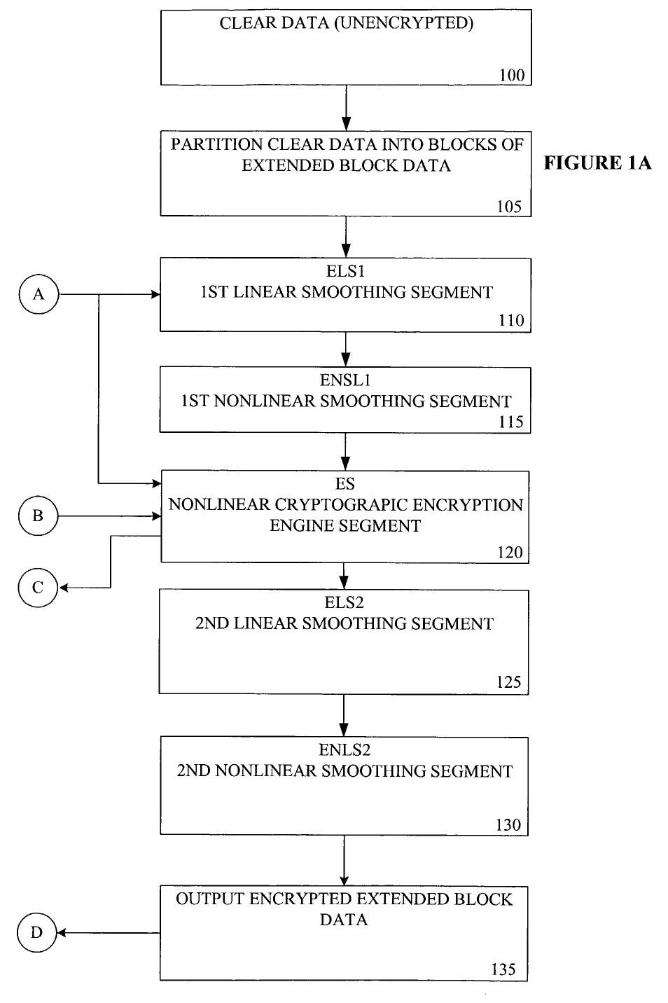

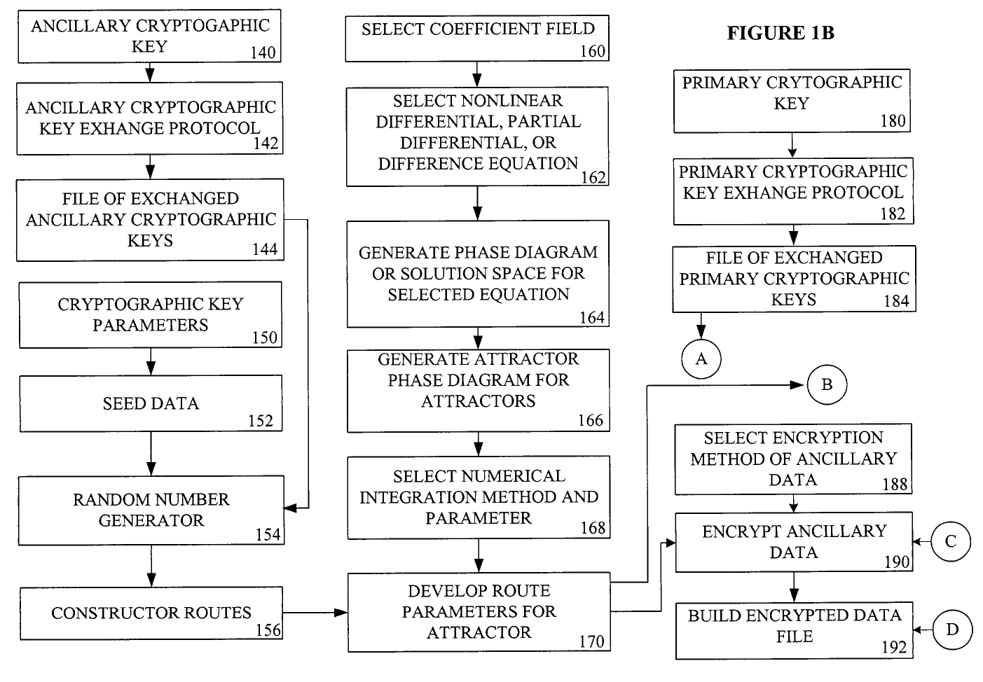

FIGS. 1A and 1B illustrate an overview of a process for encryption according to the present invention. Referring to FIG. 1A, the major processing functions are illustrated. Referring to FIG. 1B, the generation of the data used in the encryption process are illustrated. Each of these processing functions is described in greater detail below.

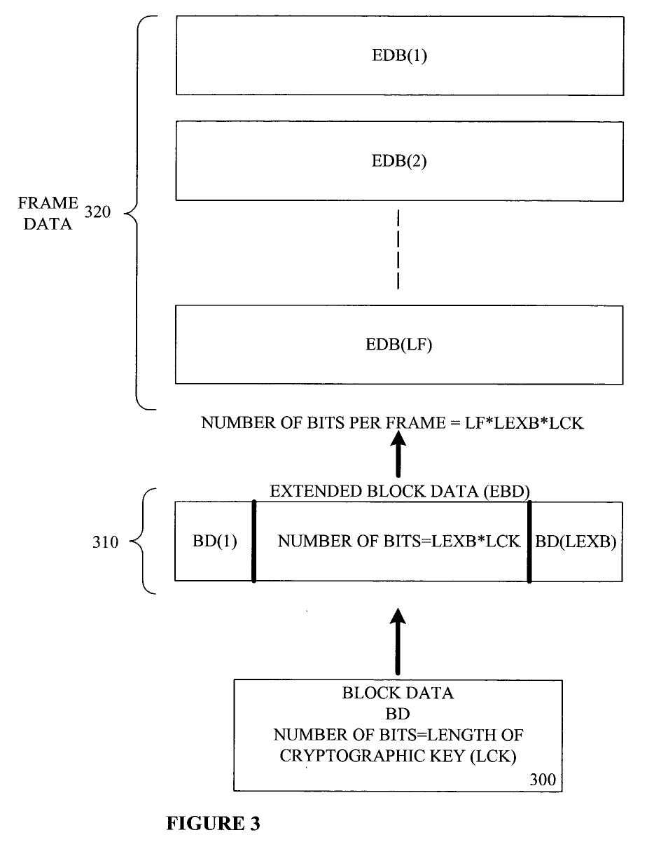

In an embodiment of the present invention, clear text data (unencrypted) 100 is partitioned into blocks of extended data 105 (extended data blocks are described in detail below in reference to FIG. 3). The extended data blocks are subjected to a first linear smoothing segment 110 (ELS1) and a first nonlinear smoothing segment 115 (ENSL1). Referring to FIG. 1B, the ELS1 segment utilizes an exchanged primary cryptographic key that was generated from a primary cryptographic key 180 using a primary cryptographic key protocol 182 and stored in a file of exchanged cryptographic keys 184.

It should be noted that the partitioning and smoothing functions are optional and may be omitted. Where smoothing is not performed, the clear data is directed to a nonlinear cryptographic engine segment (ES) 120 without further processing.

Where partitioning and smoothing are performed, following the ELS1 and ENSL1 segments, the nonlinear cryptographic engine segment (ES) operates on the partitioned data 120. Referring to FIG. 1B, ES utilizes an exchanged primary cryptographic key stored in the file of exchanged cryptographic keys 184 and route parameters 170 to encrypt the smoothed data. Referring again to FIG. 1A, in an embodiment of the present invention, the output of ES is subjected to a second linear smoothing segment 125 (ELS2) and a second nonlinear smoothing segment 130 (ENLS). These segments produce encrypted extended block data 135. As previously noted, these processes are optional. In an implementation of the present invention in which the smoothing processes are omitted, the output of the ES is a block of encrypted data.

FIG. 1B illustrates additional processes that comprise the present invention. In an embodiment of the present invention, two cryptographic keys are use, a primary cryptographic key and an ancillary cryptographic key. In this embodiment, the keys are unique, however, this is not meant as a limitation. The two keys may be the same without exceeding the scope of the present invention. A file of exchanged ancillary keys 144 is created from an ancillary cryptographic key using an ancillary cryptographic key exchange protocol 142. A random number generator 154 utilizes an exchanged ancillary key and seed data 152 which in turn are derived from selected cryptographic key parameters 150.

As will be discussed below, an embodiment of the present invention utilizes solution spaces comprising “attractors” that evolve from nonlinear differential equations, nonlinear partial differential equations, and nonlinear difference equations. “Routes” are used to determine a time history along a trajectory of an attractor. A “route constructor” uses the random numbers from the random number generator to generate routes whose independent variable is “t”, the time domain. The route parameters are computed for a specific route by using the time domain history contained in a route to find solution points on an attractor. These solution points are combined to create cipher products that are utilized by ES to encrypt the clear data.

Referring to FIG. 1B, the route parameters 170 are determined by the output of the route constructor 156 and by the particular attractor selected. In this regard, a coefficient field 160 is selected, as is a nonlinear equation form 162. The solution space for the selected equation is determined 164 and an attractor phase diagram created 166. A numerical integration method and parameter are also selected 168. The route parameters are utilized by ES 120 along with an exchanged primary cryptographic key to encrypt the extended block data (see FIG. 1A) using an XOR operation.

Referring again to FIG. 1B, in an embodiment of the present invention, ancillary data is encrypted 190 and stored in an encrypted data file 192 along with the encrypted extended block data 135 (see FIG. 1A). The ancillary data is encrypted 190 according to an encryption method that has been selected 188. Encrypting the ancillary data is optional and such data may be stored without encryption if desired.

FIGS. 1A and 1B illustrate an embodiment of the present invention comprising a cryptographic key; cryptographic key exchange; attractor constructor; route constructor; ancillary data collector and encryption method; packaging of the encrypted text data together with the encrypted ancillary data; ELS1, the encryption linear smoothing for processing before the nonlinear cryptographic engine; ENLS1, the encryption nonlinear smoothing for processing before the nonlinear cryptographic engine; ES, the nonlinear cryptographic engine; ELS2, the encryption linear smoothing for processing for processing after the nonlinear cryptographic engine (ES); and ENLS2, the encryption nonlinear smoothing for processing after the nonlinear cryptographic engine (ES).

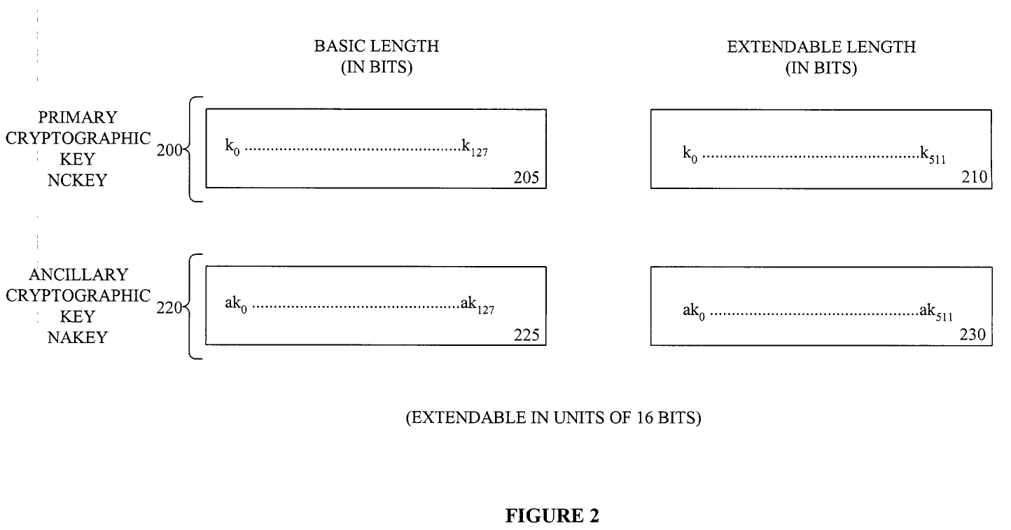

According to one embodiment of the present invention, two distinct cryptographic keys are used. These cryptographic keys are illustrated in FIG. 2. The primary cryptographic key 200 is used for the encryption of the clear text data. The ancillary cryptographic key 220 is used to encrypt ancillary data developed during the encryption process that are useful and necessary for the decryption of the encrypted data. In this embodiment of the present invention, both of the cryptographic keys are of the same length in terms of the number of bits (205, 225) and are extendable in units of 16 bits (210,230). The primary cryptographic key is denoted by NCKEY and the ancillary cryptographic key is denoted by NAKEY. In another embodiment, the cryptographic keys are variable from 128 bits to 2048 bits.

The cryptographic key is selected using a strong random number. The key selection process discards all “weak cryptographic keys”. This is a classical cryptographic technique that is widely used in the cryptographic community.

Directly associated with the length of the cryptographic keys is the concept of block data, extended block data, and frame data. In the current art of the present invention, the size of the block of clear text to be encrypted is limited to the length of the key used to encrypt the block. This limitation is imposed to reduce the likelihood of redundancies in the cipher text and to minimize statistical patterns between the clear text and the cipher text that could be exploited by cryptanalysts. The present invention is not, however, so constrained and both the key length and the block size may vary.

According to an embodiment of the present invention, the block data lengths for both the primary cryptographic and the ancillary cryptographic key are the same and equal to the length of the cryptographic keys. However, this is not a limitation. As illustrated in FIG. 3, the length of the block data in bits is denoted by LCK 300. The concepts of extended block data and frame data are only associated with the primary cryptographic key. An extended block data comprises a number of individual blocks of data 310. The number of these individual blocks of data that comprise an extended block of data is denoted by LEXB and is a constant. In this embodiment of the present invention, LEXB may vary, having admissible values from 1 to 128.

As is illustrated in FIG. 3, the number of bits contained in one extended block of data is calculated by the following equation:

Number of bits per extended block=LEXB*LCK

A frame of data 320 comprising a number of extended blocks of data as is also illustrated in FIG. 3. The number of these individual extended blocks of data that comprise a frame of data is denoted by LF. The maximum size of LF is dependent on the number of exchanged cryptographic keys that are generated securely by one pass through the cryptographic exchange key protocol. Referring again to FIG. 3, the number of bits contained in one frame of data is calculated by the following equation:

Number of bits per frame=LF*LEXB*LCK

In an embodiment of the present invention, a standard classical cryptographic key exchange is used to develop files consisting of exchanged primary cryptographic keys and exchanged ancillary cryptographic keys. These separate files are used in different segments of the present invention, including the encryption of each extended block encryption for the exchanged primary cryptographic keys and for blocks of ancillary data and route construction processing for the exchanged ancillary cryptographic keys. Techniques for secure cryptographic key exchanges are well known and are not central to the present invention. However, for completeness and understanding of the reading the following discussion presents an example for secure generation of cryptographic key exchanges.

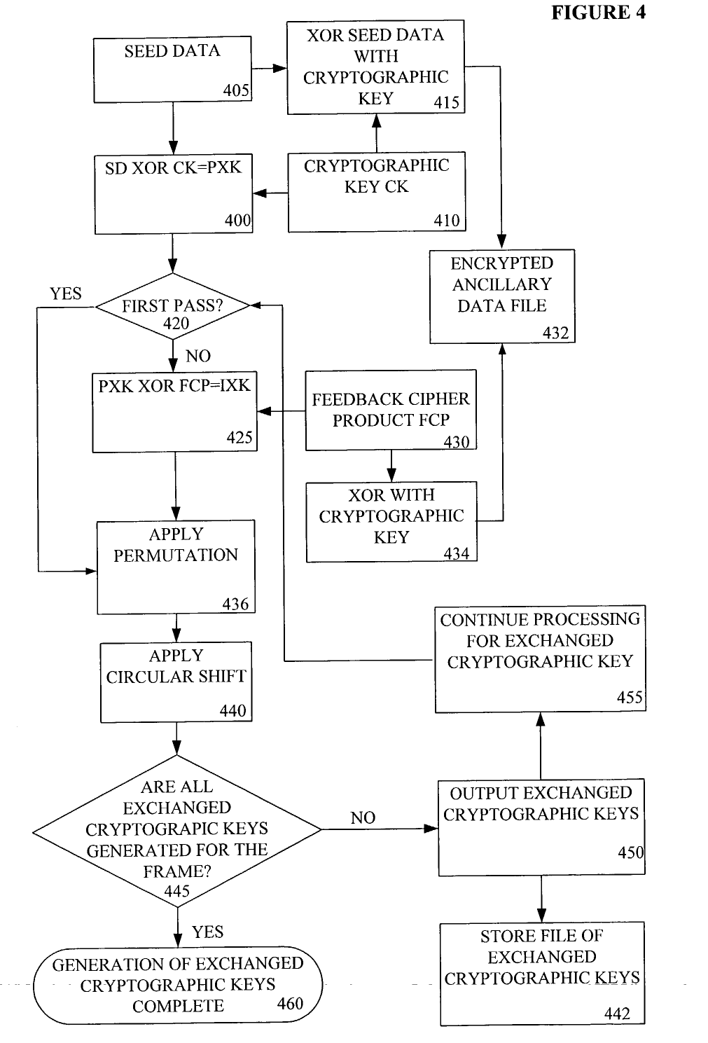

FIG. 4 illustrates a protocol for the generation of exchanged cryptographic keys utilized in an embodiment of the present invention. This process is useful for both the primary cryptographic key exchange and ancillary cryptographic key exchange. As FIG. 4 illustrates, in this embodiment there are three independent inputs to the exchange cryptographic key generation process. These inputs comprise seed data 405, a cryptographic key 410, and feedback cipher products 430. The seed data are exogenous. In an embodiment of the present invention, the seed data are based on the time of day of the initialization of the encryption process. As such they are dependent on the digital processor used to implement the present invention. As reflected in FIG. 4, the cryptographic key may be either the primary cryptographic key or the ancillary cryptographic key. In an embodiment of the present invention, the feedback cipher product differs between the primary cryptographic key and the ancillary cryptographic key. For the primary cryptographic key, the feedback cipher product is the last LCK bits in the previous frame that are encrypted. For the initial or first pass through the primary cryptographic key exchange protocol, the use of a feedback cipher product is omitted. For the ancillary cryptographic key exchange protocol, the feedback cipher product comprises the last LCK bits of cipher data before the next pass of the exchange key protocol. For the initial or first pass through the ancillary cryptographic key exchange protocol, the use of a feedback cipher product is also omitted.

The cryptographic key exchange protocol begins with the exclusive or (denoted by XOR) of the seed data and the cryptographic key 400. This is shown by the following equation, where SD is the seed data, CK is the cryptographic key, and PXK is the primary key exchange data.

PXK=SD XOR CK (3)

The iteration is checked to determine if it is the fist pass 420. If so, the feedback cipher product 430 is not used. After the first pass through the protocol, PXK is XORed with the feedback cipher product 425 to produce the initialization for the cryptographic key exchange,

IXK=PXK XOR FCP

The next step in the process is an iterative loop comprising a permutation 436 and then subsequently a circular shift of bits 440. Both of these procedures are discussed in detail below. Referring again to FIG. 4, at each iteration of this loop, an exchanged cryptographic key is outputted from the process 450 and stored in the file of exchanged cryptographic keys 442. The loop includes a check to determine if all the keys for the frame have been generated 445. If not, the process continues 455 until all of the new exchange cryptographic keys have been generated and stored that are appropriate for this frame of data (primary cryptographic key exchange protocol) and appropriate data encryption length for the ancillary cryptographic key exchange protocol 460. In addition to iterative loop process, the seed data and the cryptographic key are XORed 415 and stored in the ancillary data file 432. Similarly, the feedback cipher product is XORed with the cryptographic key 434 and stored in the ancillary data file. The FCP results from XORing the last exchanged cryptographic key with the cryptographic key.

An embodiment according to the present invention use solution spaces consisting of attractors that evolve from nonlinear differential equations, nonlinear partial differential equations, and nonlinear difference equations. Several types of these attractors have the mathematical characteristics that are useful for the cryptographic engine used in the present invention. The solution spaces consisting of these attractors are used as the primary source of nonlinear mathematically intractable functionality for the encryption process of the present invention. Specific examples include, but are not limited to, Rossler Attractors, Henon Attractors, and Lorenz strange attractors. For illustrative purposes, a discussion of the Lorenz equation, which is a nonlinear differential equation over the field of real numbers, is presented below.

The Lorenz equation has as its solution space Lorenz strange attractors. This Lorenz equation is expressed mathematically as follows:

\dot{x}=σ(y−x)

\dot{y}=rx−y−xz

\dot{z}=xy−bz

In the Lorenz equation, there are two sources of nonlinearity. These are the xy and the xz terms. The constant σ is called the Prandt1 number. The constant r is the Rayleigh number. The constant b is called the roll ratio. There is an important symmetry in the Lorenz equations of (x,y) with (−x,−y). Specifically if (x(t),y(t),z(t)) is a solution of the Lorenz equation if and only if (−x(t),−y(t),z(t)) is also a solution. The Lorenz system of nonlinear differential equations is also dissipative in the strict sense that volumes in the phase space contract under flow. It is also well known to mathematicians that there are no quasiperiodic solutions of the Lorenz system of nonlinear differential equations. There also exist only three fixed points. First, (0,0,0) is always a fixed point. Then for all Lorenz nonlinear differential equation systems with the condition that r>1, there are two other fixed points given by the following equation:

x*=y*=±\sqrt{b(r−1)},z*=r−1

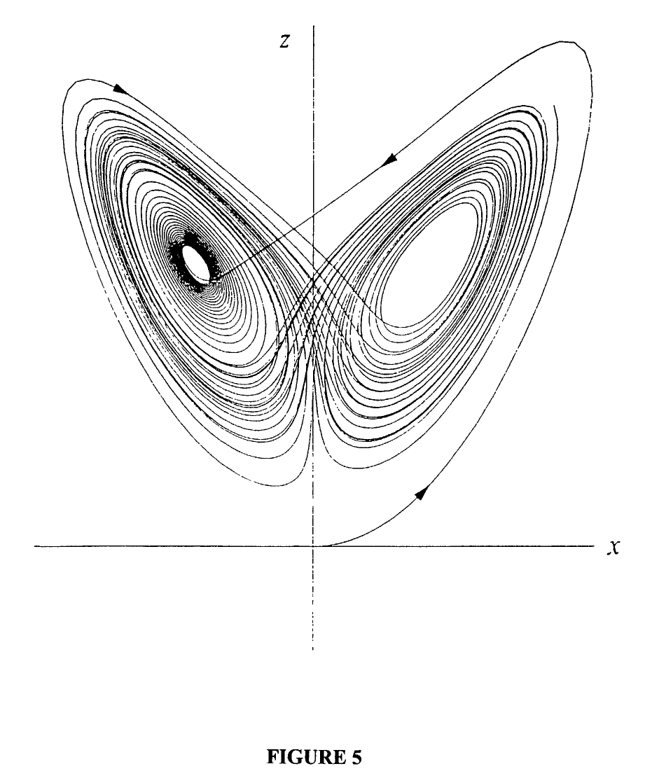

The solution space corresponding to the above referenced equation comprises Lorenz strange attractors that are illustrated for two dimensions in FIG. 5. The view of the Lorenz strange attractors illustrated in FIG. 5 actually comprises trajectories when x(t) is graphed against z(t). The Lorenz strange attractors are very sensitive and dependent on the initial conditions. This means that two trajectories that start very close together will rapidly diverge and possess strikingly different time and space histories. In fact neighboring trajectories will separate exponentially fast.

This background of the Lorenz system of nonlinear differential equations and their solution space of Lorenz strange attractors allows suitable attractors and systems of nonlinear differential equations, nonlinear partial differential equations, and nonlinear difference equations for the method of encryption to be identified.

As used in following description of an embodiment according to the present invention, “attractor” means a topologically closed set which has the following properties: (1) A is an invariant set, any trajectory x(t) that begins in A stays in A for all t>0; (2) A attracts an open set of initial conditions, in that there exists and open set U containing A such that if x(0) is in U, then the metric distance from x(t) to A tends to 0 as t approaches infinity(A attracts all trajectories that start sufficiently close to it), with the largest such open set U called the basin of attraction; and (3) A is minimal in that there is no proper subset of A that satisfies both conditions (1) and (2). The phrase “strange attractor” means an attractor that has a sensitive dependence on initial conditions, in the strict sense that nearby trajectories separate exponentially and therefore the system that produced them has a positive Liapunov exponent.

In an embodiment according to the present invention, the system of equations must be nonlinear. For example, the system of equations may be a system of nonlinear differential equations, a system of nonlinear partial differential equations, or a system of nonlinear difference equations, but this is not meant as a limitation. In this embodiment of the present invention, the largest Liapunov exponent of the system must be greater than 0, the system of equations is strictly deterministic in that the system has inputs that are stochastic, and the system of equations has long term aperiodic behavior in the following sense that there exist trajectories that do not settle into fixed points, periodic orbits, or quasiperiodic orbits as t approaches infinity. It is also a further condition of this embodiment that there is an open set of initial conditions that lead to aperiodic trajectories. Finally, regarding this embodiment, the solution space of the system of equations will contain a strange attractor.

Using the Lorenz equations as an example, an embodiment according to of the present invention is described. Referring again to FIG. 1B, the route constructor 156 constructors performs a precomputation, in the sense that the Lorenz strange attractors are computationally derived with sufficient resolution before the initiation of the enciphering process. This precomputation substantially reduces the overall processing burden of the encryption method, particular for large sized blocks of digital data. In this embodiment, the technique used for the precomputation of the strange attractors is numerical integration 168. There are several techniques for numerical integration that are well known to applied mathematicians. These include, but are not limited to, Runge-Kutta, Euler, and Heun. The selection of a specific type of numerical integration is dependent on the field over which the system of equations is defined, the resolution in bits of the solution space, and the error tolerance allowable. These parameters are specific to the implementation selected for the encryption process.

Routes are used by the encryption process to determine a time history along a trajectory of the strange attractor. The following equation illustrates a route for the encryption process.

RT(i)={t₀ⁱ, . . . ,tⱼⁱ, . . . ,t_{LC-1}ⁱ}

The sequences of numbers that comprise a route are generated by the route constructor 156.

The route constructors are used by the present invention to select cipher bits for each clear text bit from intersections of the routes with the pre-computed strange attractors. The route constructors use secure random number generators and seed data to generate routes whose independent variable is t, the time domain.

With the route determined, the route parameters associated with a specific route are computed 170. The time domain history contained in a route is used to find solution points on a strange attractor. These solution points determine the route parameters. They are illustrated and defined in the following equation:

RP(i)={(x(t₀ⁱ),y(t₀ⁱ),z(t₀ⁱ)), . . . ,(x(tⱼⁱ),y(tⱼⁱ),z(tⱼⁱ)), . . . ,(x(t_{LC-1}ⁱ),y(t_{LC-1}ⁱ),z(t_{LC-1}ⁱ))}

The ancillary data collector puts together all the seed, strange attraction parameters, and the route definitional parameters into one data set. In an embodiment of the present invention, this collected set of ancillary data is then encrypted using the ancillary encryptor. The set of ancillary data is then used for the decryption process of the present invention obviating the need to recompute the data so as to substantially decrease the time require to process and decrypt a block of enciphered data.

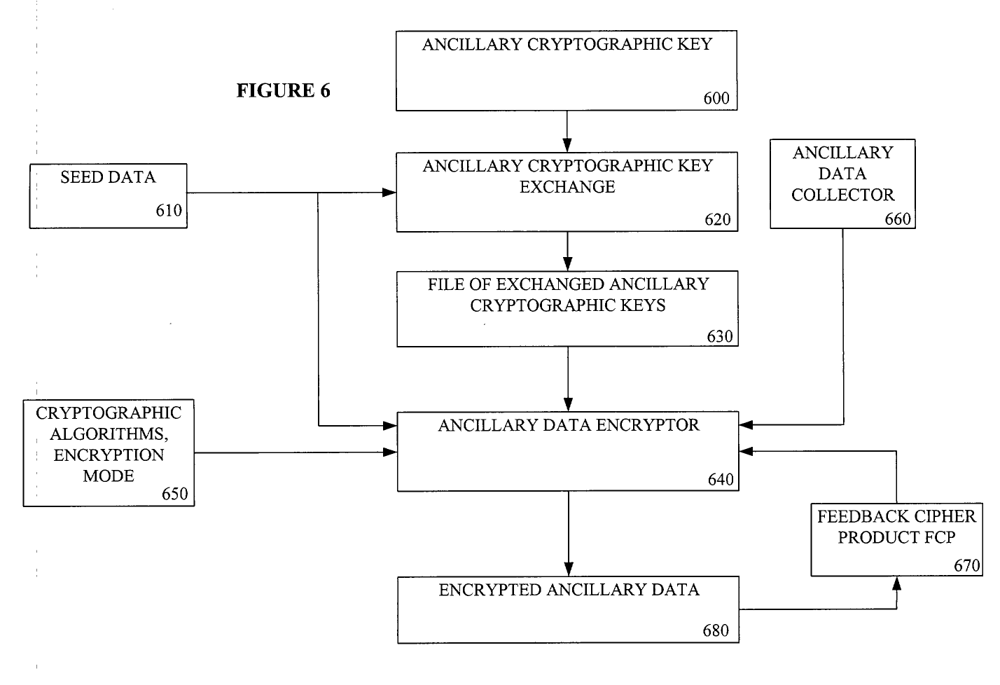

FIG. 6 illustrates a block diagram of a process for ancillary data encryption used in an embodiment of the present invention. External to this process, the ancillary cryptographic key 600 is processed by the ancillary cryptographic key exchange protocol 620 to generate and stored in a file 630 a sufficient set of exchanged ancillary cryptographic keys for use in the encryption of ancillary data. As part of this process, the ancillary cryptographic key exchange protocol requires seed data 610, which is obtained from the clock of the system processor. The selection of the specific cryptographic algorithm to encrypt the ancillary data depends on the implementation and the specific protocols required. This embodiment of the present inventions uses a secure cryptographic algorithm that has the same cryptographic key length as the primary cryptographic key and admits intermediate feedback cipher products into its encryption process for the ancillary data 670. This approach ensures the security of the cipher product while not requiring a specific level of entropy for the encryption process. Using an exchanged cryptographic key and a feedback cipher product, ancillary data from the ancillary data collector 660 is encrypted 640 and the output saved as encrypted ancillary data 680.

The ancillary encryption method is denoted in the sequel by E(AD). The seed data that is used in the initialization of the encryption method for ancillary data is encrypted and is further utilized in the protocols for the generation of the exchanged cryptographic keys for both the primary and ancillary keys.

Referring again to FIG. 1A, an embodiment of the present invention is illustrated wherein the encryption process comprises five modules: ELS1 110 is the linear presmoother; ENLS1 115 is the nonlinear presmoother; ES is the mathematically non tractable encryptor 120; ELS2 is the linear post smoother 125; and ENLS2 is the nonlinear post smoother 130.

Prior to the initiation of a computational process by the encryption cryptographic engine, the clear text data is inputted and partition into extended blocks of data 105. Near the end of a data file it is possible that insufficient bits would be available in the clear text data to form an extended block of data. In this case a bit stream of “0”s are appended to the far right hand side of the data to provide sufficient bits for an extended block of data.

ELS1 is the pre encryption linear smoothing process. In an embodiment of the present invention, ELS1 uses the next unused exchange primary cryptographic key from the exchange primary cryptographic key file and then XORs it with every block of data contained in the extended block of data. In this embodiment of the present invention, LEXB XORs are performed. The remaining segment of ELS1 comprises a loop of permutations and byte, nibble, or two bit shuffling. The number of loops is variable and adjustable to ensure the smoothness or evenness of the resultant entropy of the enciphering process. In the encryption method, the number of loops is denoted by N_{ELS1}, which is variable and dependent on the exact implementation of the encryption process.

The encryption process uses permutation transformations to effect both linear bit smoothing and entropic reductions. They are used only in the linear segments of the encryption method. The group of permutations on n symbols is well known and understood by those skilled in the art of the present invention. The group of permutations on n symbols comprises all of the bijective (into and onto) mapping of the set of n symbols into the set of n symbols. The group of permutations on n symbols is denoted by Sⁿ. For example the group of permutations on 128 symbols is denoted by S¹²⁸. Individual elements of the group of permutations on n symbols are represented by σ. The additive operation on Sⁿ is the composition of the mappings. Sⁿ consists of precisely n! objects or mappings.

An embodiment of the present invention uses rotation transformations to effect both linear bit smoothing and entropic reductions in both the linear and nonlinear segments of the encryption process. Rotation transformations are represented in the sequel by R. This embodiment of the present invention admits the use of three distinct types of rotation transformations. All three types of rotation transformations are coupled to the length in bits of the cryptographic key, which is denoted by NCKEY. All of the lengths of cryptographic keys admissible for the encryption method are powers of 2. That is NCKEY=2^{m}, where m is a positive integer. Furthermore, in this embodiment m must be equal or larger than 7. This produces cryptographic keys of at least 128 bits.

The three types of rotation transformations associated with the embodiment described above operate on data block sizes of length equal to the length of the cryptographic key, NCKEY. The first consist of byte rotations. Thus, a byte rotation transformation for this embodiment consists of precisely NCKEY/8 individual rotations. Each byte rotation simply exchanges subblocks of bytes throughout the length of the data block. It should be noted that each byte rotation transformation is simply an element of S^{NCKEY/8}. The second type of admissible rotation transformation is a nibble rotation. A nibble rotation transformation exchanges subblocks of nibbles throughout the length of the data block. The number of distinct nibble rotations contained in a single nibble rotation transformation is NCKEY/4. Therefore a nibble rotation transformation is a member of S^{NCKEY/4}. The third type of admissible rotation transformation for the encryption method is a 2-bit block rotation. This rotation transformation simply exchanges 2-bit blocks throughout the length of the data block. Therefore a 2-bit rotation transformation is a member of S^{NCKEY/2}.

The present invention also uses circular bit shift operations. The left circular bit shift operation, defined on a block of data of length M+1 bits and consisting of a circular left shift of n bits is defined by the following equation:

$$C = CL ( n ) ∘ B \{ \begin{matrix}{c}_{i} = {b}_{i - n} & for & 0 \leq i \leq M - n \\ {c}_{i} = {b}_{n - M + i - 1} & for & M - n + 1 \leq i \leq M\end{matrix} \}$$

The right circular bit shift operation, defined on a block of data of length M+1 bits and consisting of a circular right shift of n bits is defined by the following equation:

$$C = CR ( n ) ∘ B \{ \begin{matrix}{c}_{i} = {b}_{i - n} & for & n \leq i \leq M \\ {c}_{i} = {b}_{M - n + i + 1} & for & 0 \leq i \leq n - 1\end{matrix} \}$$

The purpose of the ELS1 module is linear pre-enciphering smoothing of the bits. This is a classical cryptographic technique and is well known in the art of the present invention.

The ENLS1 is the nonlinear pre-encipherment smoothing module. It employs a standard and classical cryptographic technique for the nonlinear smoothing of bits. The basic method for nonlinear smoothing comprises a nonlinear feedback shift register (NLFSR). This is a standard and classical technique employed in non-government cryptographic encryption methods. ENLS1 also comprises a rotation transformation, which may be a byte, nibble, or two-bit rotation. A loop is used to iterate first the nonlinear shift register and then the rotation. The number of iterations in this loop is variable dependent upon implementation and is denoted by N_{ENLS1}.

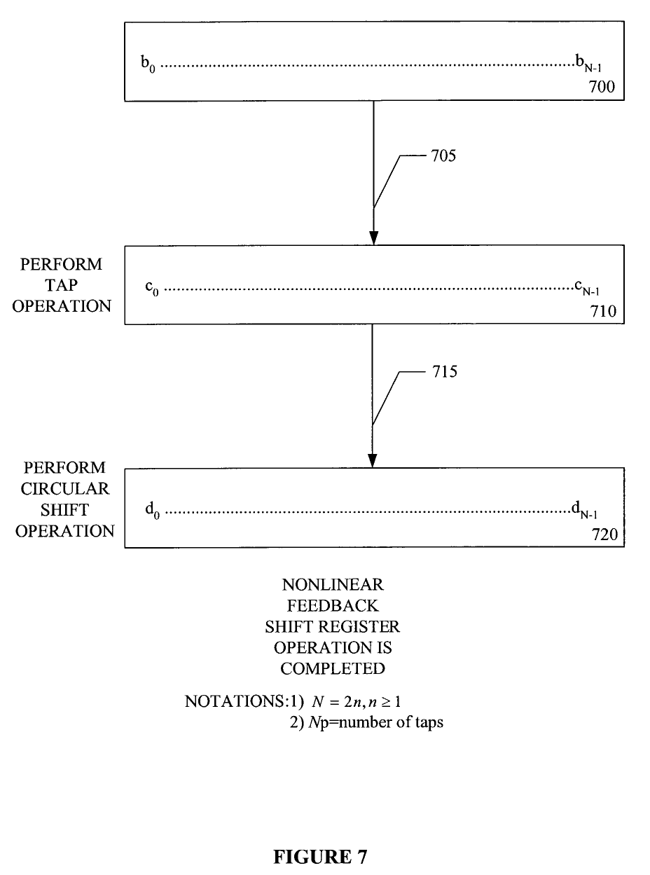

In an embodiment of the present invention, the encryption process uses nonlinear feedback shift registers to effect both nonlinear smoothing and entropic reduction. The nonlinear feedback shift registers are only used in the nonlinear smoothing segments of the present invention. FIG. 7 illustrates a general form of a nonlinear feedback shift registers used in this embodiment of the present invention. All nonlinear feedback shift registers are represented in the sequel by τ. As is illustrated by the figure, a block of data 700 is introduced into a nonlinear feedback shift register comprising two components: a tap operation 705; and a circular shift of bits 715. The parameters and functionality of both of these operations are variable and a wide spectrum of cases are admissible in the encryption methodology. The tap bits consist of Nₚ bits where the tap operations are performed. The tap bits are indexed in strictly ascending order from bit 0 to bit N−1 of the data block used in the nonlinear feedback shift register. Thus the tap bits are described by the following equation:

tap bits={0≦t₀<t₁< . . . <t₁< . . . <t_{N}_{ₚ}≦N−1}

Associated with each designated tap bit, is a distinct tap operation. Each tap operation comprises two subsets. One comprises mᵢ bits in the data word, aₖ upon which the tap operations are performed. The other comprises tap operations, Φₖ, which consist of logical arithmetic bit operations such as OR, AND, EXCLUSIVE OR, etc, and other admissible nonlinear operations involving just two bits. Thus the tap operations can be described the following equation:

φᵢ={φ_{i,0}, . . . ,φ_{i,m}_{ᵢ}}

Then the taps themselves are described by the following equation:

taps={(φ₀,{a_{0,0},. . . ,a_{0,m}_{₀}}),. . . , (φ_{N}_{ₚ},{a_{Np,0},. . .,a_{Np,m}_{_{Np}}})}

Then the tap operation can be described by the following relationship.

$$\{ \begin{matrix}{c}_{i} = {b}_{i} ⇔ i \neq {t}_{j} for j = 0 , … , {N}_{p`} \\ {c}_{i} = {φ}_{i} ( {b}_{i} , \{ {a}_{1 , 0} , … , {a}_{i , {m}_{i}} \} ) for i = {t}_{j } for some j ∈ \{ 0 , … , {N}_{p} \}\end{matrix} \}$$

An example of these tap operations is given by the following equation:

If all Φ_{i,j}=ˆ for j=0, . . . ,mᵢ, then cᵢ=bᵢˆ a_{i,0}ˆ . . . ˆ a_{i,m(i)}

After the performance of the tap operation, a newly defined block of data 710 is ready for the next operation. As illustrated in FIG. 7, the next operation in the nonlinear feedback shift register is a circular bit shift operation. The circular shift operation produces a second block of data 720 that will be used in the encryption process described below.

There are two types of circular bit shift operations: a left circular shift; and a right circular shift. The left circular bit shift operation, defined on a block of data of length M+1 bits and consisting of a circular left shift of n bits is defined by the following equation:

$$C = CL ( n ) ∘ B \{ \begin{matrix}{c}_{i} = {b}_{i - n} & for & 0 \leq i \leq M - n \\ {c}_{i} = {b}_{n - M + i - 1} & for & M - n + 1 \leq i \leq M\end{matrix} \}$$

The right circular bit shift operation, defined on a block of data of length M+1 bits and consisting of a circular right shift of n bits is defined by the following equation:

$$C = CR ( n ) ∘ B \{ \begin{matrix}{c}_{i} = {b}_{i - n} & for & n \leq i \leq M \\ {c}_{i} = {b}_{M - n + i + 1} & for & 0 \leq i \leq n - 1\end{matrix} \}$$

As previously noted, the smoothing segments ELS1 and ENLS1 are not required to practice the present invention. Because of the inherent intractability derived from using route parameters of attractors, even without smoothing the entropy achieved by the present invention is relatively low for large keys (128 bits or higher). Smoothing offers even better entropy in applications where security is paramount.

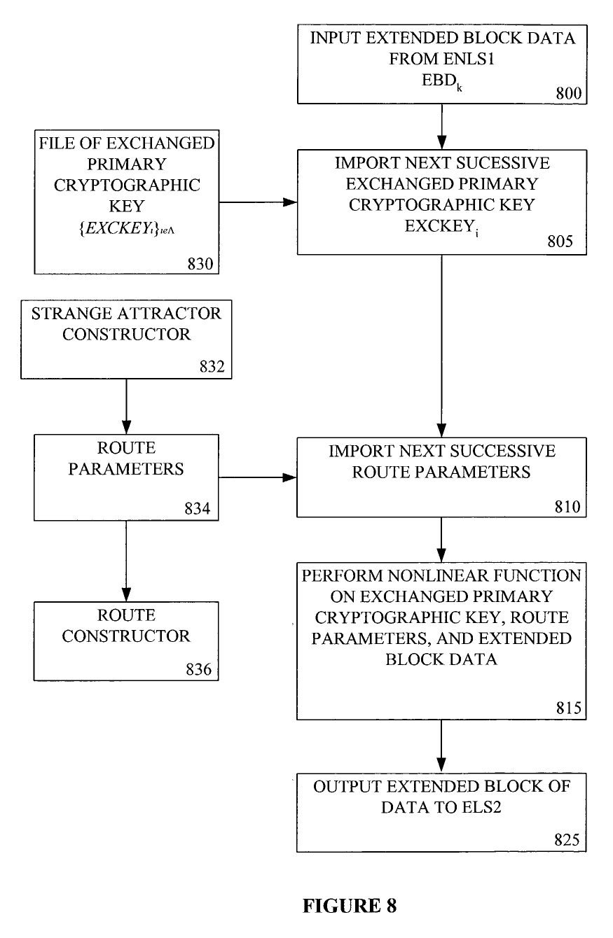

The ES module as implemented in an embodiment of the present invention is illustrated at FIG. 8. In this embodiment, the ES module comprises an intractable nonlinear cryptographic engine that uses a solution space of a deterministic nonlinear differential equation, nonlinear partial differential equation, or nonlinear difference equation meeting the conditions described previously. The solution space of the illustrated embodiment contains strange attractors.

Referring to FIG. 8, an input comprising the next extended block of data from ENLS1 is received by the ES module 800, (denoted by EBDₖ). The next successive exchanged primary cryptographic key from the file of exchanged primary cryptographic keys 830 is imported 805. This exchanged key is denoted by EXCKEYᵢ.

As previously described, the strange attractor constructor 832 has used a numerical integration technique to develop the solution space of the selected and admissible nonlinear system of equations. In the context of the embodiment illustrated in FIG. 8, the solution space must contain at least one strange attractor and the system of nonlinear equations satisfy all admissibility requirements. The route constructor 836 generates routes, which are sequential time histories. The routes are then used with the solution space generated by the strange attractor constructor to generate a set of route parameters 834. Route parameters are three-dimensional points on the strange attractor corresponding to the time histories of the route.

The next successive route parameters are imported 810, which are described by the following equation:

(x(tⱼ),y(tⱼ),z(tⱼ))ⱼ₌₁^{LC-1}

ES performs a nonlinear function, Φ, 815 on the following segments of data: exchanged primary cryptographic key, EXCKEYᵢ; the extended block of data, EBDₖ; and the route parameters, (x(tⱼ),y(tⱼ),z(tⱼ))ⱼ₌₁^{LC-1}. The nonlinear function Φ is selectable within the process for encryption with the important restriction for admissibility that it be mathematically intractable without knowledge or prior possession of either the primary cryptographic key or the exchanged primary cryptographic keys. For example, Φ, could be the appropriate number of XORs or any other combination of logical arithmetic bit operations. The relationship giving the evaluation of the function Φ is given by the following expression.

Φ((EXCKEYᵢ,(x(tⱼ),y(tⱼ),z(tⱼ)),EBDₖ)

Dependent on the functionality of Φ, ancillary data from the functional process may be required for the decryption method to reverse the cipher data produced by ES 820. If this is the case, then this ancillary data is gathered together and sent to the ancillary data collector. The final stage of the encryption process is to output the processed extended block of data for subsequent processing to ELS2 825.

ELS2 is the post encryption linear smoothing process. This process was previously described in the context of FIG. 1A.

### Overview of the Decryption Process

As previously noted, the present invention employs a mathematical approach to real time protection of content of wideband digital data that uses both an encryption process and a decryption process. Embodiments according to the present invention for encrypting wideband digital data have been described. This section will describe several embodiments of the present invention that perform a decryption process of content encrypted using the encryption process described previously.

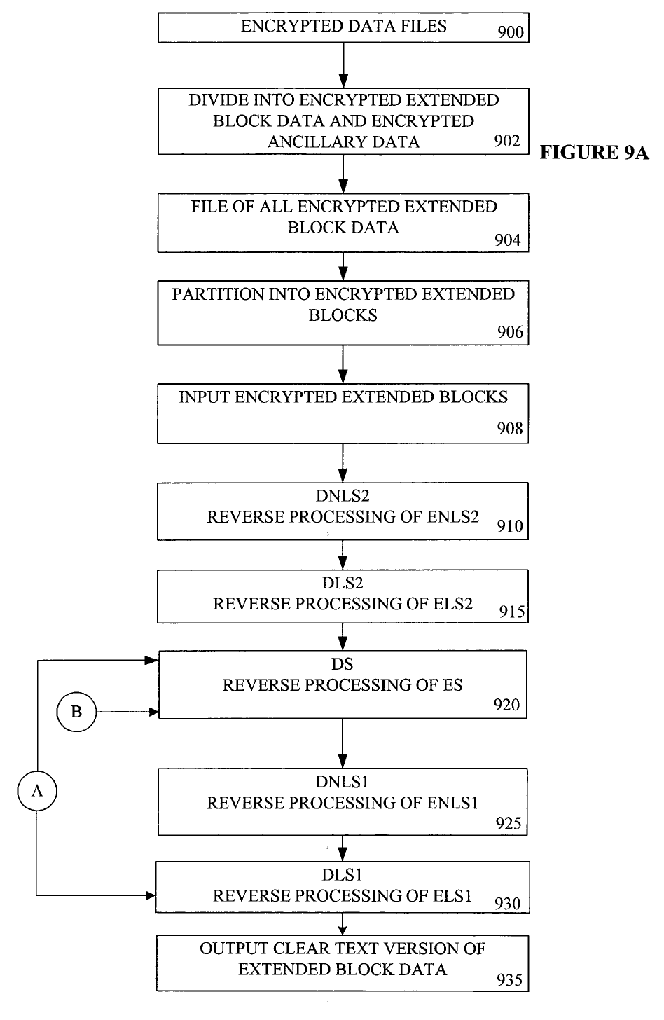

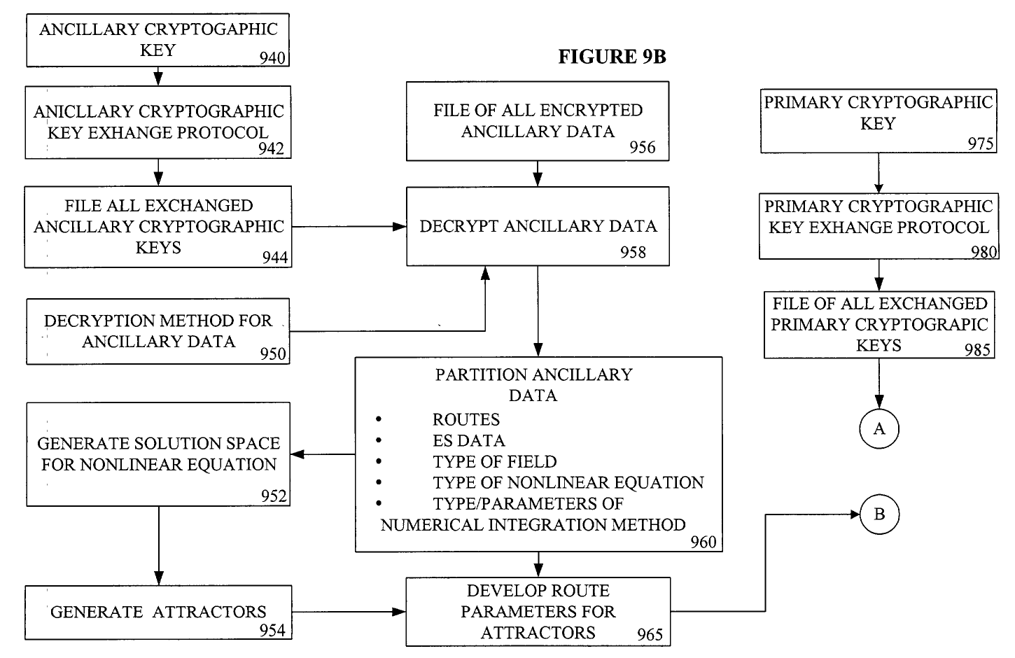

Once clear text data has been encrypted, the decryption of this encrypted data is accomplished by reversing the encryption process. The decryption process is illustrated in general terms in FIGS. 9A and 9B.

Referring to FIG. 9A, the first step in the process is to input all of the encrypted files 900. In an embodiment of the present invention, the encrypted files comprise encrypted extended data blocks; and encrypted ancillary data. The file containing the encrypted extended data block is reserved 902 and partitioned into encrypted extended blocks 906. These blocks become the input 908 for the decryption process.

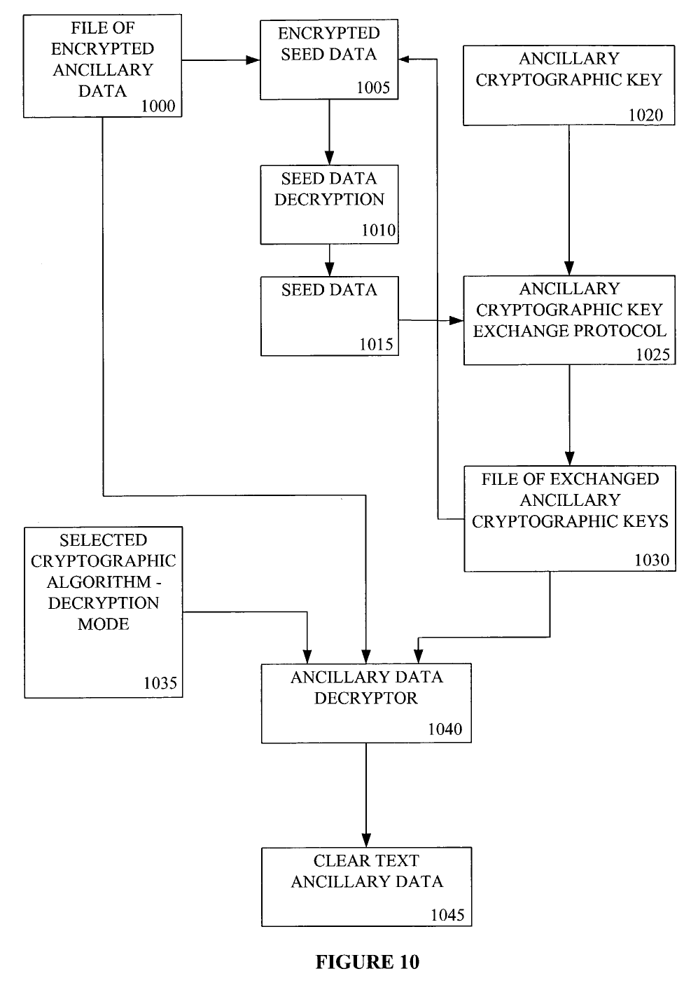

Referring to FIG. 9B, the encrypted ancillary data is reserved 956 for processing. In order to decrypt the ancillary data, a sequence of exchanged ancillary cryptographic keys that is exactly the same as the sequence used for the encryption method must be created. Referring to FIG. 10, a process for decrypting encrypted ancillary data is illustrated. The file of encrypted ancillary data is accessed 1000 and encrypted seed data is obtained 1005. The encrypted seed data is decrypted 1010 to obtain the clear text of the seed data 1015 used to created the ancillary keys. In an embodiment according to the present invention, the decryption of the encrypted seed data is accomplished by XORing it with the ancillary cryptographic key. This is the reverse of the process performed during the encryption process (see FIG. 4). Once “clear text version” of seed data has been derived, then the process of generating the exchanged ancillary keys is exactly the same process as previously described in reference to FIG. 4. Referring again to FIG. 10, the ancillary cryptographic key 1020 and the seed data 1015 are used by the ancillary cryptographic key exchange protocol 1025 to create a file of exchanged ancillary cryptographic keys that are duplicates of those used during the encryption process 1030.

Referring again to FIG. 9B, once the file of exchanged ancillary cryptographic keys has been completed for a pass, then the decryption of the encrypted version of the first group of encrypted ancillary data can proceed 958. The decryption process for ancillary data then proceeds to decrypt the encrypted ancillary data according to the process illustrated in FIG. 10. Using this process, an ancillary data decryptor 1040, using the reverse of the cryptographic algorithm used to encrypt the ancillary data 1035 accesses the file of exchanged ancillary cryptographic keys 1030 to arrive at clear text ancillary data 1045. The decryption algorithm must reverse the functionality of the encryption algorithm. The relationship between the encryption algorithm and the decryption algorithm for ancillary data is expressed in the equation below where the ancillary data is denoted by AD, the encryption algorithm for ancillary data by E, and the decryption algorithm for the ancillary data by D:

D∘E(AD)=AD

Two decryption methods are used in the present invention with respect to ancillary data. The first is used to decrypt the encrypted ancillary data, including data that is required to generate exchanged cryptographic keys and initialize the decryption process for the encrypted ancillary data. The second method uses the decryption process D to decrypt preliminary ancillary data, including, by way of example, the seed data and the random number data.

Referring again to FIG. 9B, the decrypted ancillary data is partitioned into data groups captured during the encryption process 960. These data are used to generate the solution space for the nonlinear equation used in the encryption process 952 which in turn are used to generate attractors 954. The attractors and the ancillary data are then used to develop the route parameters used in the encryption process 965. The route parameters are then sent to the decryption segment (DS) 920 (shown in FIG. 9A).

The exchanged primary cryptographic keys are generated in a similar fashion for the exchanged ancillary cryptographic keys. In order to reverse the process, “clear text” seed data is needed. This is readily accomplished by extracting the encrypted version of the seed data from the encrypted ancillary data file and XORing it with the primary cryptographic key. Once “clear text version” of seed data has been derived, then the process of generating the exchanged primary keys is exactly the same process as previously described in reference to FIG. 4 (depicted in FIG. 9B as 975, 980, and 985). All sequences of exchanged primary cryptographic keys are then stored for subsequent use in the file of exchanged primary cryptographic keys.

Once the file of exchanged primary cryptographic keys has been completed for a pass, then the decryption of the encrypted version of the first frame of encrypted clear text data can proceed.

Referring again to FIG. 9A, the cryptographic engine for the decryption process of the present invention uses the analogous notation as the description of the encryption process. Thus DLS1 corresponds to ELS1, DNLS1 corresponds to ENLS1, DLS2 corresponds to ELS2, DNLS2 corresponds to ENLS2, and DS corresponds to ES. Exactly the same permutation transformations, rotation transformations, and nonlinear feedback shift registers are used in corresponding segments of the encryption and decryption methods. The only exception is the nonlinear function Φ that was used in ES for the encryption method. In DS a new “reverse” nonlinear function is required, which is denoted by Ψ. Its definition and usage will be described below in the context of the decryption module.

After the encrypted data file has been stripped of the encrypted ancillary data files, the remaining encrypted version of the clear text data is partitioned first into frames and then into extended blocks of data. The processing order for extended blocks of data is exactly the same as it was for the encryption process.

The processing order for the cryptographic engine of the decryption process is reversed from the order of processing for the encryption process. Thus the order of processing for the decryption method is as follows: (1) DNLS2 910; (2) DLS2 915; (3) DS 920; (4) DNLS1 925; and (5) DLS1 930. Each processing segment is described in the paragraphs that follow.

DNLS2 910 corresponds to ENLS2. It uses precisely the same nonlinear feedback shift register and rotation transformation, as was the used by ENSL2. In the iterative loop for ENSL2, the first transformation applied was the nonlinear feedback shift register and then the rotation transformation. In DNLS2 the orders are reversed, first the rotation transformation is applied and then the nonlinear feedback shift register is applied. The number of iterations of the loop are the same, that is N_{DNLS2}=N_{ENLS2}.

DLS2 915 corresponds to ELS2. It uses precisely the same permutation transformation and rotation transformation as was used by ELS2. In the iterative loop for ESL2, the first transformation applied was the permutation transformation and then the rotation transformation. In DLS2 the orders are reversed, first the rotation transformation is applied and then the permutation transformation is applied. The number of iterations of the loop are the same, that is N_{DLS2}=N_{ELS2}.

DS 920 corresponds to ES. Because there are no iterative loops within ES or DS, the sequence of operations is exactly the same with one major difference. Instead of using the nonlinear function Φ used by ES, DS uses the function Ψ.

The DS module decrypts in a process that parallels the encryption process illustrated in FIG. 8. In an embodiment of the present invention, the DS comprises an intractable nonlinear cryptographic engine that uses a solution space of a deterministic nonlinear differential equation, nonlinear partial differential equation, or nonlinear difference equation that satisfies the admissible requirements for the encryption method for digital wideband data. The solution space contains strange attractors.

The DS receives the next extended block of data from DLS2 915, which is denoted by EEBDₖ. The next successive exchanged primary cryptographic key is imported from the file of exchanged primary cryptographic keys 985 (FIG. 9B). This exchanged key is denoted by EXCKEYᵢ.

As previously discussed the strange attractor constructor has used a numerical integration technique to develop the solution space of the selected and admissible nonlinear system of equations. In an embodiment according to the present invention, the solution space must contain at least one strange attractor and the system of nonlinear equations satisfy all admissibility requirements. The route constructor generates routes, which are sequential time histories. The routes are then used with the solution space generated by the strange attractor constructor to generate a set of route parameters. Route parameters are three dimensional points on the strange attractor corresponding to the time histories of the route.

The DS imports the next successive route parameters 965 (FIG. 9B), which are described by the following equation:

(x(tⱼ),y(tⱼ),z(tⱼ)ⱼ₌₁^{LC-1}

The DS performs a nonlinear function, Ψ, on the following segments of data: exchanged primary cryptographic key, EXCKEYᵢ; the extended block of data, EEBDₖ; and the route parameters, (x(tⱼ),y(tⱼ),z(tⱼ))ⱼ₌₁^{LC-1}. In an embodiment of the present invention, the nonlinear function Ψ is selectable within the process for decryption for wideband data, with the important restriction for admissibility that it be mathematically intractable without knowledge or apriori possession of either the primary cryptographic key or the exchanged primary cryptographic keys. In this embodiment, Ψ is the mathematical inverse to the nonlinear function Φ. For example, Ψ, could be the appropriate number of XORs or any other combination of logical arithmetic bit operations. The relationship giving the evaluation of the function Ψ is given by the following expression.

Ψ(EXCKEYᵢ,(x(tⱼ),y(tⱼ).z(tⱼ)),EEBDₖ)

Depending on the functionality of Ψ, ancillary data from the functional process may be required for the decryption method to reverse the cipher data produced by ES. If this is the case, then this ancillary data is gathered together and sent to the DS processing segment where it is used for the decryption method.

The final stage of DS is to output the processed extended block of data for subsequent processing to DNLS1 925 (FIG. 9A).

In this embodiment of the present invention, DNLS1 corresponds to ENLS1 of the as described above. DNLS1 uses precisely the same nonlinear feedback shift register and rotation transformation as was the used by ENSL1. In the iterative loop for ENSL1, the first transformation applied was the nonlinear feedback shift register and then the rotation transformation. In DNLS1 the orders are reversed, first the rotation transformation is applied and then the nonlinear feedback shift register is applied. The number of iterations of the loop are the same, that is N_{DNLS1}=N_{ENLS1}.

The output of DNLS1 is sent to DLS1 930. DLS1 corresponds to ELS1. It uses precisely the same permutation transformation and rotation transformation as was used by ELS1. In the iterative loop for ESL1, the first transformation applied was the permutation transformation and then the rotation transformation. In DLS1 the orders are reversed, first the rotation transformation is applied and then the permutation transformation is applied. The number of iterations of the loop are the same, that is N_{DLS1}=N_{ELS1}. There is one more major difference. The first step in ELS1 was to XOR the exchanged primary cryptographic key with each block of the incoming extended block of data. In DLS1 this is the last process to be performed. The output from DLS1 is the clear text extended block data that was originally inputted to ELS1 935.

### DETAILED DESCRIPTION OF AN EXEMPLARY EMBODIMENT OF THE PRESENT INVENTION

In order to further describe the present invention, a detailed description of an exemplary embodiment is provided below. In this embodiment, assumptions are made as to the size of the cryptographic keys, the size of the clear data, and processes applied to the clear data.

In particular, the embodiment assumes that the clear data is “wideband data.” As used herein, “wideband” means a large amount of digital data that is transmitted, accessed, displayed, or stored at speeds from 10⁷ to 10¹¹ bits per second. Examples of wideband data include digital communications of cable and satellite transmissions, digital television, digital movies, and large distributed networks of data processing systems. Typically, wideband data is financially sensitive and has a high dollar value. The unauthorized use, copying, and resale of its contents have the potential for severe financial loss to the owners of the wideband data.

In addition, the described exemplary embodiment utilizes Lorenz nonlinear differential equations as the source of the intractable quantities used in the encryption and decryption processes.

The assumptions and choices reflected in the detailed example are offered for illustrative purposes only and do not constitute limitations of the present invention. As would be clear to those skilled in the art of the present invention, other more general embodiments of the present invention may be practice without exceeding the scope of the present invention.

1. Encryption Process

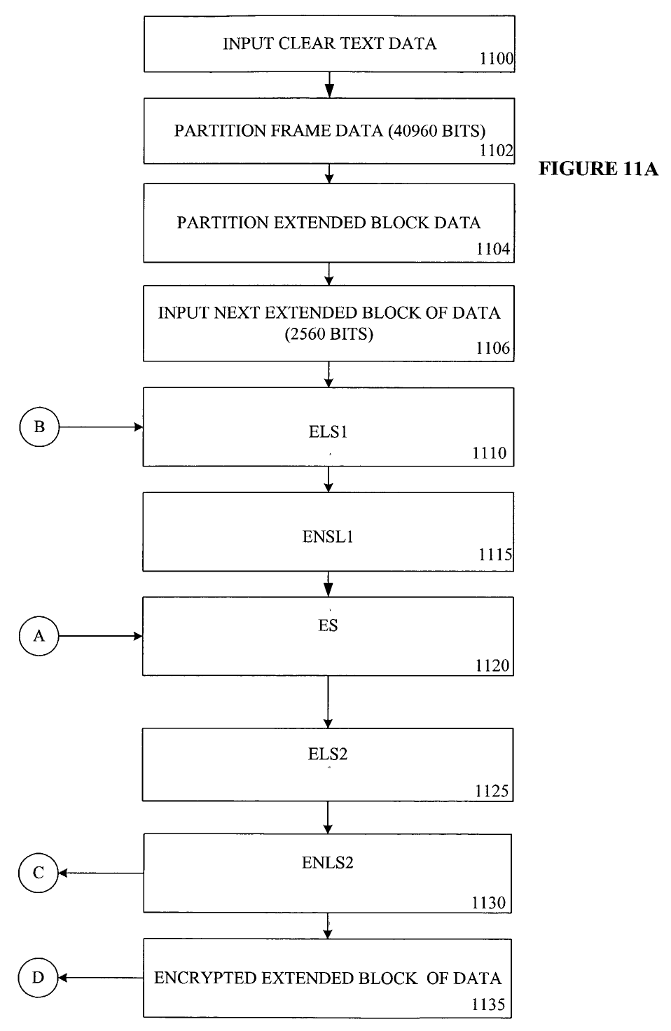

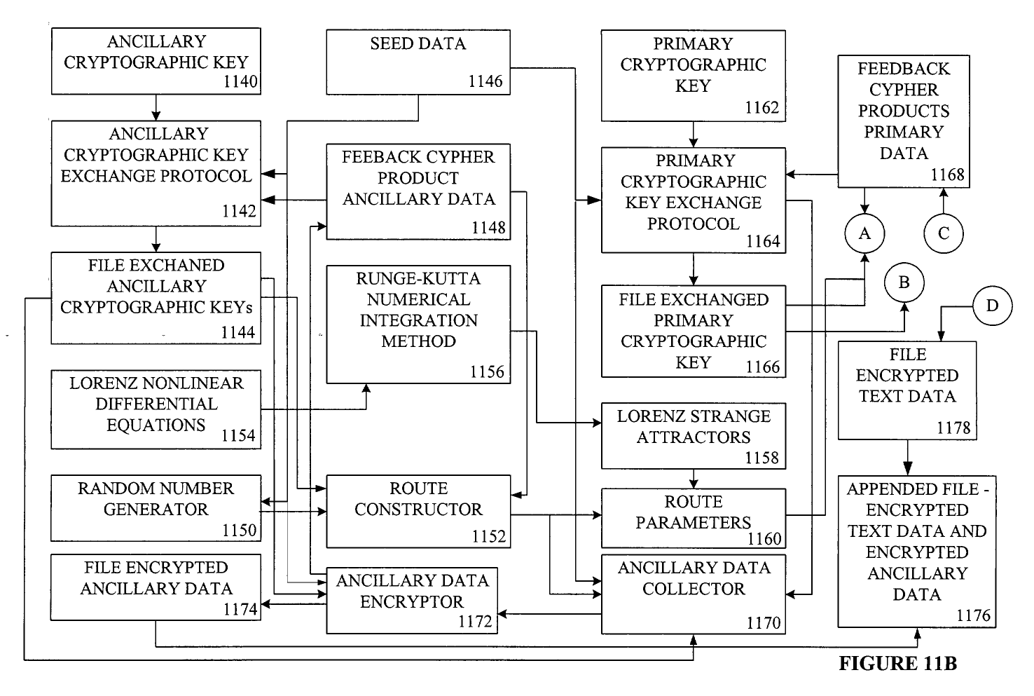

FIGS. 11A and 11B illustrates an overview of the detailed description of the encryption process for the exemplary embodiment. FIGS. 11A and 11B parallel FIGS. 1A and 1B but with more details relating to the implementation decisions made for the exemplary embodiment. In particular, the exemplary embodiment uses two 128 bit cryptographic keys, one designated the primary cryptographic key and the other designated that ancillary cryptographic key. The encryption method uses the Lorenz system of nonlinear differential equations over the real numbers as is called out in the following

$$\{ \begin{matrix}\dot{x} = σ ( y - x ) \\ \dot{y} = rx - y - xz \\ \dot{z} = xy - bz \\ σ = 10 \\ b = \frac{8}{3} \\ r = 28\end{matrix} \}$$

The selected mathematical technique for the numerical integration of Lorenz system of nonlinear equations is the Runge-Kutta technique for numerical integration. Other specific selections and approaches are detailed in the following paragraphs.

FIG. 11A reiterates the general process of FIG. 1A with the addition of detail regarding the partitioning of the clear text data. Referring to FIG. 11A, clear text data is inputted 1100, partitioned into frames 1102, and partition into extended blocks of data 1104. At this point the general flow described in reference FIG. 1A applies. Extended block data is inputted 1106 and the data subject to a first linear smoothing process ELS1 1110 and a first nonlinear smoothing process ENLS1 1115. The output of ENLS1 is encrypted using a nonlinear mathematically intractable encryption algorithm 1120 (ES). The encrypted output is subjected to a second linear smoothing process ELS2 1125 and a second nonlinear smoothing process ENLS2 1130.

The output of ENLS2 is an encrypted extended block of data 1135.

Referring to FIG. 1B, the generation of the data used in the encryption process are illustrated. Each of these processing functions is described in greater detail below.

Referring to FIG. 11B, a file of exchanged ancillary cryptographic keys 1144 is generated from the ancillary cryptographic key 1140, seed data 1146, and feedback cipher products ancillary data 1148 using an ancillary cryptographic key exchange protocol 1142.

The Lorenz nonlinear differential equations 1154 are integrated using the Runge-Kutta numerical integration method 1156 to produce Lorenz strange attractors 1158. A random number generator 1150 feeds a route constructor 1152 to produce routes that are then used to produce route parameters 1160.

A file of exchanged primary cryptographic keys 1166 is generated by a primary cryptographic key exchange protocol 1164 from a primary cryptographic key 1162, seed data 1146, and feedback cipher products primary data 1168.

Ancillary data (which comprises the file of exchanged ancillary cryptographic keys, seed data, the output of the route constructor, the ancillary cryptographic key exchange protocol and the primary cryptographic key exchange protocol) is collected by an ancillary data collector 1170 and sent to an ancillary data encryptor 1172, encrypted, and captured in a file of encrypted ancillary data 1174. The file of encrypted ancillary data is then appended 1176 with the file of encrypted text data 1178.

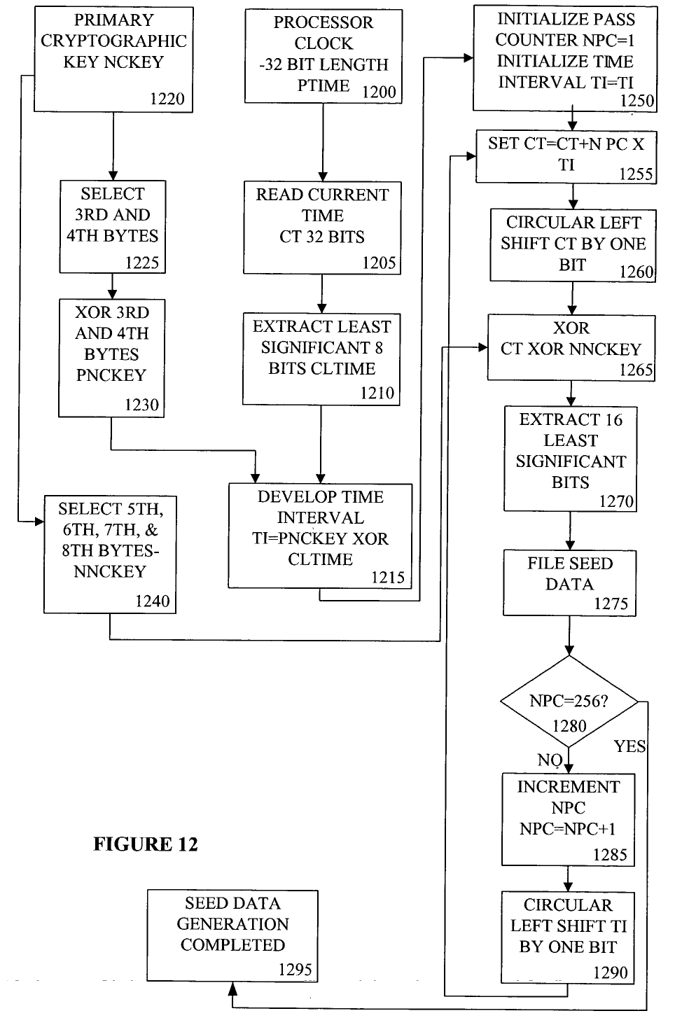

FIG. 12 contains a block diagram of the methodology for the generation of seed data for this embodiment. For the purposes of this exemplary embodiment, it is assumed that the exemplary embodiment will be implemented in a digital processor. The source of the seed data is the digital clock of this processing unit 1200. For the seed generation process, clock data is acquired at the time of the encryption of the clear text data. It is assumed that the processor has a 32-bit clock.

At the start of the encryption process, the clock is read 1205. This time is called CTIME. Next the 8 least significant bits is extracted 1210 (denoted by CLTIME). The next part of the seed generation process involves the primary cryptographic key, NCKEY 1215. First the third and fourth bytes (from the left) of NCKEY and extracted 1225 and then XORed 1230 to produce an 8-bit result which is denoted by PNCKEY. For a subsequent use in the iterative part of the procedure, the fifth, sixth, seventh, and eight bytes of NCKEY are used to form a 32-bit word that is denoted by NNCKEY 1240. The next step in the seed generation process is to develop the time interval, denoted by TI. TI is developed initially by XORing PNCKEY and CLTIME 1215 as is shown by the following equation:

TI=PNCKEY XOR CLTIME

This concludes the preliminary steps in the generation of seed data.

The next segment in the seed generation process is an iterative procedure that sequential extracts seed data based on random time accesses to the processor's system clock. This iterative procedure begins by initializing the pass counter, NPC=1, and then initializing the time interval, TI by using the previously computed value for TI given by the above reference equation 1250.

CT is then reset according to the following equation 1255.

CT=CT+NPC*TI

This result, the new CT is then operated on by a circular left shift of one bit 1260. The resultant is renamed CT. The least significant 16 bits are then extracted 1270 to form a seed data and subsequently stored in the file of seed data. At this point in the iterative process, a check is made to see if the pass counter, NPC has reaches 256 1280. If it has not reached 256, then a circular left shift of one bit is applied to TI 1285, the pass counter, NPC, is incremented by one and the iterative process continues. If the pass counter, NPC, has reached 256, then the iterative process of generating seed data concludes 1295.

Thus the data word length of seed data is 16 bits.

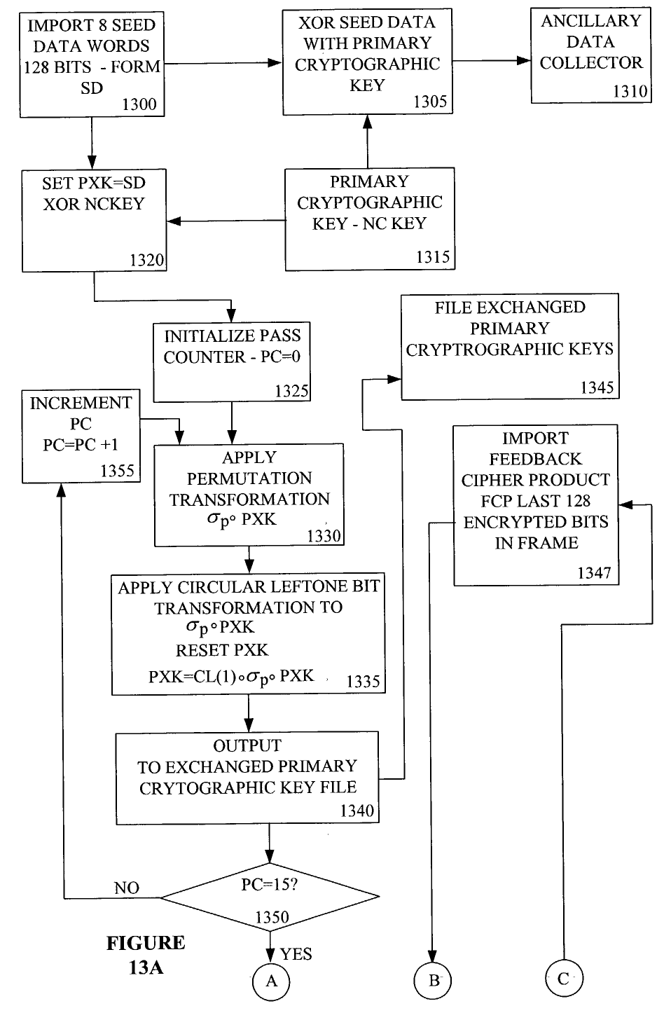

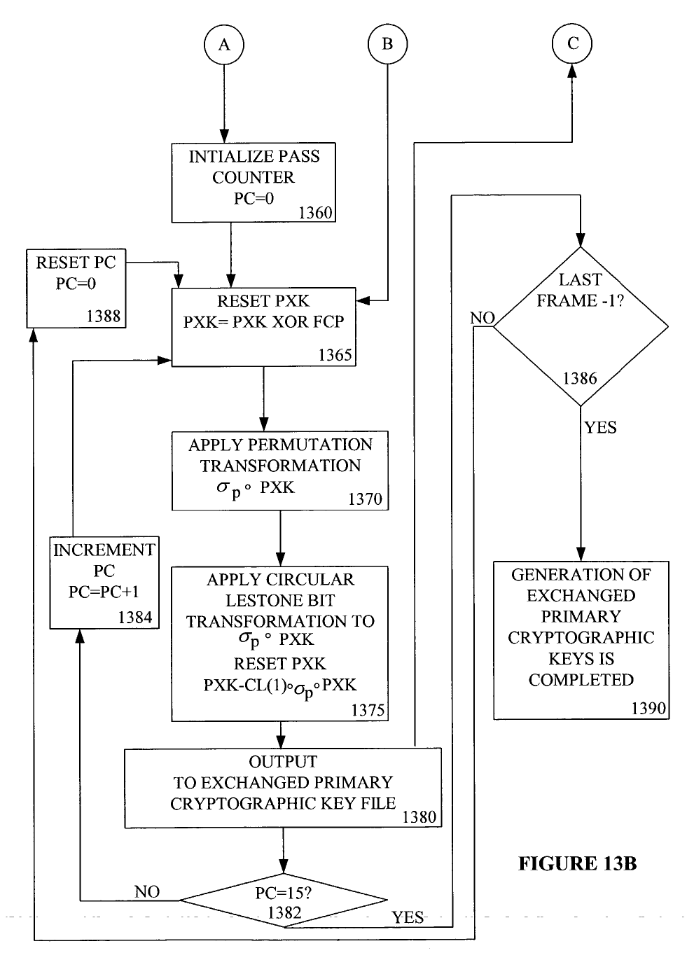

The next steps in the procedure are the protocols for the generation of exchanged cryptographic data for the both the primary cryptographic key and the ancillary cryptographic key. The discussion begins with the protocol for the primary cryptographic key, which is illustrated in a block diagram contained in FIGS. 13A and 13B.

As is illustrated by FIG. 13A, the first step in the generation of exchanged cryptographic keys for the primary cryptographic key is the importing of 8 seed data words 1300, each of which consist of 16 bits. The 16-bit seed words are used to build up a seed data extended word of 128 bits, which is the length of the primary cryptographic key. This extended 128-bit word of seed data is then XORed with the primary cryptographic key 1305 and then sent to the ancillary data collector 1310. The purpose is to encrypt this extended seed data word for use in the decryption mode of the encryption exemplary embodiment.

SD is then XORed with the primary cryptographic key, NCKEY, to form the 128-bit data word PXK 1320 as is described in the following equation:

PXK=SD XOR NCKEY

The next step in the procedure is to initialize the counter for the pass for the generation of exchanged primary cryptographic keys. This is accomplished by setting the pass counter, PC, equal to zero 1325.

The next step in the procedure is to apply the permutation transformation 1320 σ_{P}, which is described by the following equation:

$${σ}_{P} : {b}_{1} -> {c}_{j} , where j = k + [ ( int ( \frac{i}{8} ) + 3 ) mod16 ] * 8$$

$$\{ \begin{matrix}k = 0 ⇔ ( i mod 8 ) = 7 \\ k = 1 ⇔ ( i mod 8 ) = 6 \\ k = 2 ⇔ ( i mod 8 ) = 5 \\ k = 3 ⇔ ( i mod 8 ) = 4 \\ k = 4 ⇔ ( i mod 8 ) = 3 \\ k = 5 ⇔ ( i mod 8 ) = 2 \\ k = 6 ⇔ ( i mod 8 ) = 1 \\ k = 7 ⇔ ( i mod 8 ) = 0\end{matrix} \}$$

The next step in the procedure is to apply a left circular one-bit transformation 1335. This resultant is then an exchanged primary cryptographic key that is outputted to the file of exchanged primary cryptographic keys 1340 and stored 1345. The next step is to procedure is to check if the pass counter, PC, is equal to 15 1350. If not then the procedure continues and the pass counter PC is incremented 1355. If PC equals 15 then the initial pass through the generation of exchanged primary cryptographic keys is completed. In this case we proceed to the generation of the next succeeding passes through the generator of exchanged primary cryptographic keys.

As previously discussed, the first pass through the generation of exchanged primary cryptographic keys is different from all subsequent processing passes. The major difference is the use in passes subsequent to the first pass of feedback cipher products, which are denoted by FCP. In the primary encryption mode of clear text data, the frame length is exactly 40,960 bits. After the processing by the encryption method of the exemplary embodiment, the last 128 bits of a 40,960 bit frame of data is the feedback cipher product. The 128 bits of enciphered data is sent from the cryptographic engine to the feedback cipher product data file for subsequent usage in the generation of exchanged primary cryptographic keys.

Referring to FIG. 13B, all passes through the generation of exchanged primary cryptographic keys after the first pass begin with the setting of the pass counter, PC, equal to zero 1360. The next step in the procedure is to obtain the FCP generated by the last full frame pass 1347 and replace PXK by PXK XORed with FCP 1365. The permutation transformation, σ_{P}, is now applied to the above result 1370. The next step in the procedure is to apply a left circular one-bit transformation 1375. This result is then filed in the file of exchanged primary cryptographic keys 1380. The last 128 bits of the encrypted frame are used as FCP and sent to 1347. Then a check is made to determine if the number of passes, PC, equal 15 1382. If not then the pass counter, PC, is incremented 1384 and this iterative procedure continues. If PC=15, then a check is made to see if the number of frames is completed 1386. If yes the process is also concluded 1390, then the generation of exchanged primary cryptographic keys is completed. If not, then PC is reset to 0 1388 and the process continues.

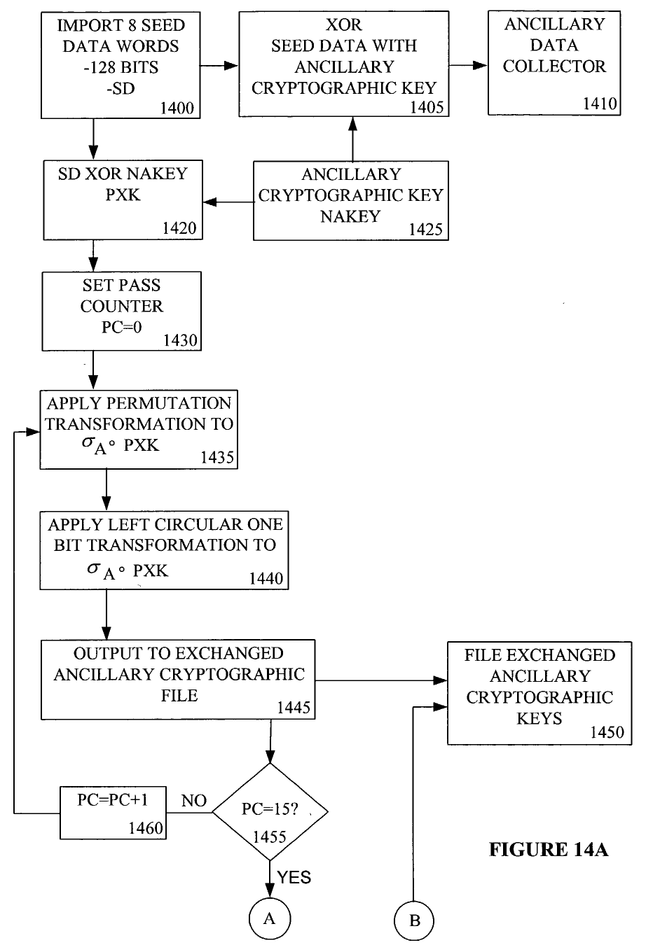

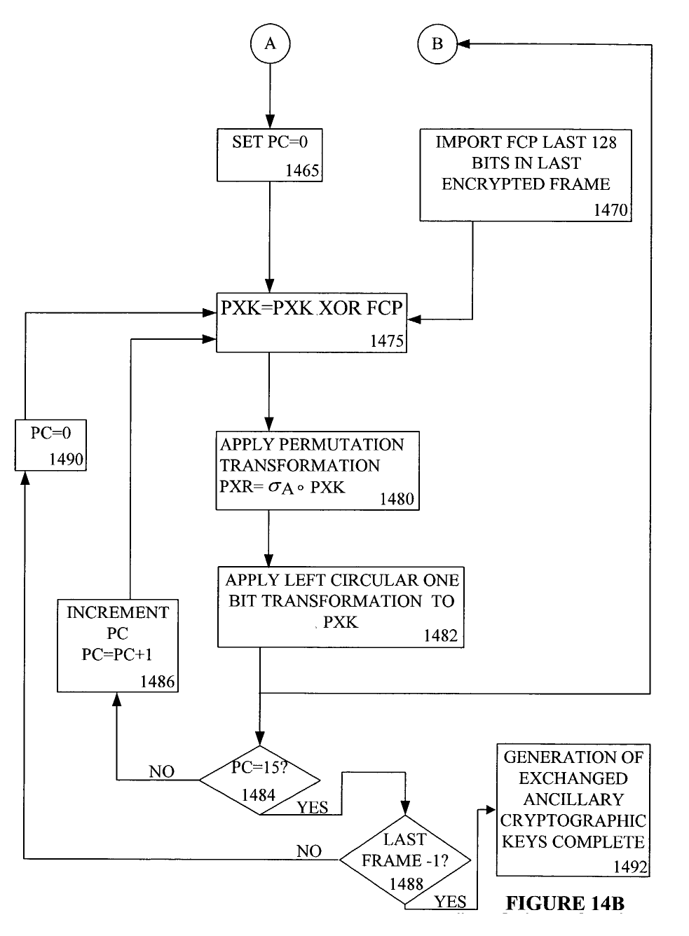

As is illustrated by FIG. 14A, the first step in the generation of exchanged cryptographic keys for the ancillary cryptographic key is the importing of 8 seed data words, each of which consist of 16 bits and creating a seed data extended word of 128 bits 1400, which is the length of the ancillary cryptographic key. This extended 128-bit word of seed data is then XORed with the ancillary cryptographic key 1405 and then sent to the ancillary data collector 1410. The purpose is to encrypt this extended seed data word for use in the decryption process of the exemplary embodiment.

The first pass through the generation of exchanged ancillary cryptographic keys is unique. The first step is to import 8 seed data words from the seed data file. This is used to form procedure for the generation of exchanged ancillary cryptographic keys is substantially different. The detailed discussion of this procedure begins with the first or initial a 128-bit data word, which is denoted by SD 1400. SD is then XORed with the ancillary cryptographic key, NAKEY, to form the 128 bit data word PXK 1420 as is described in the following equation:

PXK=SD XOR NAKEY

The next step in the procedure is to initialize the counter for the pass for the generation of exchanged primary cryptographic keys. This is accomplished by setting the pass counter, PC, equal to zero 1430.

The next step in the procedure is to apply the permutation transformation 1435 σ_{A}, which is described by the following equation:

$${σ}_{A} : {b}_{i} -> {c}_{j} , where j = k + [ ( int ( \frac{i}{8} ) + 3 ) mod16 ] * 8$$

$$\{ \begin{matrix}k = 0 ⇔ ( i mod 8 ) = 7 \\ k = 1 ⇔ ( i mod 8 ) = 6 \\ k = 2 ⇔ ( i mod 8 ) = 5 \\ k = 3 ⇔ ( i mod 8 ) = 4 \\ k = 4 ⇔ ( i mod 8 ) = 3 \\ k = 5 ⇔ ( i mod 8 ) = 2 \\ k = 6 ⇔ ( i mod 8 ) = 1 \\ k = 7 ⇔ ( i mod 8 ) = 0\end{matrix} \}$$

The next step in the procedure is to apply a left circular one-bit transformation 1440. This resultant is then an exchanged ancillary cryptographic key that is outputted to the file of exchanged ancillary cryptographic keys 1445 and stored 1450. The next step is to procedure is to check if the pass counter, PC, is equal to 15 1455. If not, the pass counter is incremented 1460 and the procedure continues. If PC equals 15 then the initial pass through the generation of exchanged ancillary cryptographic keys is completed. In this case we proceed to the generation of the next succeeding passes through the generator of exchanged ancillary cryptographic keys.

As previously discussed, the first pass through the generation of exchanged ancillary cryptographic keys is different from all subsequent processing passes. The major difference is the use in passes subsequent to the first pass of feedback cipher products, which are denoted by FCP. In the ancillary encryption mode of ancillary data, the frame length is exactly 2048 bits. After, encryption of the frame, the last 128 bits of a 2048-bit frame of data is the feedback cipher product. This 128 bits of enciphered data is sent from the ancillary encryption cryptographic engine to the feedback cipher product data file for subsequent usage in the generation of exchanged ancillary cryptographic keys.

Referring to FIG. 14B, all passes through the generation of exchanged ancillary cryptographic keys after the first pass begin with the setting of the pass counter, PC, equal to zero 1465. The next step in the procedure is to obtain the FCP generated by the last full frame pass 1470 and to replace PXK with PXK XORed with FCP 1475. The permutation transformation, σ_{A}, is now applied to the above result 1480. The next step in the procedure is to apply a left circular one-bit transformation 1482. This result is then filed in the file of exchanged ancillary cryptographic keys 1450. Then a check is made to determine if the number of passes, PC, equal 15 1484. If not then the pass counter is incremented 1486 and this iterative procedure continues. If PC=15, then a check is made to see if the number of frames is completed 1488. If yes the process is also concluded, then the generation of exchanged ancillary cryptographic keys is completed 1492. If no, the pass counter is set to 1 and the process continues from 1475.

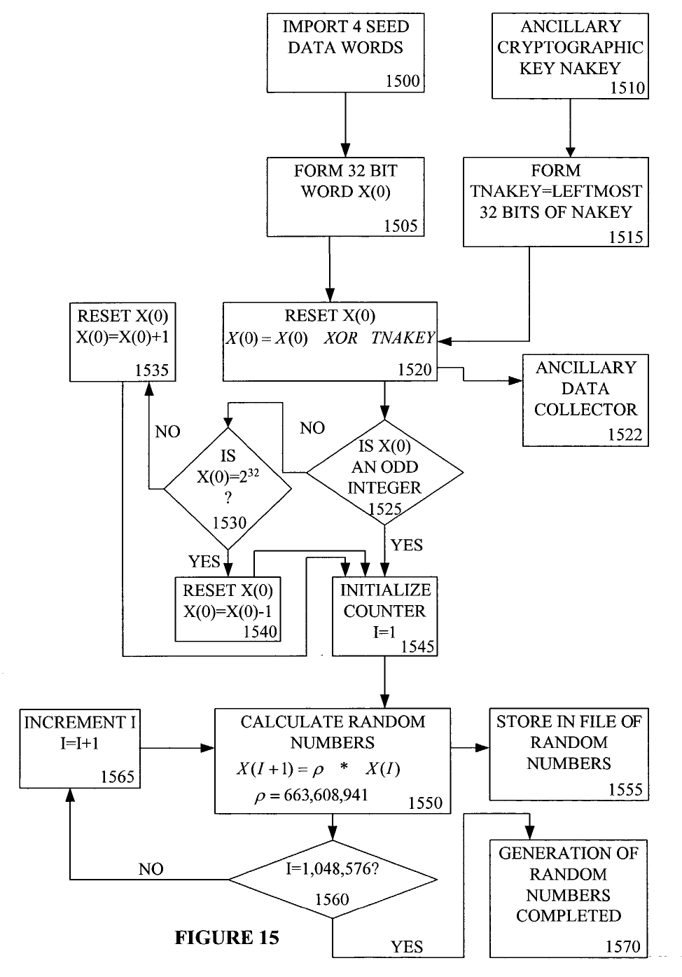

The next step in the process is the generation of random numbers. A functional block diagram illustrating this process is provided in FIG. 15. The first step in the generation of random numbers is to import 4 seed data words 1500 and form a 32-bit word 1505, which is denoted by X(0).

The ancillary cryptographic key 1510 is then used to form a partial cryptographic key 1515, which is denoted by TNAKEY. TNAKEY is formed by using only the leftmost 32 bits of NAKEY. This 32-bit word, TNAKEY, is then used in subsequent segments of the generation of random numbers.

The next step in the procedure is to XOR TNAKEY with X(0) 1520. This is described by the following equation:

X(0)=X(0)XOR TNAKEY

In this procedure it is required that X(0) is an odd integer. A check is made to determine if X(0) is an odd integer 1525, i.e., not divisible by 2. If this is the case then the processing continues. Otherwise, in the case that X(0) is an even integer, a modification is made to X(0) to make it an odd integer. First, a determination is made if X(0)=2³² 1530, if this is case then X(0) is made an odd integer by simply subtracting one from its previous value 1535. If X(0) does not equal 2³², then X(0) is converted into an odd integer by simply adding one to its previous value 1540.

The next steps in the procedure involve the iterative computation of random numbers and the subsequent exporting to a file for random numbers. The process begins by initializing the loop counter, I, to equal to one 1545. Next the random number generator is used to compute the next random number 1550. This computation is given by the following equation:

X(I+1)=ρ*X(I)

where, ρ=663,608,94

The result is stored in the file of random numbers 1555.

Next a check is made to see if the number of iterations is complete 1560. This is accomplished by checking to see if I=1,048,576. If the answer is yes, then the generation of random numbers is completed 1570. If the answer is no, then the counter I is incremented by one 1565 and the iterative process continued 1550.

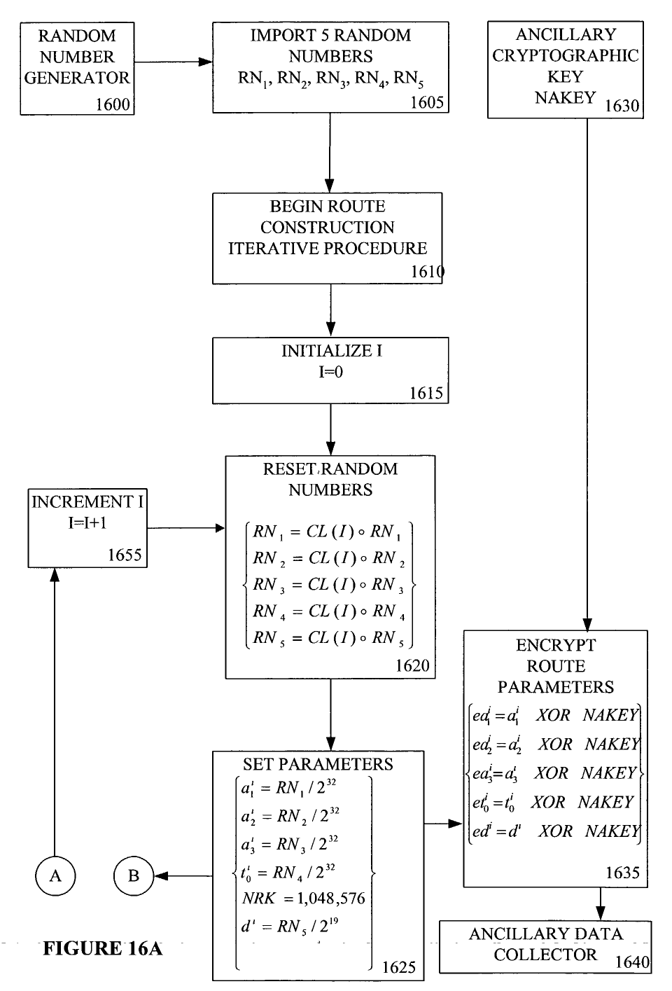

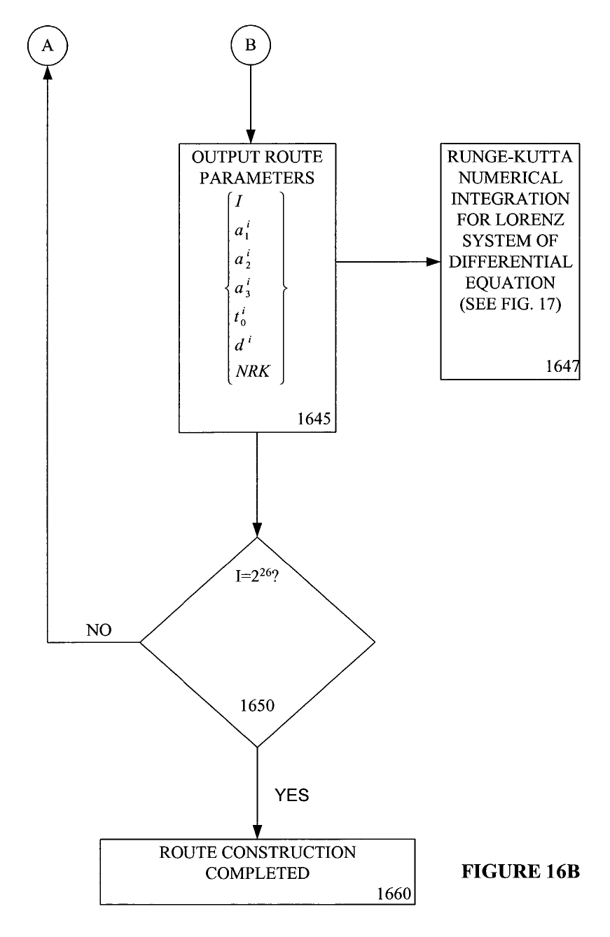

The route constructor is used in the present embodiment to develop parameters and specifications to select from the Lorenz strange attractors data for the hard encryption of incoming clear text data. A block diagram of the route constructor is illustrated in FIGS. 16A and 16B. The route constructor primarily consists of calculations and decisions required to develop data for the initialization of the Runge-Kutta numerical method of integration of the Lorenz system on nonlinear differential equations, which have as their solution space the Lorenz strange attractors.

Refering to FIG. 16A, the first step in the procedure is to import from the random number generator 1600 processor five random words, each of which consist of 32 bits 1605. This begins the iterative process of the construction of routes for the encryption method of wideband data 1610. The next step in the procedure is to initialize the loop counter, I, to zero 1615.

The next step in the procedure is to reset the values of the random numbers, RN₁, where i=1, . . . ,5. Each random number RN(I) is reset by applying left circular bit shift of I bits 1620. This is accomplished by the following equation:

$$\{ \begin{matrix}{RN}_{1} = CL ( I ) ∘ {RN}_{1} \\ {RN}_{2} = CL ( I ) ∘ {RN}_{2} \\ {RN}_{3} = CL ( I ) ∘ {RN}_{3} \\ {RN}_{4} = CL ( I ) ∘ {RN}_{4} \\ {RN}_{5} = CL ( I ) ∘ {RN}_{5}\end{matrix} \}$$

The next step in the procedure is to set the parameters required for the Runge-Kutta numerical method of integration of the Lorenz system of nonlinear differential equations 1625. This procedure is set forth in the following set of equations.

$$\{ \begin{matrix}{a}_{1}^{i} = {RN}_{1} / {2}^{32} \\ {a}_{2}^{i} = {RN}_{2} / {2}^{32} \\ {a}_{3}^{i} = {RN}_{3} / {2}^{32} \\ {t}_{0}^{i} = {RN}_{4} / {2}^{32} \\ NRK = 1 , 048 , 576 \\ {d}^{i} = {RN}_{5} / {2}^{32}\end{matrix} \}$$

These parameters are then immediately encryption 1635 using the ancillary cryptographic key 1630 for subsequent usage in the decryption process of the exemplary embodiment. Each of the parameters is prefixed by the symbol “e” to indicate encryption. The following equations describe this encryption process.

$$\{ \begin{matrix}{ea}_{1}^{i} = {a}_{1}^{i} XOR NAKEY \\ {ea}_{2}^{i} = {a}_{2}^{i} XOR NAKEY \\ {ea}_{3}^{i} = {a}_{3}^{i} XOR NAKEY \\ {et}_{0}^{i} = {t}_{0}^{i} XOR NAKEY \\ {ed}^{i} = {d}^{i} XOR NAKEY\end{matrix} \}$$

This data is then sent to the Ancillary Data Collection for storage 1640 for subsequent usage in the decryption mode.

Referring to FIG. 16B, the route parameters given by the following equation are sent 1645 to the Runge-Kutta numerical integration method for the Lorenz system of nonlinear differential equations 1647.

$$\{ \begin{matrix}I \\ {a}_{1}^{i} \\ {a}_{2}^{i} \\ {a}_{3}^{i} \\ {t}_{0}^{i} \\ {d}^{i} \\ NRK\end{matrix} \}$$

A check is then made to determine if the index counter is equal to 2²⁶ 1650. If the answer is yes, then the process of route construction is completed 1660. If the answer is no, then the index I is incremented by one 1655 and. the iterative process begins again 1620 (FIG. 16A).

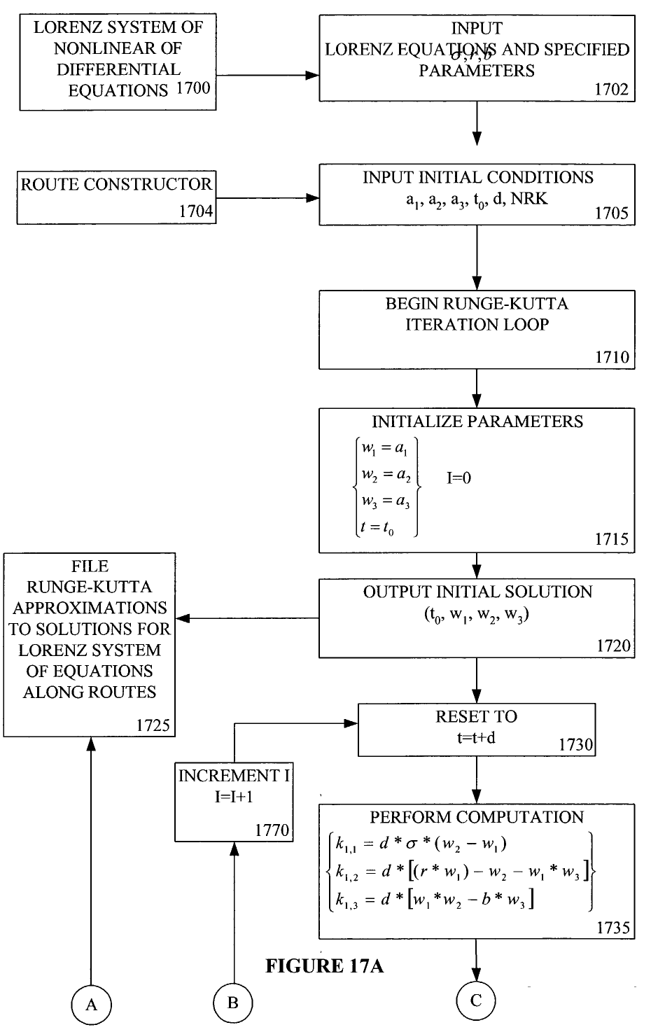

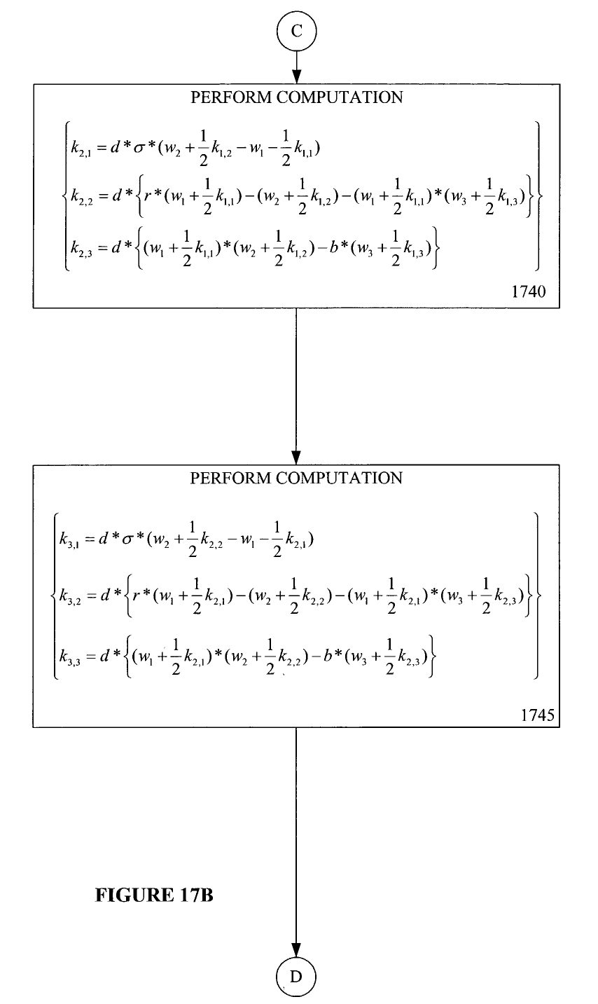

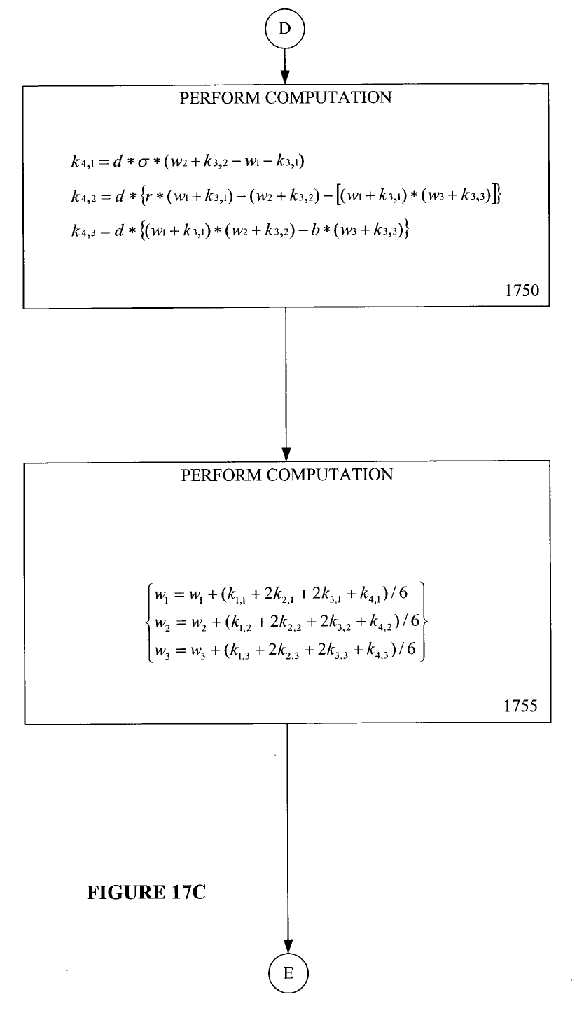

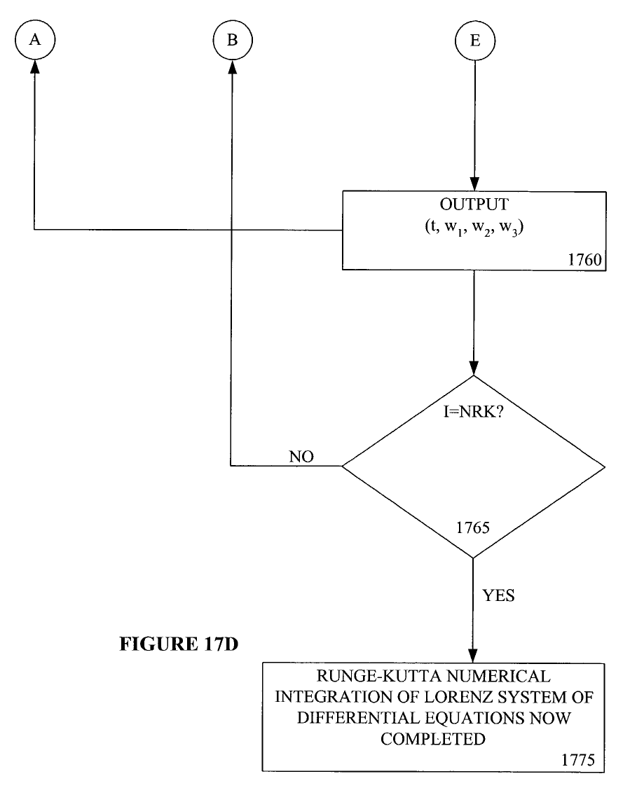

The next step in the procedure is the Runge-Kutta method of numerical integration for the Lorenz system of nonlinear differential equations. The process begins by the inputting of the Lorenz system of nonlinear differential equations and the parameters σ, r, and b. These are supplied by the route constructor segment of the exemplary embodiment. A block diagram for this procedure is illustrated in FIGS. 17A, 17B, 17C, and 17D.

Referring to FIG. 17A, the first step in the procedure is to input the Lorenz system of nonlinear differential equations 1700. The next step in the procedure is to input the specific parameters for this Lorenz system of nonlinear differential equations 1702 as is contained in the following equation:

$$\{ \begin{matrix}σ = 10 \\ r = 28 \\ b = 2.667\end{matrix} \}$$

The next step in the procedure is to input the initial conditions 1705 from the route constructor segment of the encryption process. These parameters comprise: a₁, a₂, a₃, t₀, d, and NRK.

The next step is to begin the Runge-Kutta numerical integration technique iterative loop 1710. The first step in the procedure is to initialize parameters according to the following equation 1715:

$$\{ \begin{matrix}{w}_{1} = {a}_{1} \\ {w}_{2} = {a}_{2} \\ {w}_{3} = {a}_{3} \\ t = {t}_{0}\end{matrix} \}$$

The next step in the procedure is to output the results, (t₀, w₁, w₂, w₃) 1720, into the file of Runge-Kutta approximations to the solutions for the Lorenz System of nonlinear differential equations 1725.

The next step in the process is to reset t. This is accomplished by setting t=t+d 1730.

The next step in the procedure is to perform the calculation given by the following equation 1735.

$$\{ \begin{matrix}{k}_{1 , 1} = d * σ * ( {w}_{2} - {w}_{1} ) \\ {k}_{1 , 2} = d * [ ( r * {w}_{1} ) - {w}_{2} - {w}_{1} * {w}_{3} ] \\ {k}_{1 , 3} = d * [ {w}_{1} * {w}_{2} - b * {w}_{3} ]\end{matrix} \}$$

Referring to FIG. 17B, the next step in the procedure is to perform the calculation given by the following equation 1740:

$$\{ \begin{matrix}{k}_{2 , 1} = d * σ * ( {w}_{2} + \frac{1}{2} {k}_{1 , 2} - {w}_{1} - \frac{1}{2} {k}_{1 , 1} ) \\ {k}_{2 , 2} = d * \{ r * ( {w}_{1} + \frac{1}{2} {k}_{1 , 1} ) - ( {w}_{2} + \frac{1}{2} {k}_{1 , 2} ) - ( {w}_{1} + \frac{1}{2} {k}_{1 , 1} ) * ( {w}_{3} + \frac{1}{2} {k}_{1 , 3} ) \} \\ {k}_{2 , 3} = d * \{ ( {w}_{1} + \frac{1}{2} {k}_{1 , 1} ) * ( {w}_{2} + \frac{1}{2} {k}_{1 , 2} ) - b * ( {w}_{3} + \frac{1}{2} {k}_{1 , 3} ) \}\end{matrix} \}$$

The next step in the procedure is to perform the calculation given by the following equation 1745:

$$\{ \begin{matrix}{k}_{3 , 1} = d * σ * ( {w}_{2} + \frac{1}{2} {k}_{2 , 2} - {w}_{1} - \frac{1}{2} {k}_{2 , 1} ) \\ {k}_{3 , 2} = d * \{ r * ( {w}_{1} + \frac{1}{2} {k}_{2 , 1} ) - ( {w}_{2} + \frac{1}{2} {k}_{2 , 2} ) - ( {w}_{1} + \frac{1}{2} {k}_{2 , 1} ) * ( {w}_{3} + \frac{1}{2} {k}_{2 , 3} ) \} \\ {k}_{3 , 3} = d * \{ ( {w}_{1} + \frac{1}{2} {k}_{2 , 1} ) * ( {w}_{2} + \frac{1}{2} {k}_{2 , 2} ) - b * ( {w}_{3} + \frac{1}{2} {k}_{2 , 3} ) \}\end{matrix} \}$$

Referring to FIG. 17C, the next step in the procedure is to perform the calculation given by the following equation 1750:

k_{4,1}=d*σ*(w₂+k_{3,2}−w₁−k_{3,1})

k_{4,2}=d*{r*(w₁+k_{3,1})−(w₂+k_{3,2})−[(w₁+k_{3,1})*(w₃k_{3,3})]}

k_{4,3}=d*{(w₁+k_{3,1})*(w₂+k_{3,2})−b*(w₃+k_{3,3})}

The next step in the procedure is to perform the calculation given by the following equation 1755:

$$\{ \begin{matrix}{w}_{1} = {w}_{1} + ( {k}_{1 , 1} + 2 {k}_{2 , 1} + 2 {k}_{3 , 1} + {k}_{4 , 1} ) / 6 \\ {w}_{2} = {w}_{2} + ( {k}_{1 , 2} + 2 {k}_{2 , 2} + 2 {k}_{3 , 2} + {k}_{4 , 2} ) / 6 \\ {w}_{3} = {w}_{3} + ( {k}_{1 , 3} + 2 {k}_{2 , 3} + 2 {k}_{3 , 3} + {k}_{4 , 3} ) / 6\end{matrix} \}$$

These data is then outputted as the sequence (t, w₁, w₂, w₃) 1760 (FIG. 17D).

Next a check is made to see if the iteration loop has been completed 1765. If I=NRK, then the loop has been completed 1775 and the Runge-Kutta numerical integration of the Lorenz system of nonlinear differential equations is now completed. If I is not equal to NRK, then the iteration process is continued by incrementing the value of I by one 1770 and the process continues 1730 (FIG. 17A).

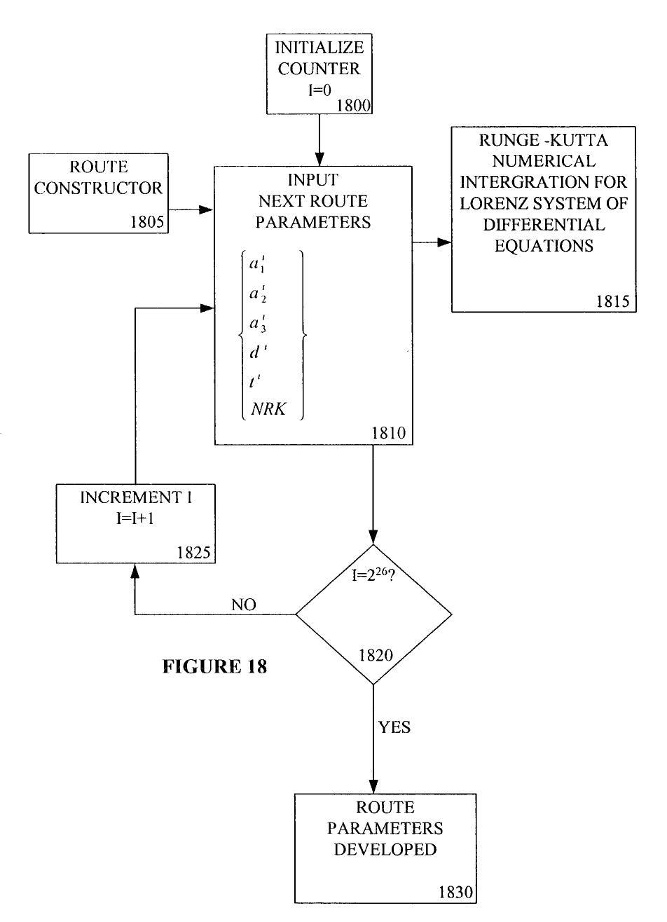

The next step in the process is the generation of the route parameters. This process is illustrated in FIG. 18. First, the counter, I, is initialized to 0 1800. Then the next route parameters are inputted 1810 from the route constructor 1805. These parameters are described in the following equation:

$$\{ \begin{matrix}{a}_{1}^{i} \\ {a}_{2}^{i} \\ {a}_{3}^{i} \\ {d}^{i} \\ {t}^{i} \\ NRK\end{matrix} \}$$

A check is then made to determine if I=2²⁶ 1820. If the answer is yes, then the process is completed and all route parameters have been generated 1830. If not, then I is incremented by one 1825 and the iterative process is continued 1810.

The next step in the method for the encryption of wideband digital data is the encryption of the ancillary data. Ancillary data is encrypted using a distinct and separate cryptographic encryption method than is used to encrypt the clear text data. Ancillary data is used by the encryption process of the exemplary embodiment to assist the decryption of the clear text data once it is encrypted.

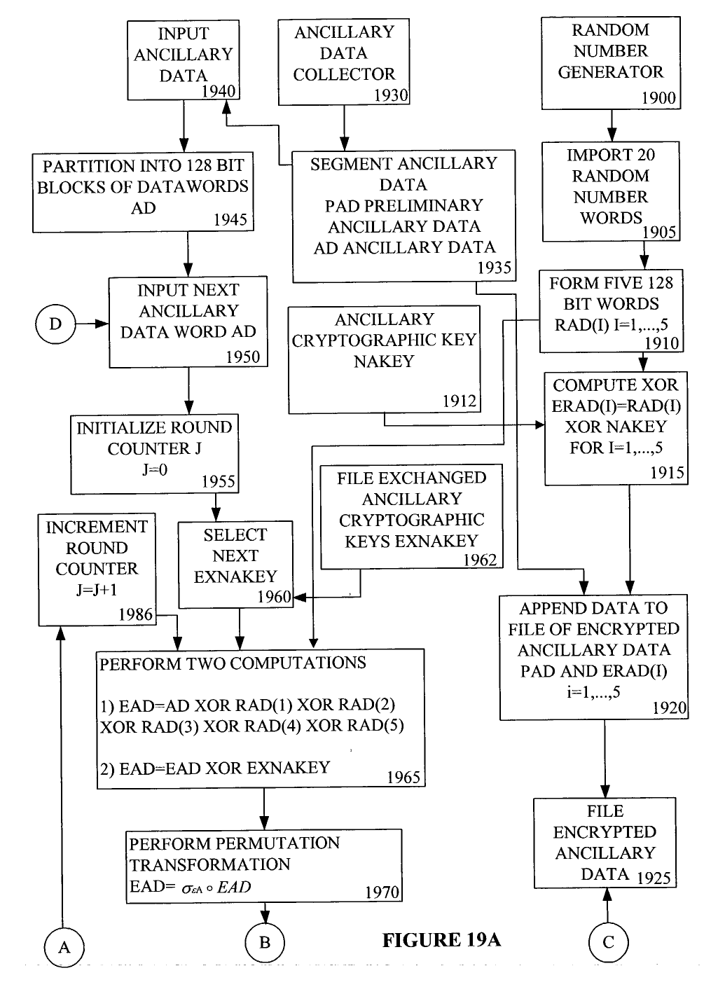

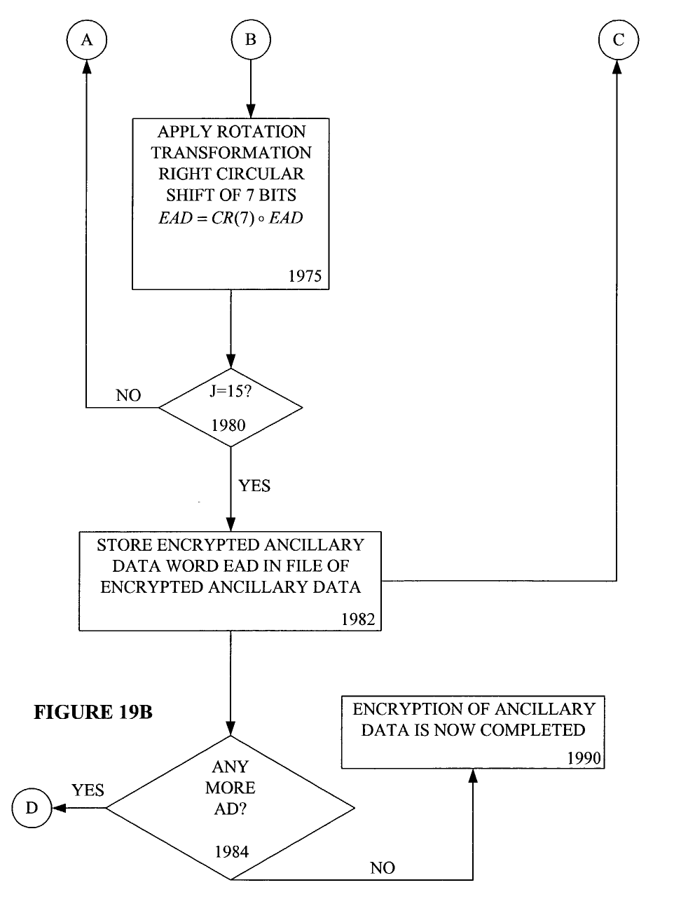

FIGS. 19A and 19B are a block diagram of the method for encryption of the ancillary data. Referring to FIG. 19A, the first step in the procedure is to import 20 random data words 1905 from the random number generator 1900 and form five 128 bit words 1910. Each random number data word is 32 bits long. Concatenating four of these random number words produces a 128-bit word of randomnized bit data. This operation is described in the following equation:

$$\{ \begin{matrix}RAD ( 1 ) \\ RAD ( 2 ) \\ RAD ( 3 ) \\ RAD ( 4 ) \\ RAD ( 5 )\end{matrix} \}$$

The next step in the procedure is to XOR each RAD(I) with NAKEY 1912, the ancillary cryptographic key, to form the words ERAD(I) 1915. This is shown in the following equation:

$$\{ \begin{matrix}ERAD ( 1 ) = RAD ( 1 ) XOR NAKEY \\ ERAD ( 2 ) = RAD ( 2 ) XOR NAKEY \\ ERAD ( 3 ) = RAD ( 3 ) XOR NAKEY \\ ERAD ( 4 ) = RAD ( 4 ) XOR NAKEY \\ ERAD ( 5 ) = RAD ( 5 ) XOR NAKEY\end{matrix} \}$$

The next step is to append the ERAD data as preliminary ancillary data to the file of encrypted ancillary data 1920.

The next step in the process for the encryption of the ancillary data is to input the ancillary data from the ancillary data collector 1930. This data is then segmented 1935 into the following two segments: (1) PAD, preliminary ancillary data; and (2) AD, ancillary data. The preliminary ancillary data are required before the decryption procedure can be initiated. PADs are used to generate the exchanged primary cryptographic keys, the exchanged ancillary cryptographic keys, seed data for the random number generator, and seed data for the decryption method for ancillary data. After the segmentation of the ancillary data is completed, all of PAD is then appended to the file of encrypted ancillary data 1925.

The next step in the procedure is to input the ancillary data 1940, the data previously classified as AD data. This data is then partitioned into blocks of data consisting of 128 bits each 1945. This data is denoted in the following discussion as AD.

The next step in the procedure is the iterative loop for the encryption of ancillary data. The first block of ancillary data, AD, is then inputted to the process 1950.

The next step in the procedure is to initialize the round counter, J. This is accomplished by setting J=0 1955.

The next step in the procedure is to perform two separate computations 1965. They involve XORing the incoming ancillary data, AD, first with RAD(I) data and then with the next exchanged cryptographic ancillary key 1960 from the file of exchanged ancillary cryptographic key 1962. These computations are expressed in the following two equations.

EAD=EAD XOR RAD(1)XOR RAD(2)XOR RAD(3)XOR RAD(4)

EAD=EAD XOR NAKEY

In the above expressions, we have renamed the value AD to EAD after these operations to indicate that encryption processing has occurred.

The next step in the process is to apply a permutation transformation, σ_{EA}, to EAD 1970. This permutation transformation is described by the following equation:

$${σ}_{EA} : {b}_{i} -> {c}_{j} , where j = k + [ ( int ( \frac{i}{8} ) + 3 ) mod16 ] * 8$$

$$\{ \begin{matrix}k = 0 ⇔ ( i mod 8 ) = 7 \\ k = 1 ⇔ ( i mod 8 ) = 6 \\ k = 2 ⇔ ( i mod 8 ) = 5 \\ k = 3 ⇔ ( i mod 8 ) = 4 \\ k = 4 ⇔ ( i mod 8 ) = 3 \\ k = 5 ⇔ ( i mod 8 ) = 2 \\ k = 6 ⇔ ( i mod 8 ) = 1 \\ k = 7 ⇔ ( i mod 8 ) = 0\end{matrix} \}$$

The resultant to EAD is given by the following equation:

EAD=σ_{EA}∘EAD

Referring to FIG. 19B, the next step in the procedure is to apply a right circular shift of bits with the bit shift to the right being 7 bits 1975. This is described by the following equation:

EAD=CR(7)∘EAD

This completes the iterative segment of the encryption method for ancillary data. Therefore the next step checks to see if the iterative loop has been completed. This is accomplished by checking to see if J=15 1980. If the answer is yes the iterative loop has been completed for the inputted AD 1982. If not, then the value of J is incremented by one 1986 and the iterative computational process is continued 1965 (FIG. 19A).

Once an iterative loop has been completed, the encrypted ancillary data, EAD, is stored in the file of encrypted ancillary data 1925.

After this step a check is made to determine if there are any additional AD data requiring encryption 1984 (FIG. 19B). If yes, then the next AD data is imputed 1950 (FIG. 19A) and the iterative process of encrypting a block of ancillary data is initialized. If there are no additional AD data requiring encryption, then the encryption process for the ancillary data is completed 1990 (FIG. 19B).

The next segment in the process of the encryption is the encryption cryptographic engine, which puts together all the previous processing into a very hard mathematically intractable cryptographic algorithm.

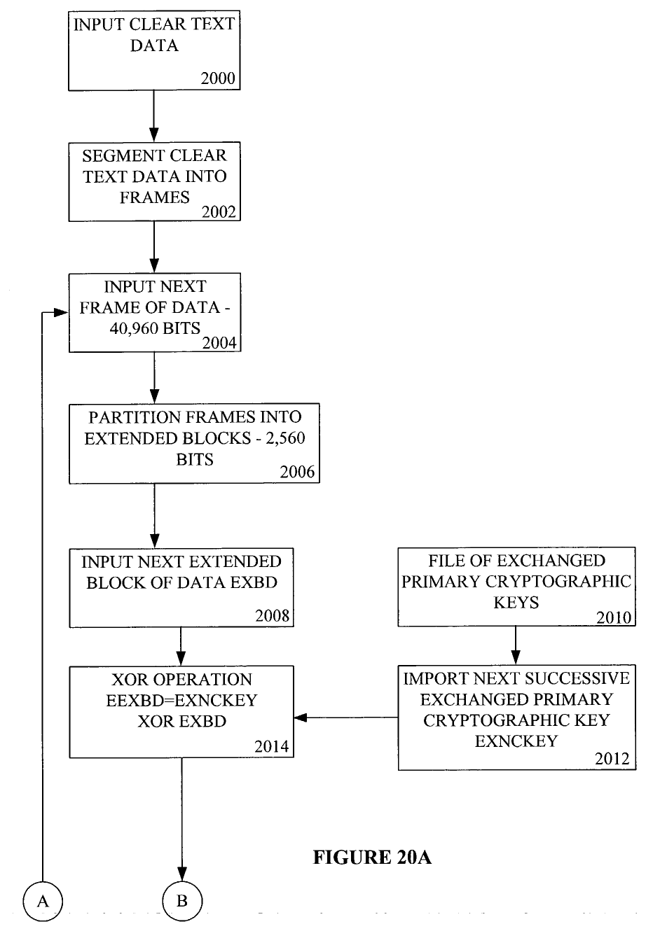

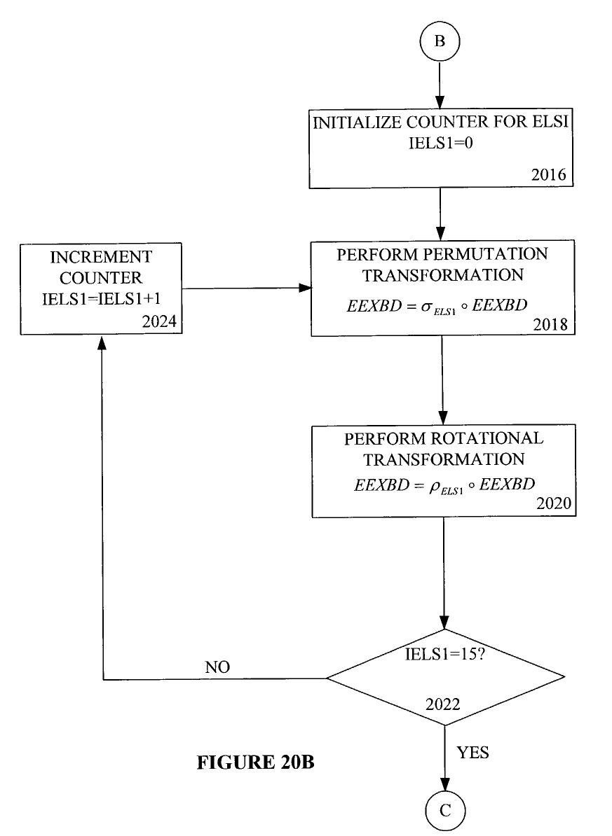

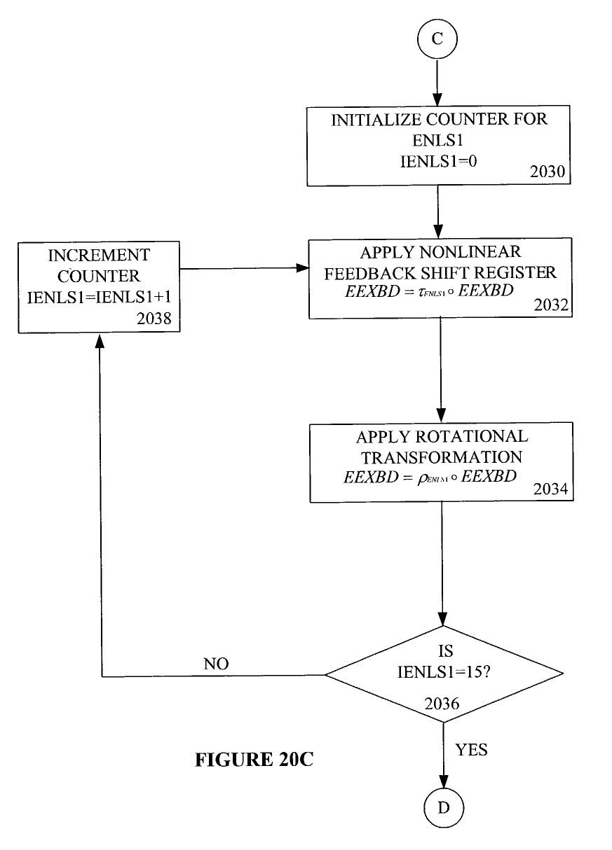

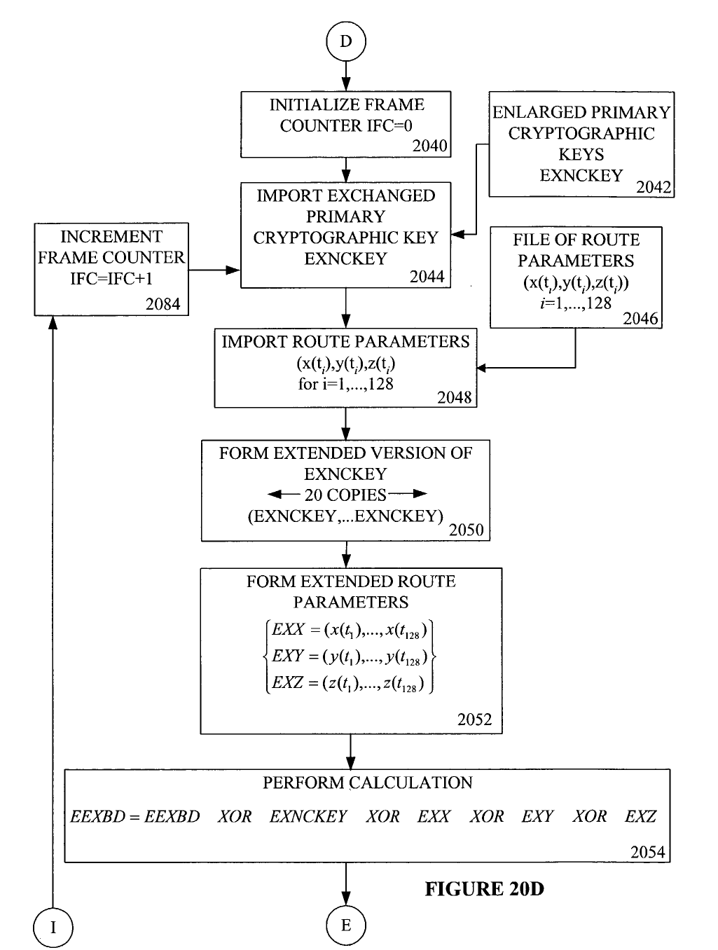

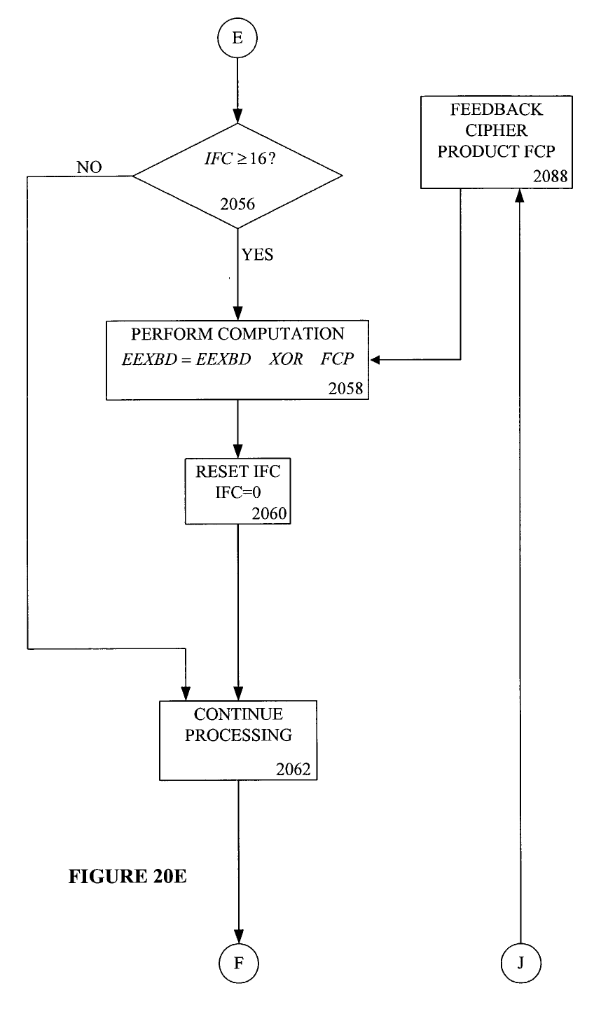

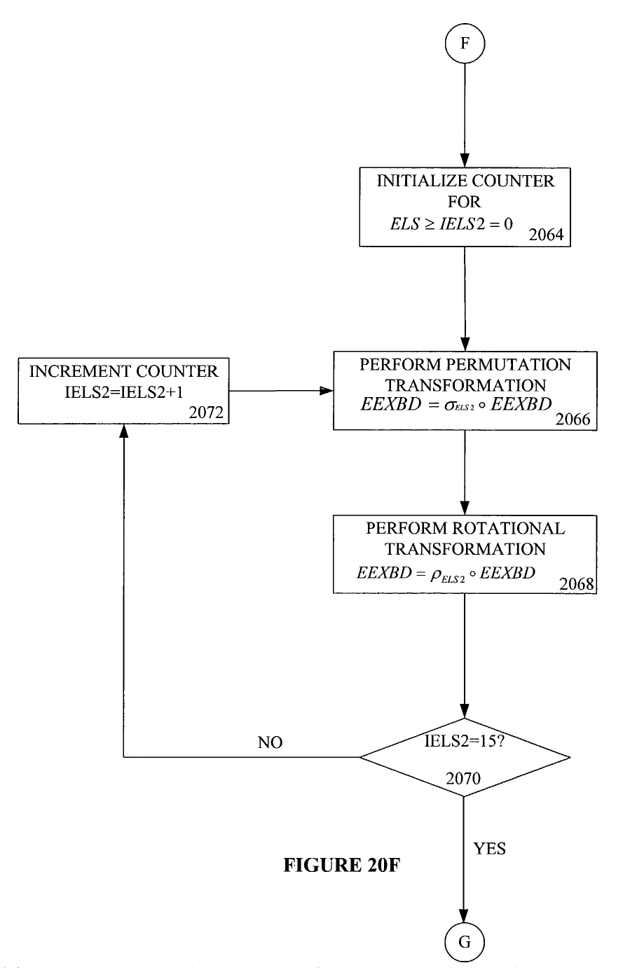

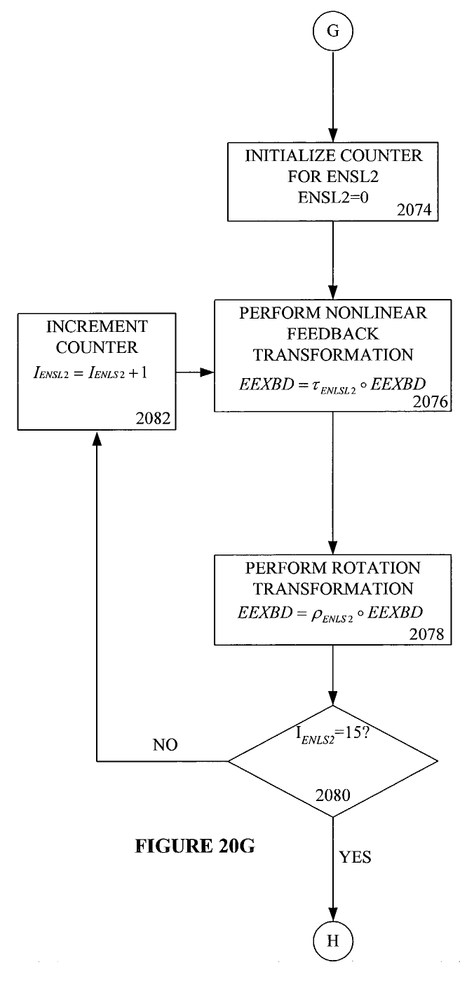

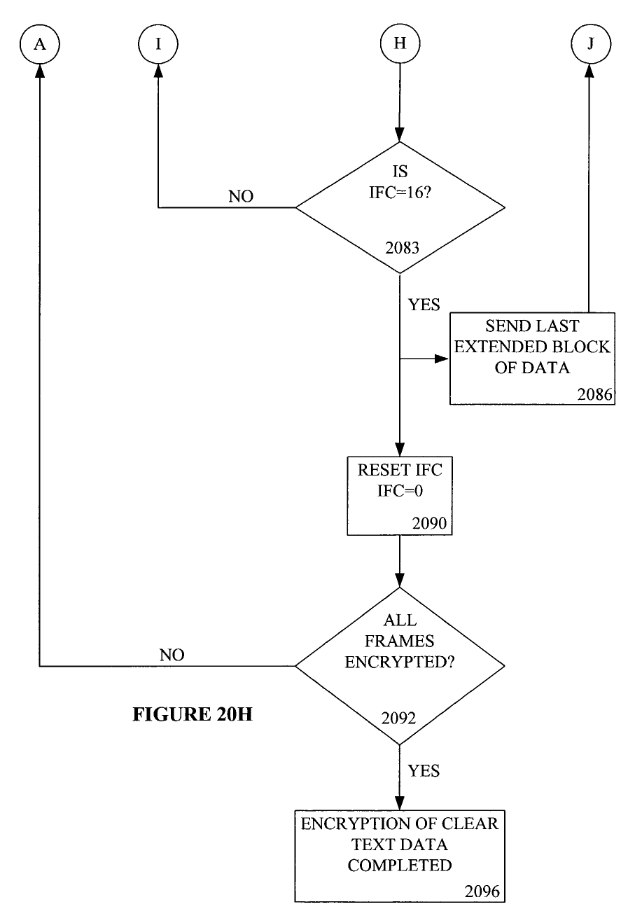

The process is illustrated in the block diagram contained in FIGS. 20A, 20B, 20C, 20D, 20E, 20F, 20G, and 20H. Referring to FIG. 20A, the first step in the process is to input the clear text data 2000.

The next step in the process is to segment the clear text data into frames 2002. In this embodiment, each frame consists of exactly 40,960 bits. If the last frame is less than 40,960 bits then a sequence of zeroes is appended to the right hand side of the frame to ensure that the last frame consists of exactly 40,960 bits.

The next step in the procedure is to input the next successive frame of 40,960 bits 2004.

The next step consists of partitioning a frame into extended blocks of data 2006. Each extended block of data consists of exactly 2,560 bits of data.

The next step in the procedure consists of inputting the next successive extended block of data 2008, consisting of 2,560 bits of data. This extended block of data is denoted in the following discussion as EXBD.

The next step in the procedure is to import from the file of exchanged primary cryptographic keys 2010 the next successive exchanged primary cryptographic key 2012, EXNCKEY, and XOR that key 2014 with the extended block data word, EXBD. This produces the result of EEXBD. This is illustrated in the following equation: Because the EEXBD consists of 2,560 bits of data and the EXNCKEY consists of 128 bits of data, it is required that 20 copies of EXNCKEY be used in this XOR operation.

EEXBD=EXNCKEY XOR EXBD

The next step in the procedure is to process the first linear bit smoothing segment, which is denoted by ELS1. ELS1 is the first linear smoothing segment of the encryption process. As is shown in FIG. 20B, the first step in the process is to initialize the counter for ELS1, IELS1. This is accomplished by setting IELS1=0 2016.

The next step in the process is to apply the permutation transformation, σ_{ELS1}, to EEXBD 2018. Again because EEXBD consists of 2,560 bits and the permutation transformation is a mapping of 128 bits, one has to use 20 copies of the permutation transformation to affect the complete permutation transformation of EEXBD.

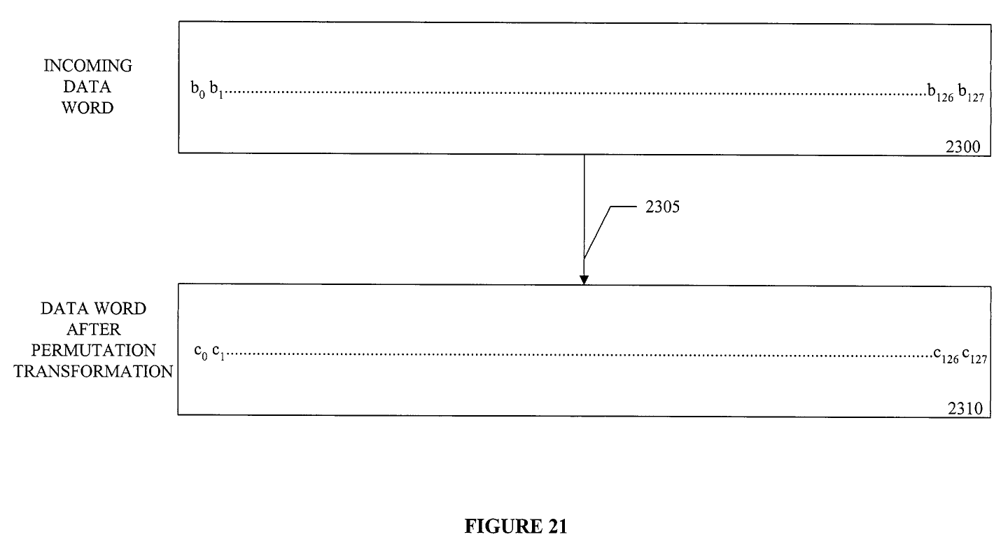

The permutation transformation, σ_{ELS1}, is illustrated in FIG. 21. Referring to FIG. 21, an incoming data word 2300 is operated on by transformation σ_{ELS1} 2305 resulting in a new data word 2310. The transformation products are set forth below:

$$\begin{matrix}{C}_{i} = {b}_{15 - i} & 0 \leq i \leq 7 \\ {C}_{i} = {b}_{15 - ι} & 8 \leq i \leq 15 \\ {C}_{i} = {b}_{47 - i} & 16 \leq i \leq 23 \\ {C}_{i} = {b}_{47 - i} & 24 \leq i \leq 31 \\ {C}_{i} = {b}_{79 - i} & 32 \leq i \leq 47 \\ {C}_{i} = {b}_{111 - ι} & 48 \leq i \leq 63 \\ {C}_{i} = {b}_{143 - ι} & 64 \leq i \leq 79 \\ {C}_{i} = {b}_{175 - ι} & 80 \leq i \leq 95 \\ {C}_{i} = {b}_{207 - i} & 96 \leq i \leq 111 \\ {C}_{i} = {b}_{239 - i} & 112 \leq i \leq 127\end{matrix}$$

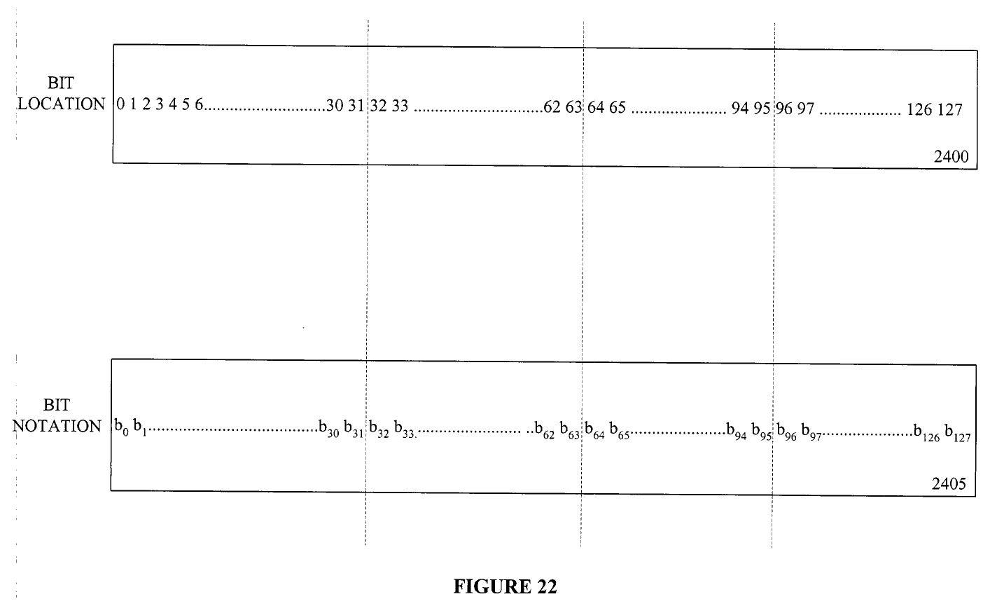

For clarity purposes, an overview of the bit nomenclature used herein is provided in FIG. 22. Referring to FIG. 22, the use of subscripts to designate bits within words is illustrated.

Again referring to FIG. 20B, the application of the permutation transformation σ_{ELS1} to EXBD is expressed in the following equation: The resultant of this transformation is denoted by EEXBD.

EEXBD=σ_{ELS1}∘EXBD

Next a rotational transformation is applied to EEXBD 2020. Again the rotational transformation is defined for 128 bits, therefore 20 copies of the rotational transformation are required to effect the rotational transformation on the 2,560 bit word EEXBD.

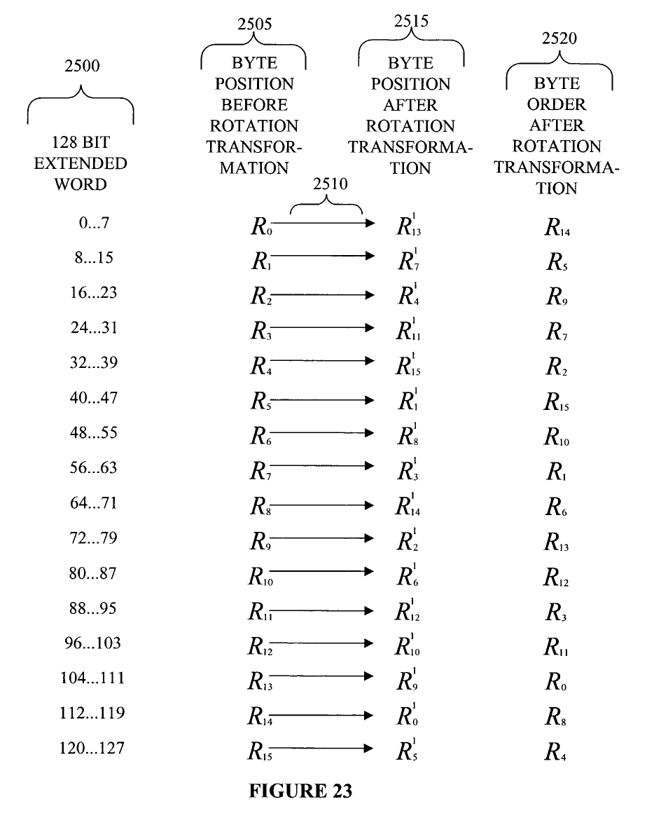

This rotational transformation, σ_{ELS1}, is defined in detail in FIG. 23. The rotational transformation is expressed in the following equation:

EEXBD=ρ_{ELS1}∘EESBD

Referring to FIG. 23, a 128-bit word 2500 comprises 16 8-bit words (each 1 byte) 2505. The rotation transformation is applied 2510 and the byte position after rotation, R′, is given 2515. The actual order of the bytes after rotation 2520 is also illustrated.

Referring again to FIG. 20B, the next step in the procedure is to check if the iterative loop for ELS1 has been completed. This is accomplished by checking if IELS1=15 2022. If the answer is not, then the counter, IELS1 is incremented by one 2024 and the iterative process for ELS1 is continued 2018 (FIG. 20A). If the answer is yes, then the process is transferred to ENLS1.

Returning to FIG. 20C, the next segment in the process is the first nonlinear bit smoothing, ENLS1. The first step in the procedure is to initialize the counter for ENLS1, IENLS1. This is accomplished by setting IENLS1=0 2030.

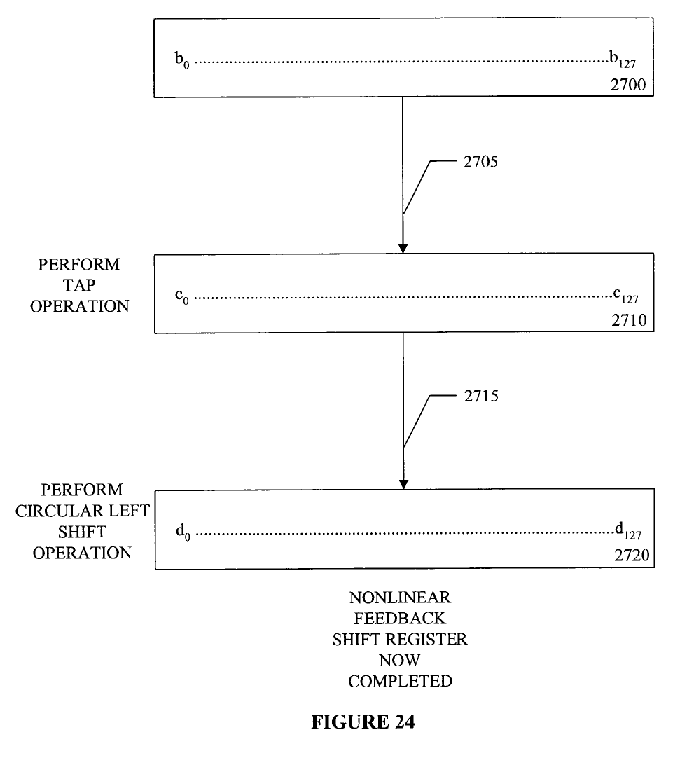

The first step in the iterative process for ENLS1 is to apply a nonlinear feedback shift register 2032, which is illustrated in FIG. 24. Referring to FIG. 24, an incoming extended data word 2700 is operated on by a tap operation 2705 to produce intermediate product 2710. The tap operation is described by the following equations:

Incoming extended data word:

tap bits={3, 37, 93}.

taps={(φ₀, {a₇}), (φ₁, {a₄₃)}, (φ₂(a, a₉))}

where φ₀=φ₁=φ₂=ˆ (exclusive OR)

c₃=b₃ˆ b₇

c₃₇=b₃₇ˆ b₄₃

c₉₃=b₉₃ˆ b₉₁

cᵢ=cᵢ all i≠3, 37, 93

The intermediate produce is then subjected to a circular left shift operation 2715 producing a new word 2720. The circular left shift operation is described by the following equations:

N₁=7

dᵢ=cᵢ₊₇ for i=0, . . . , N−7−1

dᵢ=c_{N-i-1} for i≦N−7

Referring again to FIG. 20C, the nonlinear feedback shift register, τ_{ENLS1}, is a 128 bit shift register, therefore 20 copies of it are required to effect the feedback transformation of the data EEXBD. This is expressed in the following equation:

EEXBD=τ_{ENLSL1}∘EEXBD

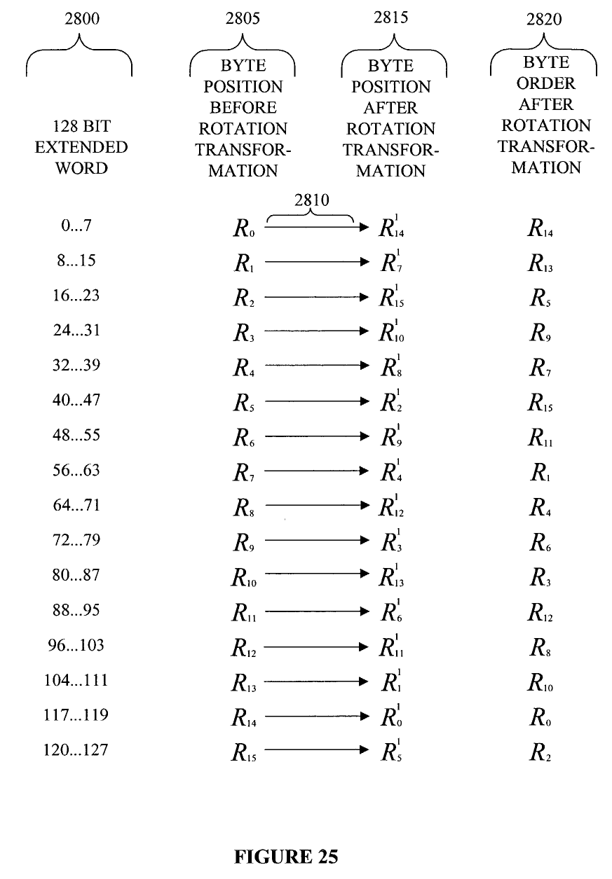

The next step in the iterative process for ENLS1 is to apply the rotational transformation 2034, which is denoted by ρ_{ENLS1}. FIG. 25 illustrates the rotational transformation, ρ_{ENLS1}. Referring to FIG. 25, a 128-bit word 2800 comprises 16 8-bit words (each 1 byte) 2805. The rotation transformation is applied 2810 and the byte position after rotation, R′, is given 2815. The actual order of the bytes after rotation 2820 is also illustrated

The rotational transformation ρ_{ENLS1} is defined for 128-bit words, therefore 20 copies of it are required to complete the rotational transformation for the 2,560 bit word, EEXBD. The equation expressing this rotational transformation is given below.

EEXBD=ρ_{ENSL1}∘EEXBD

Referring again to FIG. 20C, the next step in the iterative process is to check to determine if the iterative loop has been completed. This is accomplished by checking if IENLS1=15 2036. If the answer is yes, then the iterative loop is completed and the processing continues with ELS2. If the answer is no, then the loop counter is incremented by one 2038 and the processing of the iterative loop continues 2032. This is accomplished by the following equation:

IENLS1=IENLS1+1

The next segment is to process ES. Referring to FIG. 20D, the first step in the procedure is to initialize the frame counter, IFC. This is accomplished by setting IFC=0 2040.

The next step in the procedure is to import the next succeeding exchanged primary cryptographic key 2044, denoted by EXNCKEY, from the file of exchanged primary cryptographic keys 2042.

The next step in the procedure is to import the route parameters 2048 from the file of route parameters 2046, which are given by the following equation:

{x(t),y(t),z(t)}

The next step in the procedure is to form an extended block version of the exchanged primary cryptographic key EXNCKEY 2050. This is accomplished through the concatenation of 20 copies of EXNCKEY.

The next step in the procedure is to form extended versions of the route parameters 2052. Here 128 values are concatenated to form the extended block version as is described by the following equation:

$$\{ \begin{matrix}EXX = ( x ( {t}_{1} ) , … , x ( {t}_{128} ) \\ EXY = ( y ( {t}_{1} ) , … , y ( {t}_{128} ) \\ EXZ = ( z ( {t}_{1} ) , … , z ( {t}_{128} )\end{matrix} \}$$

The next step in the procedure is to perform the nonlinear transformation 2054 given by the following equation:

EEXBD=EEXBD XOR EXNCKEY XOR EXX XOR EXY XOR EXZ

Referring to FIG. 20E, the next step in the procedure is to check to see if we are at then of a frame. This is accomplished by checking to see if IFC is greater than or equal to 16 2056. If the answer is yes, then the end of a frame of text data has been reached. If this is the case, the now available feedback cipher product, FCP, 2088 is obtained and the calculation 2058 given by the following equation performed:

EEXBD=EEABD XOR FCP

The frame counter, FCP, is then reset to 0 2060 and the processing continues 2062.

If the answer was no, that is IFC<16, then no computation or resetting is required and the processing continues 2062.

The next step in the procedure is to process the second linear bit smoothing segment, which is denoted by ELS2. ELS2 is the second linear smoothing segment of the encryption process. Returning to FIG. 20F, the first step in the process is to initialize the counter for ELS2, IELS2. This is accomplished by setting IELS2=0 2064.

The next step in the process is to apply the permutation transformation, σ_{ELS2}, to EEXBD 2066. Again, because EEXBD consists of 2,560 bits and the permutation transformation is a mapping of 128 bits, one has to use 20 copies of the permutation transformation to affect the complete permutation transformation of EEXBD.

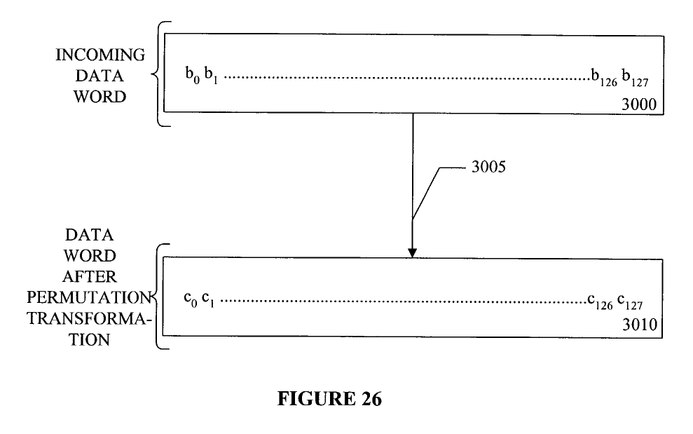

The permutation transformation, σ_{ELS2}, is defined in detail in FIG. 26. Referring to FIG. 26, an incoming data word 3000 is operated on by transformation σ_{ELS2} 3005 resulting in a new data word 3010. The transformation products are set forth below:

| | |
|---|---|
| cᵢ = b₆₃₋ᵢ | 0 ≦ i ≦ 15 |
| cᵢ = b₆₃₋ᵢ | 16 ≦ i ≦ 31 |
| cᵢ = b₆₃₋ᵢ | 32 ≦ i ≦ 47 |
| cᵢ = b₆₃₋ᵢ | 48 ≦ i ≦ 63 |
| cᵢ = b₁₉₁₋ᵢ | 64 ≦ i ≦ 127 |

To enhance the discussion, an overview of the bit nomenclature used in this discussion is contained in FIG. 22. This application is expressed in the following equation: The resultant of this transformation is denoted by EEXBD.

EEXBD=σ_{ELS2}∘EEXBD

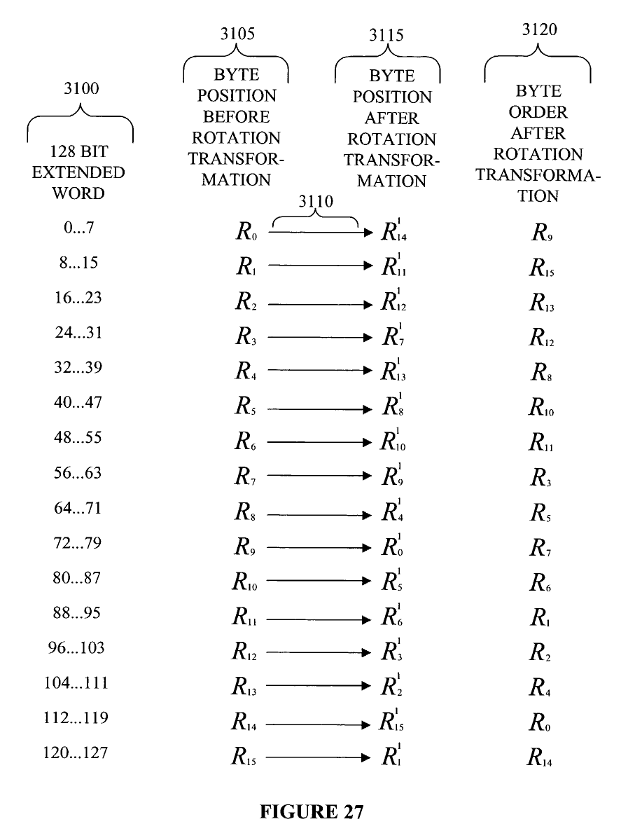

Referring to FIG. 20F, a rotational transformation is applied to EEXBD 2068. Again, the rotational transformation is defined for 128 bits, therefore 20 copies of the rotational transformation are required to effect the rotational transformation on the 2,560 bit word EEXBD. This rotational transformation, ρ_{ELS2}, is illustrated in FIG. 27.

Referring to FIG. 27, a 128-bit word 3100 comprises 16 8-bit words (each 1 byte) 3105. The rotation transformation is applied 3110 and the byte position after rotation, R′, is given 3115. The actual order of the bytes after rotation 3120 is also illustrated. The rotational transformation is expressed in the following equation:

EEXBD=ρ_{ELS2}∘EEXBD

Referring again to FIG. 20F, the next step in the procedure is to check if the iterative loop for ELS2 has been completed. This is accomplished by checking if IELS2=15 2070. If the answer is no, then the counter, IELS2 is incremented by one 2072 and the iterative process for ELS2 is continued 2066. If the answer is yes, then the process is transferred to ENLS2.

Referring to FIG. 20G, the next segment in the process is the second nonlinear bit smoothing, ENLS2. The first step in the procedure is to initialize the counter for ENLS2, IENLS2. This is accomplished by setting IENLS2=0 2074.

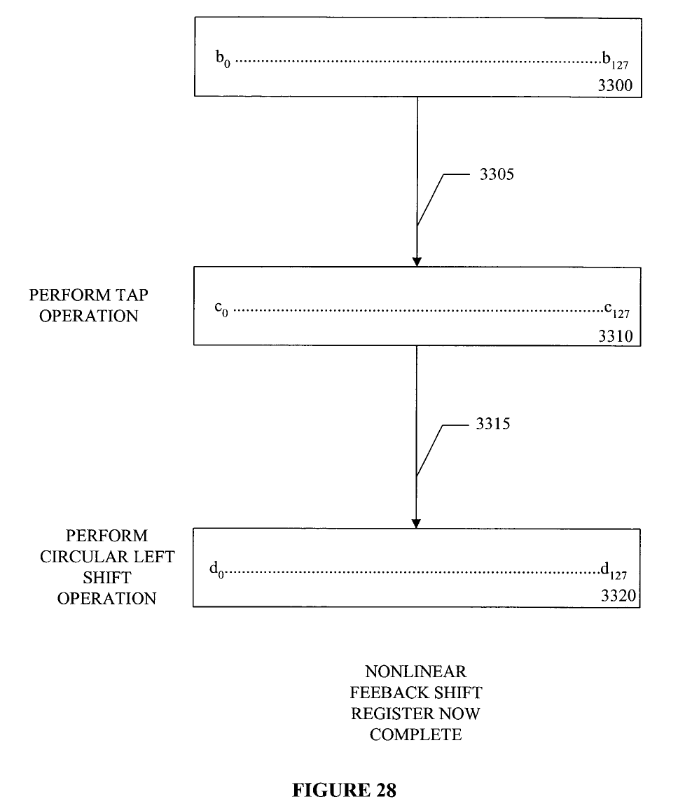

The first step in the iterative process for ENLS2 is a nonlinear feedback shift register 2076, which is illustrated in FIG. 28.

Referring to FIG. 28, an incoming extended data word 3300 is operated on by a tap operation 3305 to produce intermediate product 3310. The tap operation is described by the following equations:

tap bits={7, 43, 117}

taps={(φ₀, {a₉)), (φ₁, {a₃₉}), (φ₂{a₁₂₃})}

where φ₀=φ₁=φ₂=ˆ (exclusive OR)

c₇=b₇ˆ b₉

c₄₃=b₄₃ˆ b₃₉

c₁₁₇=b₁₁₇ˆ b₁₂₃

The intermediate product is then subjected to a circular left shift operation 3315 producing a new word 3320. The circular left shift operation is described by the following equations:

n₁=11

dᵢ=cᵢ+11 for i=0, . . . ,N−1−1

dᵢ=c_{N-i-1} for i≧N−11

Referring again to FIG. 20G, the nonlinear feedback shift register, τ_{ENLS2}, is a 128 bit shift register, therefore 20 copies of it are required to effect the feedback transformation of the data EEXBD. This is expressed in the following equation:

EEXBD=τ_{ENLSL2}∘EEXBD

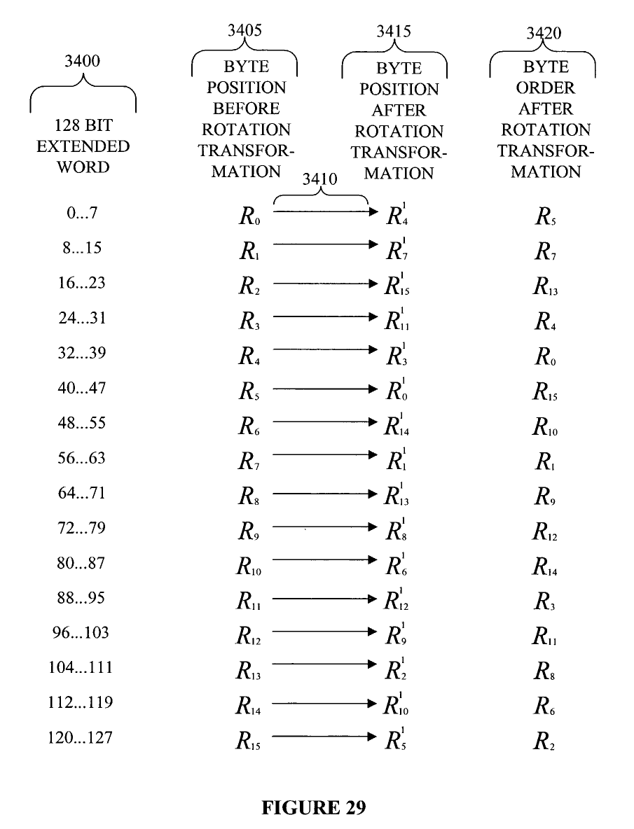

The next step in the iterative process for ENLS2 is to apply the rotational transformation 2078, which is denoted by ρ_{ENLS2}. The rotational transformation, ρ_{ENLS2}, is illustrated in FIG. 29.

Referring to FIG. 29, a 128-bit word 3400 comprises 16 8-bit words (each 1 byte) 3405. The rotation transformation is applied 3410 and the byte position after rotation, R′, is given 3415. The actual order of the bytes after rotation 3420 is also illustrated.

As ρ_{ENLS2} is defined for 128 bit words, therefore 20 copies of it are required to complete the rotational transformation for the 2,560 bit word, EEXBD. The equation expressing this rotational transformation is given below.

EEXBD=ρ_{ENLS2}∘EEXBD

Referring to FIG. 20G, the next step in the iterative process is to check to determine if the iterative loop has been completed. This is accomplished by checking if IENLS2=15 2080. If the answer is yes, then the iterative loop is completed and the processing continues. If the answer is no, then the loop counter is incremented by one 2082 and the processing of the iterative loop continues 2076. This is accomplished by the following equation:

IENLS2=IENLS2+1

Referring to FIG. 20H, the next steps in the procedure involved in the cryptographic engine for the present embodiment involves checking if frame processing is completed and resetting counters if the current frame data has been processed.

The first step is to check if IFC=16 2083. If the answer is no, then frame counter IFC is incremented by one 2084 and the iterative processing for the current frame data continues 2044. If the answer is yes, then the iterative processing for the current frame data has been concluded. In this case, the counter, IFC, is reset to zero 2090. In addition the last extended encrypted block of data, consisting of 2,560 bits is send forward 2086 to become the next successive feedback cipher product, FCP. The FCP is always used in rounds after the first as a feedback enciphering control for the cryptographic engine for the encryption of wideband digital data.

Next a determination is made if all frames have been encrypted 2092. If not, then the iterative process continues 2004. If the answer is yes, then all frames of clear text data have been encrypted by present embodiment. In this case the encryption process is concluded 2096.

2. Decryption Process

In the preceding paragraphs, an exemplary embodiment of the present invention is described in which a number of assumptions were identified and used to implement an encryption method according to the present invention. In the paragraphs that follow, the same assumptions are used to implement a decryption method according to the present invention. As in the case of the exemplary embodiment for an encryption method, the assumptions and details relating the decryption method described below are intended only to illustrate a possible embodiment of the present invention and not as limitations.

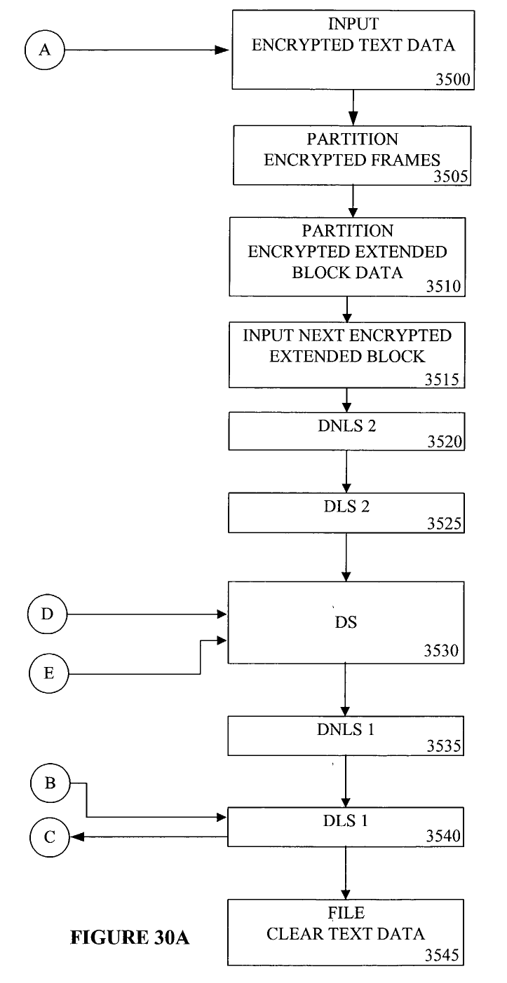

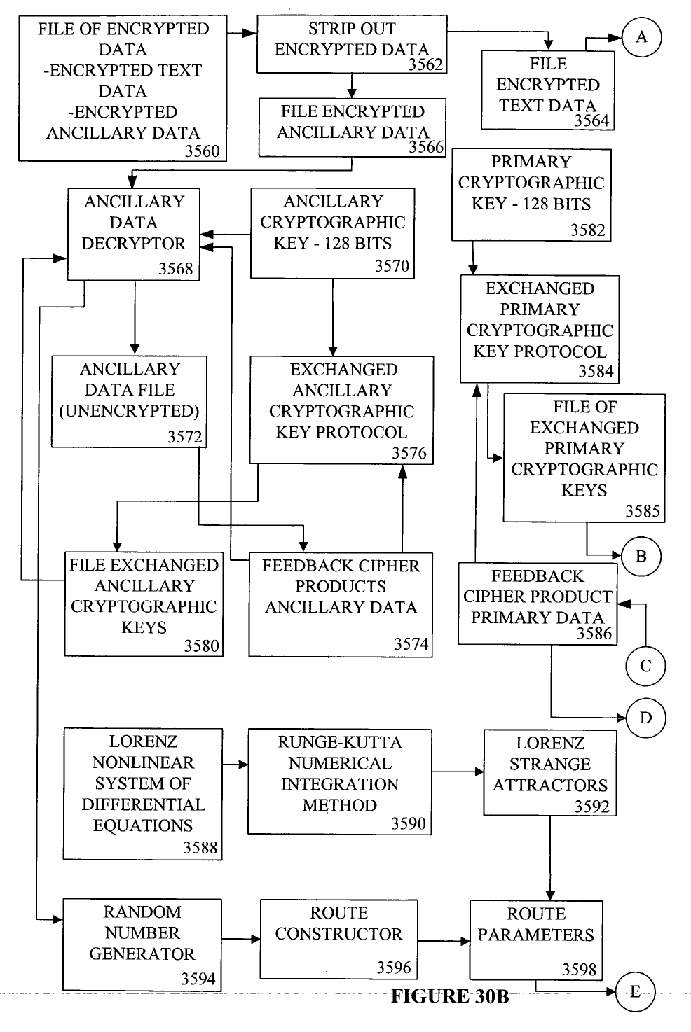

Decryption reverses the encryption process for both the encrypted text data and for the encrypted ancillary data. An overview of this process is illustrated in FIGS. 30A and 30B. The major components of this embodiment comprise protocols for the generation of exchanged cryptographic keys, the ancillary data decryptor, the generation of routes, Lorenz strange attractors, route parameters, and the decryption cryptographic engine.

FIGS. 30A and 30B parallel FIGS. 9A and 9B but with more details relating to the implementation decisions made for the exemplary embodiment. Referring to FIG. 30A, encrypted text data is received 3500, partitioned into encrypted frames 3505, and partitioned into encrypted extended block data 3510. The next encrypted extended block is inputted 3515 into the second nonlinear smoothing segment (DNLS2) 3520, the output of which is then processed by the second linear smoothing segment (DLS2) 3525. The result of this operation is then decrypted 3530 using a nonlinear decryption algorithm DS that reverses the encryption process. The output of DS is processed by the first nonlinear smoothing segment (DNLS1) 3535. The result of this process is then processed by the first linear smoothing segment (DLS1) 3540. The result of this latter operation is a clear text data file 3545.

The operations described in relationship to FIG. 30A depend on external inputs from a number of other processes. These processes are illustrated in FIG. 30B. The file of encrypted data created as a product of the encryption process of the exemplary encryption embodiment is accessed 3560. The encrypted data is stripped out 3562 and filed 3564. This is the data that was decrypted in the process beginning at 3500. The file of encrypted ancillary data 3566 is also captured and sent to an ancillary data decryptor 3568. The ancillary cryptographic key 3570, feedback cipher products 3574, and an exchanged ancillary cryptographic key obtained from the file of exchanged ancillary cryptographic keys 3580 are used by the ancillary data decryptor to produce a file of unencrypted ancillary data 3572. The exchanged ancillary cryptographic key protocol is obtained 3576 from the ancillary data and using the ancillary cryptographic key, a file of exchanged cryptographic keys is generated 3580.

A file of exchanged primary cryptographic keys is generated from the primary cryptographic key 3582 and feedback cipher product primary data 3586 using the exchanged primary cryptographic key protocol 3584.

The Lorenz nonlinear differential equations 3588 are integrated using the Runge-Kutta numerical integration method 3590 to produce Lorenz strange attractors 3592. A random number generator 3594 feeds a route constructor 3596 to produce routes that are then used to produce route parameters 3598.

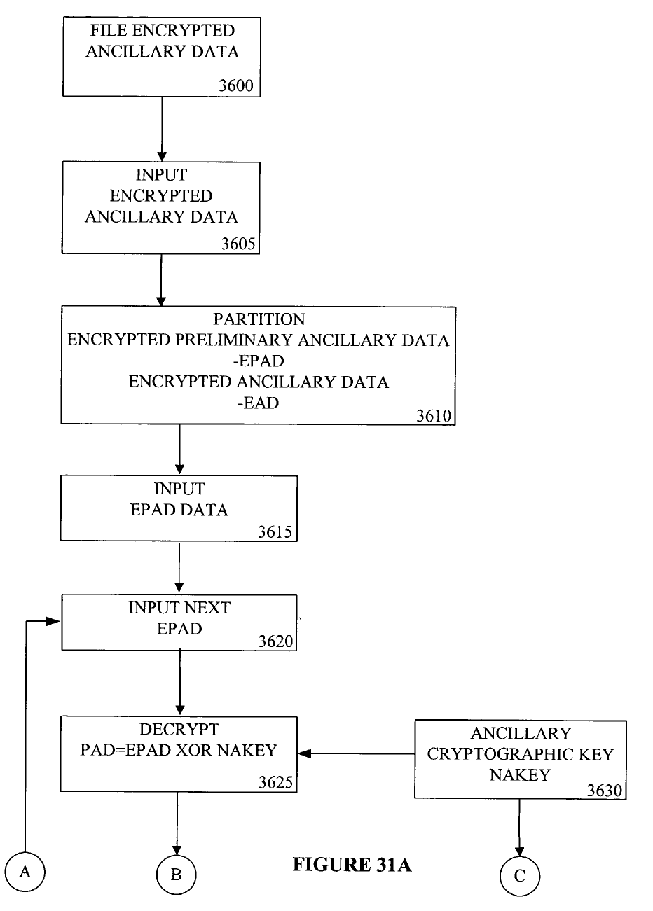

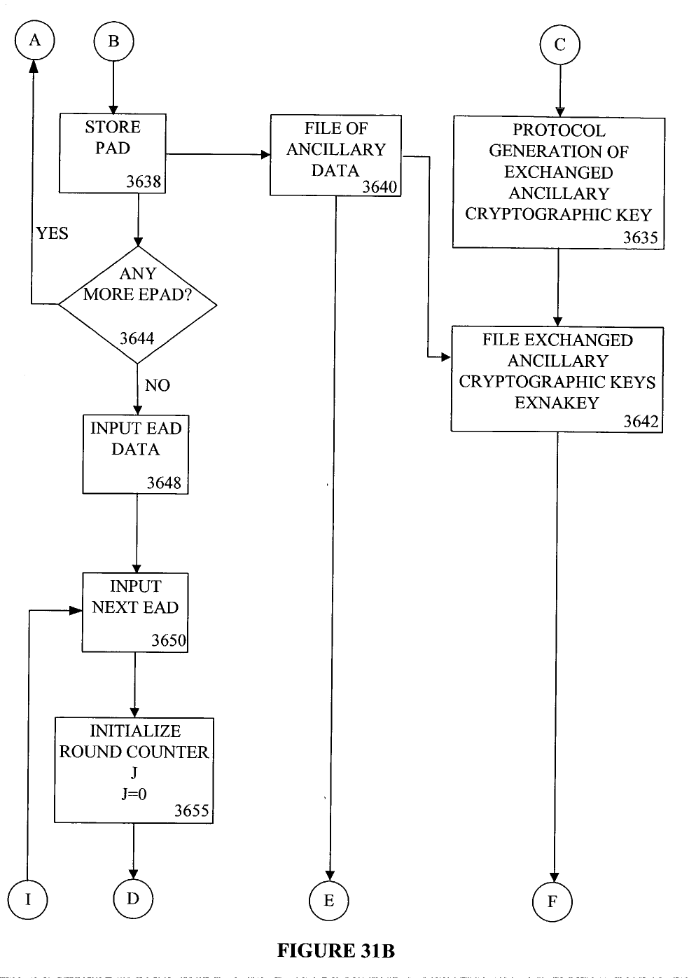

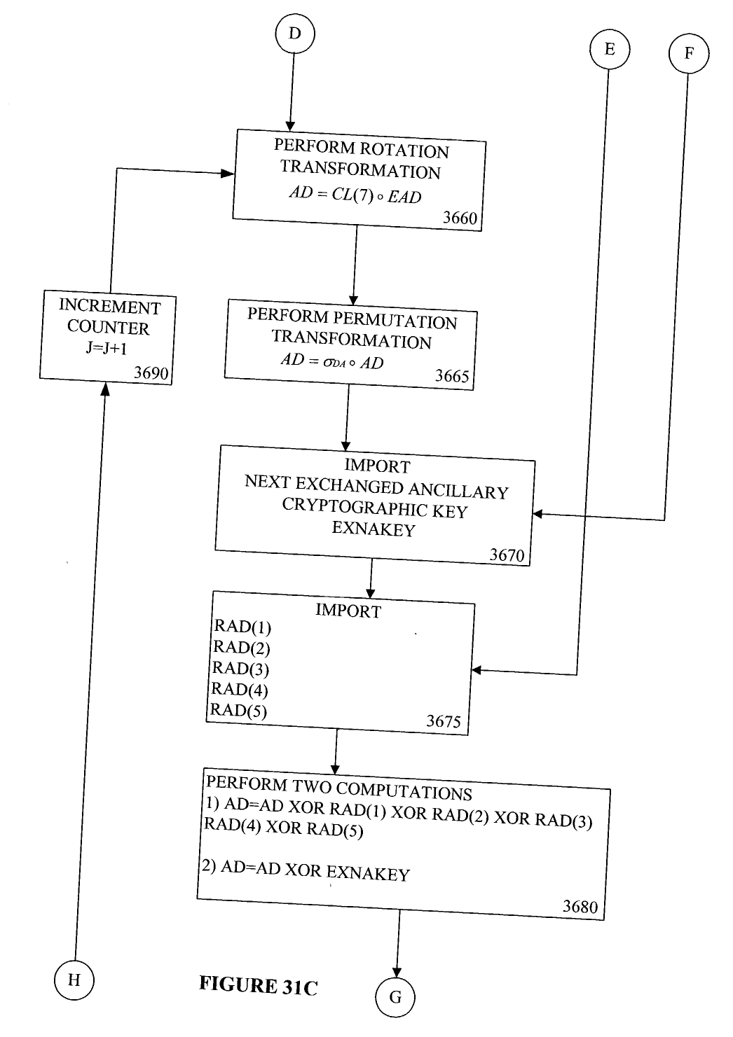

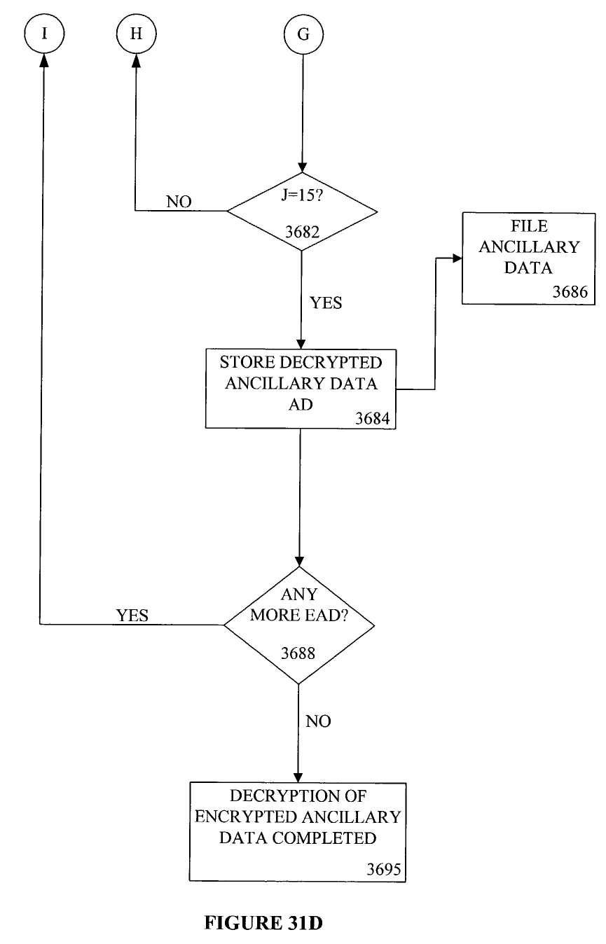

Referring to FIG. 31A, the first segment in the process of decryption is to access the file of encrypted ancillary data 3600 and input the encrypted ancillary data to the “ancillary data” decryption engine 3605. The encrypted ancillary data is partitioned into two sub-files 3610: (: (1) EPAD, encrypted preliminary ancillary data; and (2) EAD, encrypted ancillary data.

The EPAD data is processed first by the ancillary data decryptor. This is because some of PAD data is required (in unencrypted form) to decrypt the EAD data. The process begins by inputting the EPAD data 3615 and then inputting the next block of EPAD data 3620. Within the ancillary data, blocks of data consist of 128 bits.

Each block of EPAD data is then decrypted 3625 by XORing it with the ancillary cryptographic key 3630 as is shown by the following equation:

PAD=EPAD XOR NAKEY

Referring to FIG. 31B, the next step in the procedure is to store the now unencrypted PAD data 3638 in the file of ancillary data 3640. Some of the PAD data is used in the protocol for the generation of exchanged ancillary cryptographic keys. Thus this functionality is proceeding in parallel with the current processing in the ancillary data decryptor. The functionality and processing for the generation of exchanged ancillary cryptographic keys will be discussed in following paragraphs.

The next step in the process is to determine if any EPAD data remain 3644. If the answer is yes then the process is continued by inputting the next EPAD data word 3620. If the answer is no, then the processing moves on to the decryption of EAD data.

The EAD data is then inputted 3648 and the next successive EAD block of data, consisting of 128 bits, is inputted 3650 to the decryption process.

The first step in this process is to initialize the round counter, J. This is accomplished by setting J=0 3655.

Referring to FIG. 31C, the next step in the procedure is to perform a rotational transformation consisting of a circular right shift of 7 bits 3660. This is described in the following equation:

AD=CL(7)∘EAD

The next step in the procedure is to perform a permutation transformation 3665 given by σ_{DA}, which is defined by the following equation:

$${σ}_{DA} : {b}_{i} -> {c}_{j} , where j = k + [ ( int ( \frac{i}{8} ) + 13 ) mod16 ] * 8$$

$$\text{with} \text{k} \text{defined by:}$$

$$\{ \begin{matrix}k = 0 ⇔ ( i mod 8 ) = 7 \\ k = 1 ⇔ ( i mod 8 ) = 6 \\ k = 2 ⇔ ( i mod 8 ) = 5 \\ k = 3 ⇔ ( i mod 8 ) = 4 \\ k = 4 ⇔ ( i mod 8 ) = 3 \\ k = 5 ⇔ ( i mod 8 ) = 2 \\ k = 6 ⇔ ( i mod 8 ) = 1 \\ k = 7 ⇔ ( i mod 8 ) = 0\end{matrix} \}$$

The permutation transformation on the AD data block is described by the following equation:

AD=σ_{DA}∘AD

The next step in the procedure is to import the next successive exchanged ancillary cryptographic key 3670, EXNAKEY, from the file of exchanged ancillary cryptographic keys.

The next step in the procedure is to import five PAD data words from the ancillary data file 3675. These five words are as follows: RAD(1); RAD(2); RAD(3); RAD(4) and RAD(5).

The next step in the procedure is to perform two computations 3680 which are given by the following two equations.

AD=AD XOR RAD(1)XOR RAD(2)XOR RAD(3)XOR RAD(4)XOR RAD(5)

AD=AD XOR EXNAKEY

Referring to FIG. 31D, a check is then made to determine if the iterative loop has completed its processing. This is accomplished by determining if J=15 3682. If the answer is no, then J is incremented by one 3690 and the iterative processing loop continues 3660. If the answer is yes, then the iterative loop processing is completed. In this case, the now decrypted ancillary data block, AD, is stored 3684 in the file of ancillary data 3686.

Then a check is made to determine if there are any remaining EAD blocks 3688. If there are additional remaining blocks of EAD data, then the next successive EAD data block is inputted 3650 and the iterative process is initialized for the processing of this EAD block.

If there are no remaining EAD blocks, then the decryption of the encrypted ancillary data has been completed 3695.

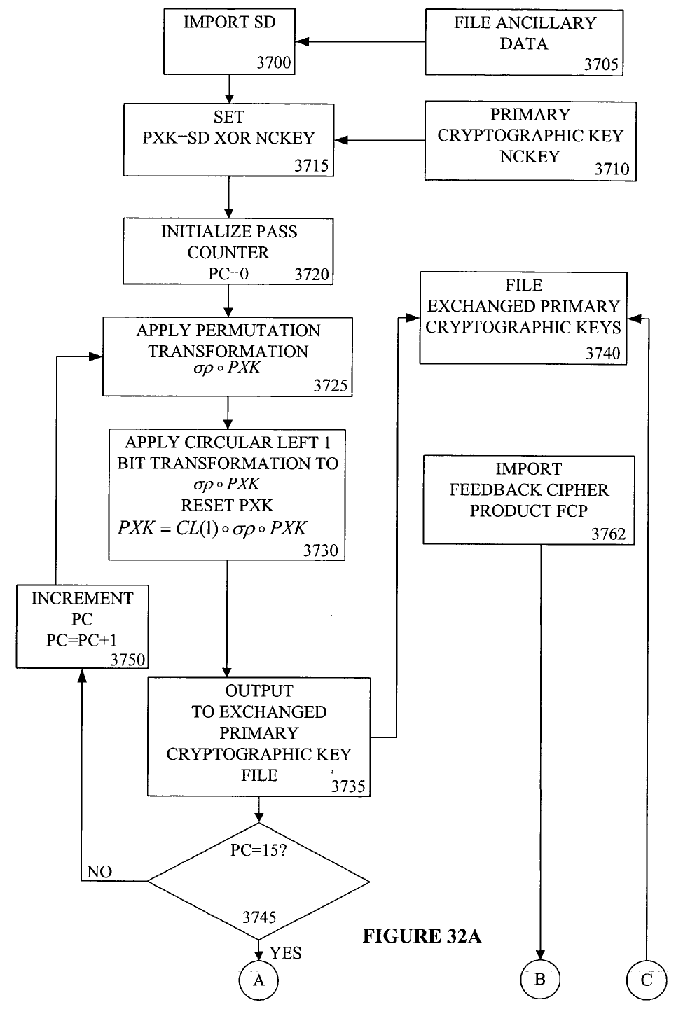

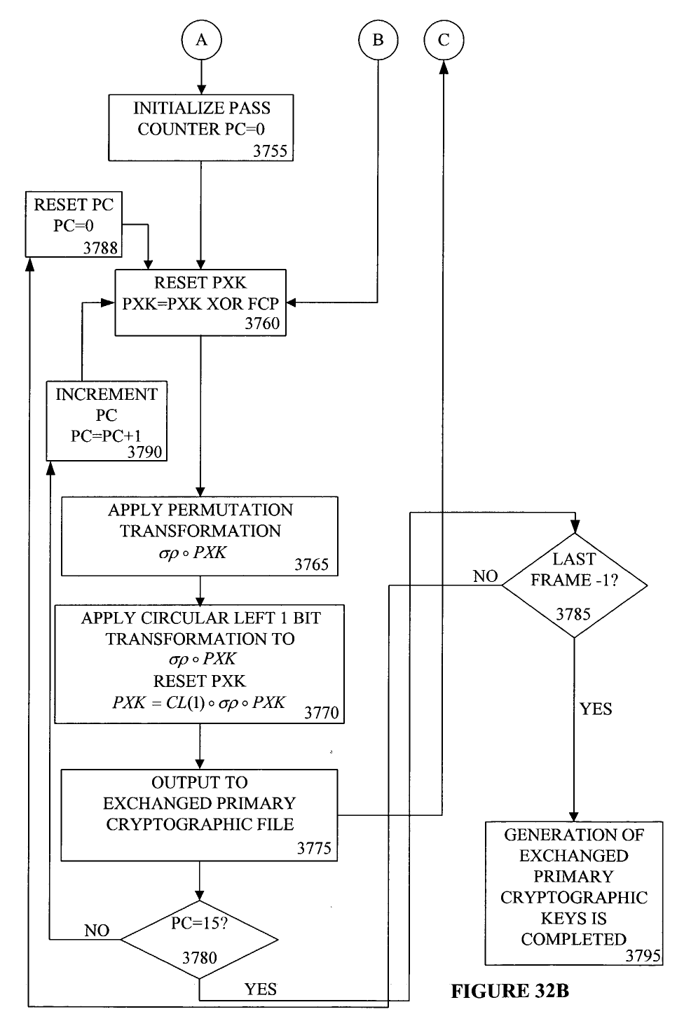

The next steps in the procedure are the protocols for the generation of exchanged cryptographic data for the both the primary cryptographic key and the ancillary cryptographic key. The discussion begins with the protocol for the primary cryptographic key, which is illustrated in a block diagram contained in FIGS. 32A and 32B.

As is illustrated by FIG. 32A, the first step in the generation of exchanged cryptographic keys for the primary cryptographic key is the importing of the seed data words 3700, SD, from the file of ancillary data 3705. The SD was a PAD

The first pass through the generation of exchanged primary cryptographic keys is unique. This means that subsequent passes through the procedure for the generation of exchanged primary cryptographic keys are substantially different. The detailed discussion of this procedure begins with the first or initial pass. SD is XORed 3715 with the primary cryptographic key 3710, NCKEY, to form the 128 bit data word PXK as is described in the following equation:

PXK=SD XOR NCKEY

The next step in the procedure is to initialize the counter for the pass for the generation of exchanged primary cryptographic keys. This is accomplished by setting the pass counter, PC, equal to zero 3720.

The next step in the procedure is to apply the permutation transformation σ_{P} 3725, which is described by the following equation:

$${σ}_{P} : {b}_{i} -> {c}_{j} , where j = k + [ ( int ( \frac{i}{8} ) + 3 ) mod16 ] * 8$$

$$\{ \begin{matrix}k = 0 ⇔ ( i mod 8 ) = 7 \\ k = 1 ⇔ ( i mod 8 ) = 6 \\ k = 2 ⇔ ( i mod 8 ) = 5 \\ k = 3 ⇔ ( i mod 8 ) = 4 \\ k = 4 ⇔ ( i mod 8 ) = 3 \\ k = 5 ⇔ ( i mod 8 ) = 2 \\ k = 6 ⇔ ( i mod 8 ) = 1 \\ k = 7 ⇔ ( i mod 8 ) = 0\end{matrix} \}$$

The next step in the procedure is to apply a left circular one-bit transformation 3730. This resultant is then an exchanged primary cryptographic key that is outputted 3735 to the file of exchanged primary cryptographic keys 3740. The next step is to procedure is to check if the pass counter, PC, is equal to 15 3745. If not then the pass counter is incremented by one 3750 and procedure continues 3725. If PC equals 15 then the initial pass through the generation of exchanged primary cryptographic keys is completed. In this case we proceed to the generation of the next succeeding passes through the generator of exchanged primary cryptographic keys.

As previously discussed, the first pass through the generation of exchanged primary cryptographic keys is different from all subsequent processing passes. The major difference is the use in passes subsequent to the first pass of feedback cipher products, which are denoted by FCP. In the primary encryption mode of clear text data, the frame length is exactly 40,960 bits. After the processing by the encryption engine, the last 128 bits of a 40,960-bit frame of data is the feedback cipher product. The 128 bits of enciphered data is sent from the cryptographic engine to the feedback cipher product data file for subsequent usage in the generation of exchanged primary cryptographic keys.

Referring to FIG. 32B, all passes through the generation of exchanged primary cryptographic keys after the first pass begin with the setting of the pass counter, PC, equal to zero 3755. The next step in the procedure is to retrieve FCP 3762 (FIG. 32A) and replace PXK with PXK XORed with FCP 3760, which is the previously discussed feedback cipher product. The permutation transformation, σ_{P}, is now applied to the above result 3765. The next step in the procedure is to apply a left circular one bit transformation 3770. This result is then filed in the file of exchanged primary cryptographic keys 3775. Then a check is made to determine if the number of passes, PC, equal 15 3780. If not then the pass counter PC is increment by one 3790 and this iterative procedure continues 3760. If PC=15, then a check is made to see if the number of frames is completed 3785. If yes the process is also concluded, then the generation of exchanged primary cryptographic keys is completed 3795. If the answer is no, then pass counter PC is reset to zero 3788 and another frame is processed 3760.

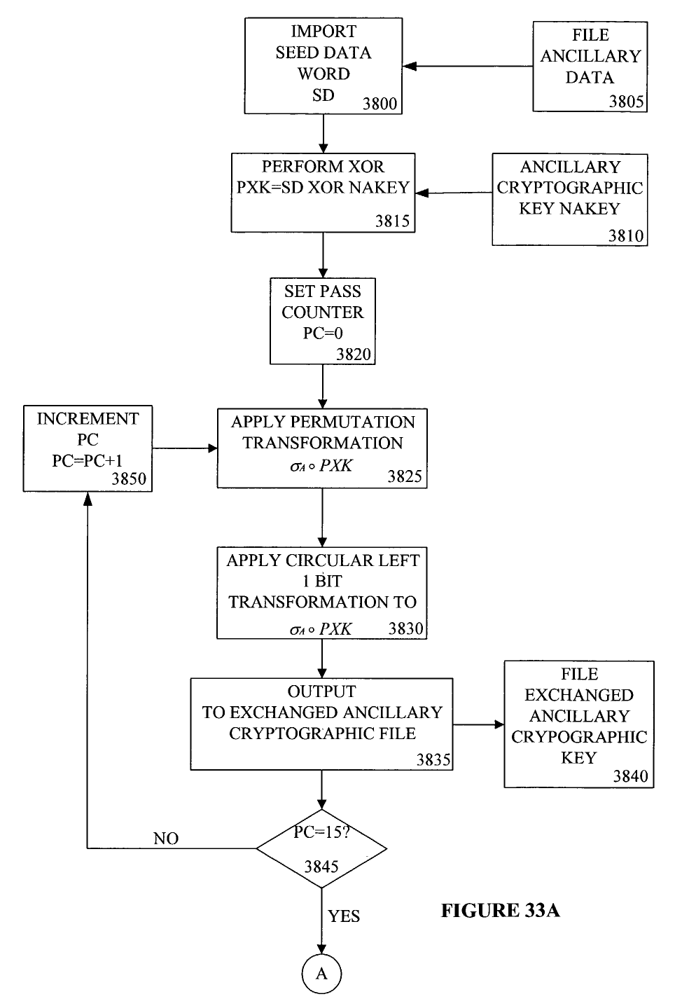

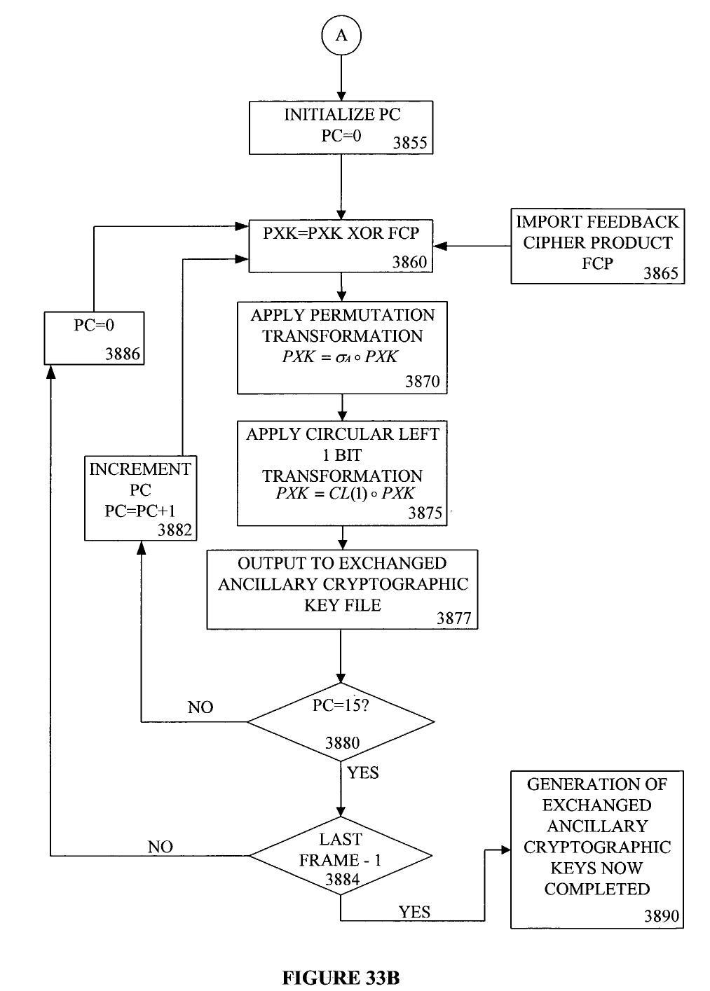

As is illustrated by FIG. 33A, the first step in the generation of exchanged cryptographic keys for the ancillary cryptographic key is the importing of the seed data word 3800, SD, from the file of ancillary data 3805.

The ancillary cryptographic key, NAKEY, is retrieved 3810. SD is then XORed with the ancillary cryptographic key, NAKEY, to form the 128 bit data word PXK 3815 as is described in the following equation:

PXK=SD XOR NAKEY

The next step in the procedure is to initialize the counter for the pass for the generation of exchanged primary cryptographic keys. This is accomplished by setting the pass counter, PC, equal to zero 3820.

The next step in the procedure is to apply the permutation transformation σ_{A} 3825, which is described by the following equation:

$${σ}_{A} : {b}_{i} -> {c}_{j} , where j = k + [ ( int ( \frac{i}{8} ) + 3 ) mod16 ] * 8$$

$$\{ \begin{matrix}k = 0 ⇔ ( i mod 8 ) = 7 \\ k = 1 ⇔ ( i mod 8 ) = 6 \\ k = 2 ⇔ ( i mod 8 ) = 5 \\ k = 3 ⇔ ( i mod 8 ) = 4 \\ k = 4 ⇔ ( i mod 8 ) = 3 \\ k = 5 ⇔ ( i mod 8 ) = 2 \\ k = 6 ⇔ ( i mod 8 ) = 1 \\ k = 7 ⇔ ( i mod 8 ) = 0\end{matrix} \}$$

The next step in the procedure is to apply a left circular one-bit transformation 3830. This resultant is then an exchanged ancillary cryptographic key that is outputted 3835 to the file of exchanged ancillary cryptographic keys 3840. The next step is to procedure is to check if the pass counter, PC, is equal to 15 3845. If not then the pass counter PC is incremented by one 3850 and the procedure continues 3825. If PC equals 15 then the initial pass through the generation of exchanged ancillary cryptographic keys is completed and the process continues with the generation of the next succeeding passes through the generator of exchanged ancillary cryptographic keys.

As previously discussed, the first pass through the generation of exchanged ancillary cryptographic keys is different from all subsequent processing passes. The major difference is the use in passes subsequent to the first pass of feedback cipher products, which are denoted by FCP. In the ancillary encryption mode of ancillary data, the frame length is exactly 2048 bits. After the processing by the encryption engine, the last 128 bits of a 2048 bit frame of data is the feedback cipher product. These 128 bits of enciphered data is sent from the ancillary encryption cryptographic engine to the feedback cipher product data file for subsequent usage in the generation of exchanged ancillary cryptographic keys.

Referring to FIG. 33B, all passes through the generation of exchanged ancillary cryptographic keys after the first pass begin with the setting of the pass counter, PC, equal to one 3855. The next step in the procedure is to import feedback cipher product FCP 3865 and replace PXK with PXK XORed with FCP 3860. The permutation transformation, σ_{A}, is now applied to the above result 3870. The next step in the procedure is to apply a left circular one bit transformation 3875. This result is then filed in the file of exchanged ancillary cryptographic keys 3877. Then a check is made to determine if the number of passes, PC, equal 15 3880. If not then the pass counter PC is incremented by one 3882 this iterative procedure continues 3860. If PC=15, then a check is made to see if the number of frames is completed 3884. If yes the process is also concluded, then the generation of exchanged ancillary cryptographic keys is completed 3890. If no, the pass counter is reset to zero 3886 and the process continues 3860.

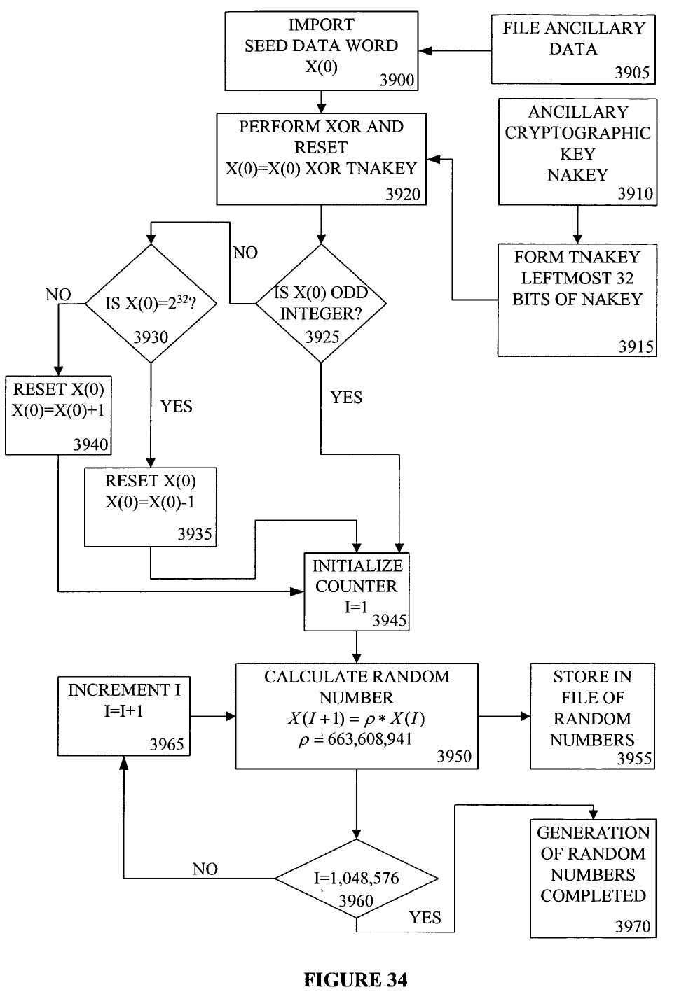

The next step in the exemplary embodiment is the generation of random numbers. A functional block diagram illustrating this process is provided in FIG. 34. The first step in the generation of random numbers is to import the seed data words, X(0) 3900, from the file of ancillary data 3905.

The ancillary cryptographic key 3910 is then used to form a partial cryptographic key 3915, which is denoted by TNAKEY. TNAKEY is formed by using only the leftmost 32 bits of NAKEY. This 32 bit word, TNAKEY, is then used in subsequent segments of the generation of random numbers.

The next step in the procedure is to XOR TNAKEY with X(0) 3920. This is described by the following equation:

X(0)=X(0)XOR TNAKEY

In this procedure it is required that X(0) is an odd integer. A check is made to determine if X(0) is an odd integer, ie not divisible by 2 3925. If this is the case then the processing continues. Otherwise, in the case that X(0) is an even integer, a modification is made to X(0) to make it an odd integer. First, a determination is made if X(0)=2³² 3930 and, if so, then X(0) is made an odd integer by simply subtracting one from its previous value 3935. If X(0) does not equal 2³², then X(0) is converted into an odd integer by simply adding one to its previous value 3940.

The next steps in the procedure involve the iterative computation of random numbers and the subsequent exporting of those numbers to a file for random numbers. The process begins by initializing the loop counter, I, to equal one 3945. Next the random number generator is used to compute the next random number 3950. This computation is given by the following equation:

X(I+1)=ρ*X(I)

where, ρ=663,608,94

The result is stored in the file of random numbers 3955.

Next a check is made to see if the number of iterations is complete. This is accomplished by checking to see if I=1,048,576 3960. If the answer is yes, then the generation of random numbers is completed 3970. If the answer is no, then the counter I is incremented by one 3965 and the iterative process continued 3950.

The route constructor is used in the encryption process of the present embodiment to develop parameters and specifications to select from the Lorenz strange attractors data for the hard encryption of incoming clear text data. A block diagram of the route constructor is illustrated in FIG. 16, which was described in detail above. To reiterate, the route constructor primarily consists of calculations and decisions required to develop data for the initialization of the Runge-Kutta numerical method of integration of the Lorenz system on nonlinear differential equations, which have as their solution space the Lorenz strange attractors.

The next step in the procedure is the Runge-Kutta method of numerical integration for the Lorenz system of nonlinear differential equations. The process beings by the inputting of the Lorenz system of nonlinear differential equations and the parameters σ, r, and b. These are supplied by the route constructor segment of the encryption process. The block diagram for this procedure is illustrated in FIG. 17, which was described in detail above.

This next step in the process is the generation of the route parameters. This process is illustrated in FIG. 18, which was described in detail above.

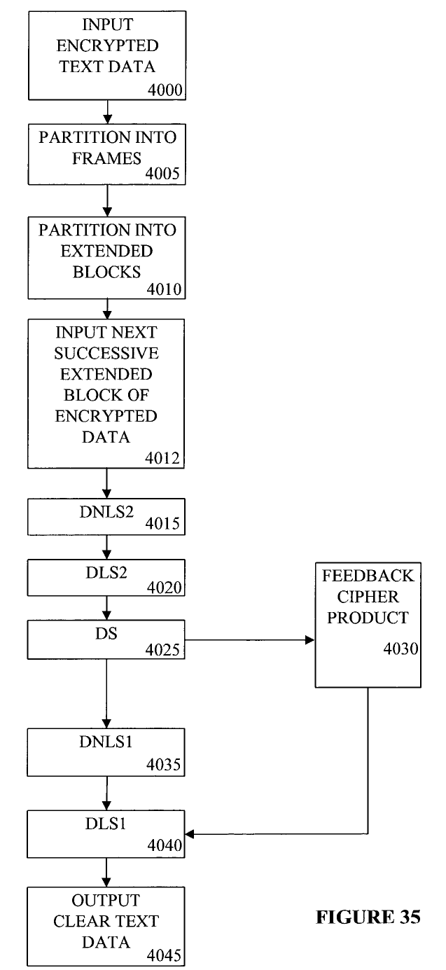

The next segment in the process of decryption is the decryption cryptographic engine, DS. A functional block diagram of DS is illustrated in FIG. 35. As shown there the main components consist of the following modules: input 4000 and partition of data into frames 4005 blocks 4010; DNLS2 4015; DLS2 4020; DS 4025; feedback cipher product 4030; DNLS1 4035, and DLS1 4040 and the output of clear text data 4045. The correspondence between the encryption mode components and the decryption mode components is called out in the following table.

| Encryption Mode | Decryption Mode |
|---|---|
| ELS1 | DLS1 |
| ENLS1 | DNLS1 |
| ES | DS |
| ELS2 | DLS2 |
| ENLS2 | DNLS2 |

Because decryption is the reverse of the encryption process, we reverse the order of the components during the decryption mode.

The first segments are concerned with the inputting and partitioning of data. The first step is to input the file of encrypted text data 4000.

The next step is to partition this data into frames of data 4005. Frames of data consist of 40,960 bits of data.

The next step in the procedure is to partition each encrypted frame of data into encrypted extended blocks of data 4010. This is accomplished by partitioning each encrypted frame of data into 2,560 bits of extended blocks of encrypted data.

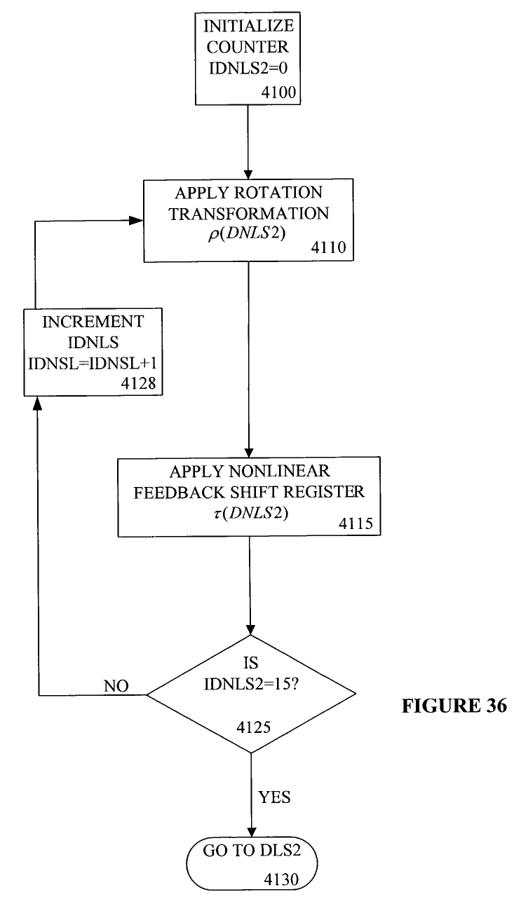

The next step is the initialization of the decryption cryptographic engine. This begins by the inputting of the next successive extended block of data 4012. The next segment in the decryption mode for the cryptographic engine is the module DNLS2 4015. This module is illustrated as a functional block diagram in FIG. 36. Referring to FIG. 36, the first step in the iterative procedure is to initialize the counter, IDNLS2. This is accomplished by setting IDNLS2=0 4100. The next step in DNLS2 is to apply the rotational transformation, ρ_{DNLS2} 4110.

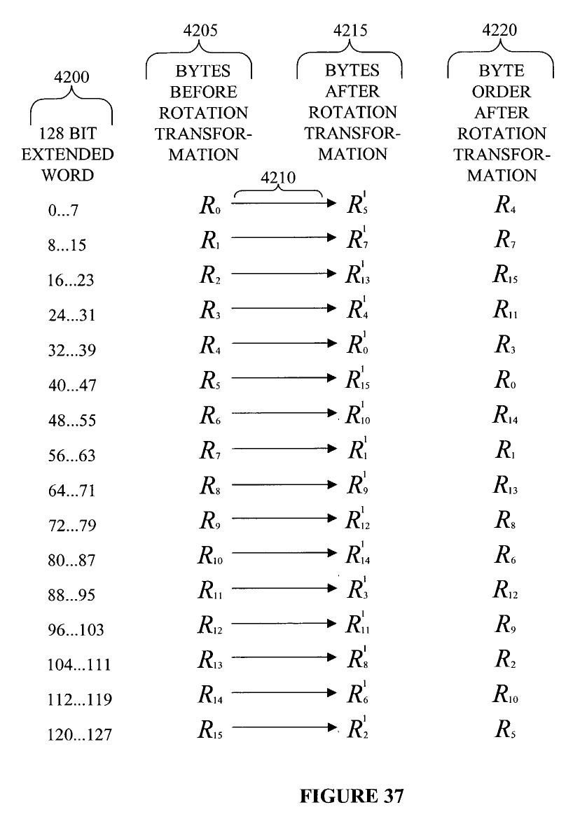

This rotational transformation is defined in detail illustrated in FIG. 37. Referring to FIG. 37, a 128-bit word 4200 comprises 16 8-bit words (each 1 byte) 4205. The rotation transformation is applied 4210 and the byte position after rotation, R′, is given 4215. The actual order of the bytes after rotation 4220 is also illustrated. The equation expressing this transformation is given below.

EXBD=ρ_{DNLS2}∘EEXBD

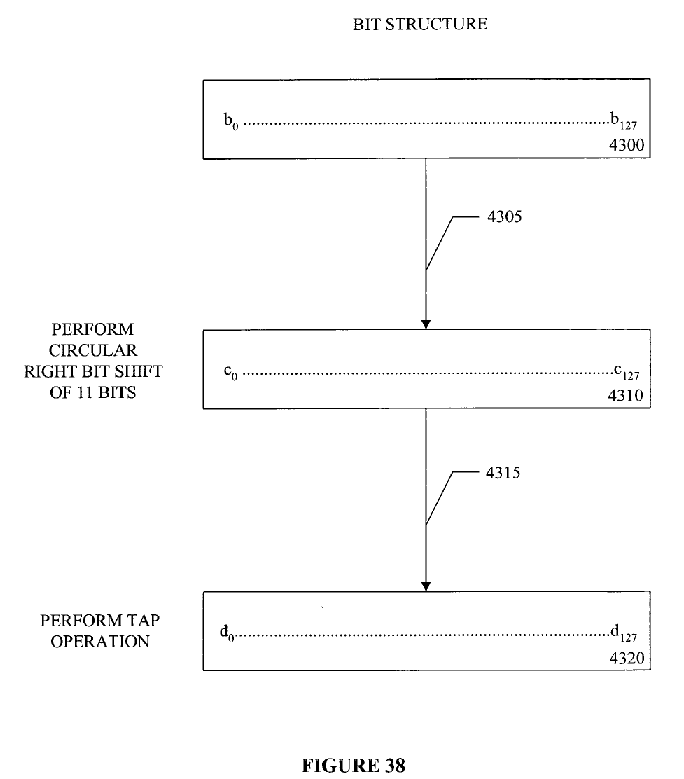

The next step in the procedure is to apply the nonlinear feedback shift register, τ_{DNSL2} 4115. This nonlinear feedback shift register is defined in detail in FIG. 38. Referring to FIG. 38, an incoming extended data word 4300 is operated on by a circular right shift operation 4305 to produce intermediate product 4310. The right circular shift operation is described by the following equations:

cᵢ=bᵢ+11i=0, . . . ,116

cᵢ=b₁₂₈₋₁₊₁₁i≧117

The intermediate product is then subjected to a tap operation 4315 producing a new word 4320. The tap operation is described by the following equations:

dᵢ=cᵢ if i≠7,43,117

d₇=c₇ XOR c₉

d₄₃=c₄₃ XOR c₃₉

d₁₁₇=c₁₁₇ XOR d₁₂₃

The equation expressing τ_{DNSL2} is given below.

EXBD=τ_{DNLS2}∘EXBD

Referring again to FIG. 36, the application τ_{DNSL2} continues. A check is made to determine if the iterative loop has completed processing. This is accomplished by checking if IDNLS2=15 4125. If the answer is yes, then the iterative loop for DNLS2 is complete and the processing continues with DLS2 4130. If the answer is no, then the counter IDNLS2 is incremented by one 4128 and the iterative processing continues 4100.

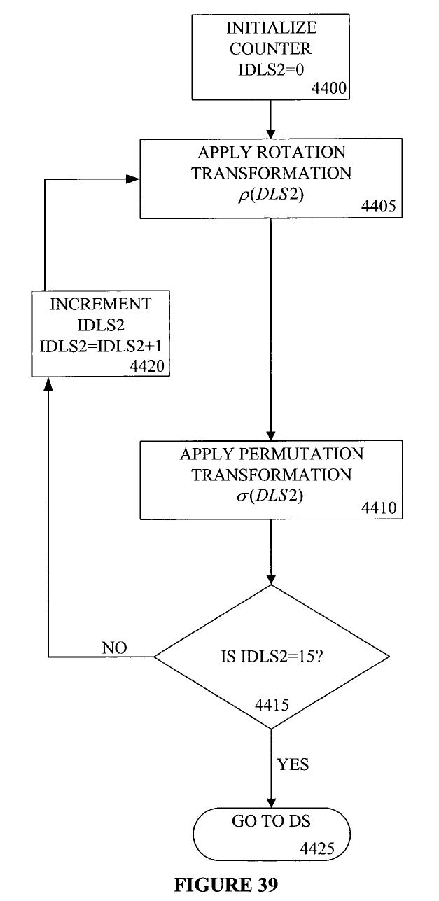

Referring again to FIG. 35, the next segment in the decryption mode for the cryptographic engine is the module DLS2 4020. An overview of the processing by this module is contained in FIG. 39.

Referring to FIG. 39, the processing is initiated by initializing the counter, IDLS2. This is accomplished by setting IDLS2=0 4400.

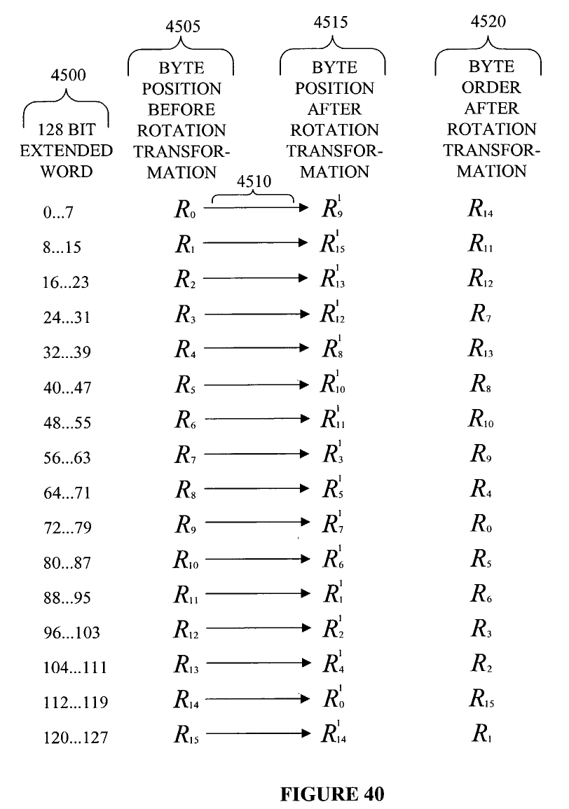

The next step in the procedure is to apply the rotational transformation, ρ_{DLS2} 4405. The detailed description of this rotational transformation is illustrated in FIG. 40. Referring to FIG. 40, a 128-bit word 4500 comprises 16 8-bit words (each 1 byte) 4505. The rotation transformation is applied 4510 and the byte position after rotation, R′, is given 4515. The actual order of the bytes after rotation 4520 is also illustrated. The transformation is called out in the following equation:

EXBD=ρ_{DLS2}∘EXBD

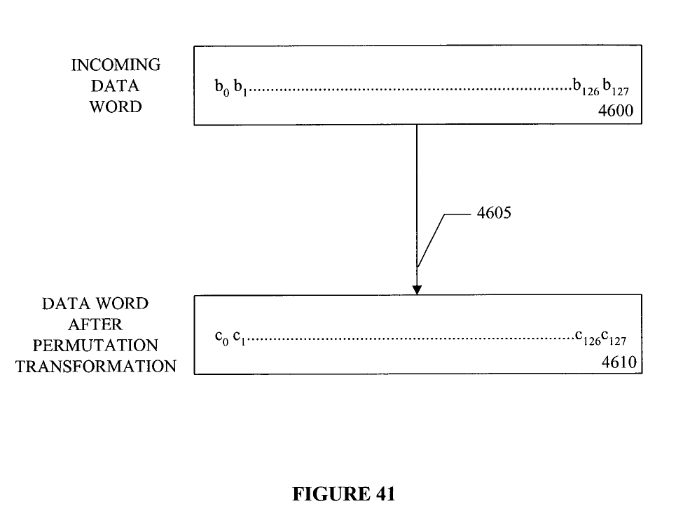

The next step in the procedure is to apply the permutation transformation, σ_{DLS2} 4410. The detailed description of this permutation transformation is illustrated FIG. 41. Referring to FIG. 41, an incoming data word 4600 is operated on by transformation σ_{DLS2} 4605 resulting in a new data word 4610. The transformation products are set forth below:

cᵢ=bᵢ₌₆₃ 0≦i≦15

cᵢ=bᵢ₋₆₃ 16≦i≦31

cᵢ=bᵢ₋₆₃ 32≦i≦47

cᵢ=bᵢ₋₆₃ 48≦i≦63

cᵢ=bᵢ₋₁₉₁ 64≦i≦79

cᵢ=bᵢ₋₁₉₁ 80≦i≦95

cᵢ=bᵢ₋₁₉₁ 96≦i<111

cᵢ=bᵢ₋₁₉₁ 112≦i≦127

The transformation is called out in the following equation:

EXBD=σ_{DLS2}∘EXBD

Next a check is made to determine if the iterative loop has completed processing. This is accomplished by checking if IDLS2=15 4415. If the answer is yes, then the iterative loop for DLS2 is complete and the processing continues with DS 4425. If the answer is no, then the counter IDLS2 is incremented by one 4420 and the iterative processing continues 4405

Referring again to FIG. 35, the next segment is to decrypt the output of DLS2 using the nonlinear cryptographic engine DS 4025. Because the decryption process must reverse the process originally used to encrypt the encrypted data, the decryption process can be illustrated by reference to FIG. 20 (which illustrated the encryption process). Referring to FIG. 20, the first step in the procedure is to initialize the frame counter, IFC. This is accomplished by setting IFC=0 2040.

The next step in the procedure is to import the next succeeding exchanged primary cryptographic key 2044, denoted by EXNCKEY, from the file of exchanged primary cryptographic keys 2042.

The next step in the procedure is to import the route parameters 2048 from file of route parameters 2046, which are given by the following equation:

{x(t),y(t),z(t)}

The next step in the procedure is to form an extended block version of the exchanged primary cryptographic key EXNCKEY 2050. This is accomplished through the concatenation of 20 copies of EXNCKEY.

The next step in the procedure is to form extended versions of the route parameters 2052. Here 128 values are concatenated to form the extended block version as is described by the following equation:

$$\{ \begin{matrix}EXX = ( x ( {t}_{1} ) , … , x ( {t}_{128} ) \\ EXY = ( y ( {t}_{1} ) , … , y ( {t}_{128} ) \\ EXZ = ( z ( {t}_{1} ) , … , z ( {t}_{128} )\end{matrix} \}$$

The next step in the procedure is to perform the nonlinear transformation 2054 given by the following equation:

EEXBD=EEXBD XOR EXNCKEY XOR EXX XOR EXY XOR EXZ

The next step in the procedure is to check to see if we are at then of a frame. This is accomplished by checking to see if IFC is greater than or equal to 12 2056. If the answer is yes, then the end of a frame of text data has been reached. If this is the, the now available feedback cipher product, FCP, is obtained 2088 and the calculation 2058 given by the following equation performed:

EEXBD=EEXBD XOR FCP

The frame counter, FCP, is then reset to 0 2060 and the processing continues 2062.

If the answer was no, that is IFC<16, then no computation or resetting is required and the processing continues 2062.

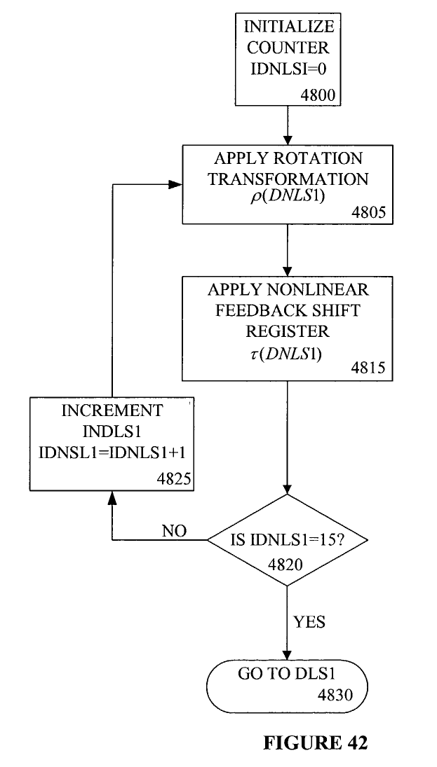

Referring again to FIG. 35, the next segment in the decryption process is to direct the output of DS to the DNSL1 module 4035. This module is described by the functional block diagram contained in FIG. 42. Referring to FIG. 42, the first step in the iterative procedure is to initialize the counter, IDNLS1. This is accomplished by setting IDNLS1=0 4800. The next step in DNLS1 is to apply the rotational transformation, ρ_{DNLS1} 4805.

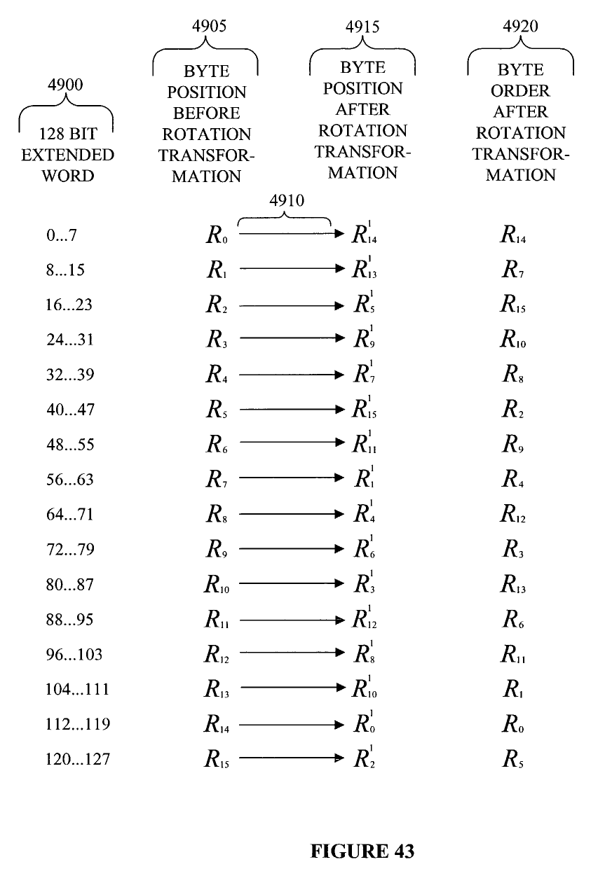

This rotational transformation is defined in detail in FIG. 43. Referring to FIG. 43, a 128-bit word 4900 comprises 16 8-bit words (each 1 byte) 4905. The rotation transformation is applied 4910 and the byte position after rotation, R′, is given 4915. The actual order of the bytes after rotation 4920 is also illustrated. The equation expressing this transformation is given below:

EXBD=ρ_{DNLS1}∘EXBD

Referring again to FIG. 42, the next step in the procedure is to apply the nonlinear feedback shift register, ρ_{DNSL1} 4815.

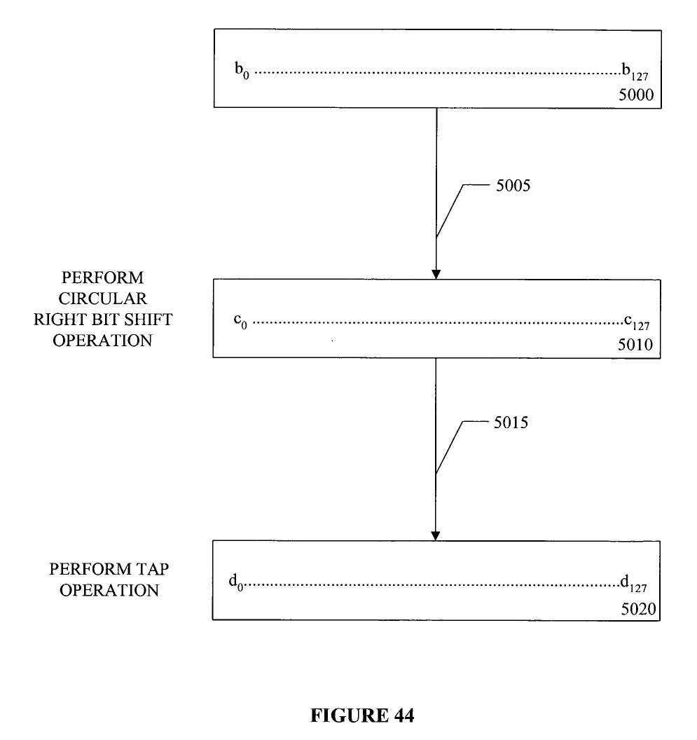

This nonlinear feedback shift register is defined in detail in FIG. 44. Referring to FIG. 44, an incoming extended data word 5000 is operated on by a circular right shift operation 5005 to produce intermediate product 5010. The right circular shift operation is described by the following equations:

cᵢ=bᵢ₋₇ for i=7, . . . ,127

cᵢ=b₁₂₇₋ᵢ₊₁ for i=0, . . . 6

The intermediate product is then subjected to a tap operation 5015 producing a new word 5020. The tap operation is described by the following equations:

d₃=c₃ˆ c₇

d₃₇=c₃₇ˆ c₄₃

d₉₃=c₉₃ˆ c₉₁

dᵢ=cᵢ all i≠3,37,93

The equation expressing ρ_{DNSL1} is given below.

EXBD=τ_{DNLS1}∘EXBD

Next a check is made to determine if the iterative loop has completed processing. This is accomplished by checking if IDNLS1=15 4820. If the answer is yes, then the iterative loop for DNLS1 is complete and the processing continues with DLS1 4830. If the answer is no, then the counter IDNLS1 is incremented by one 4825 and the iterative processing continues 4805.

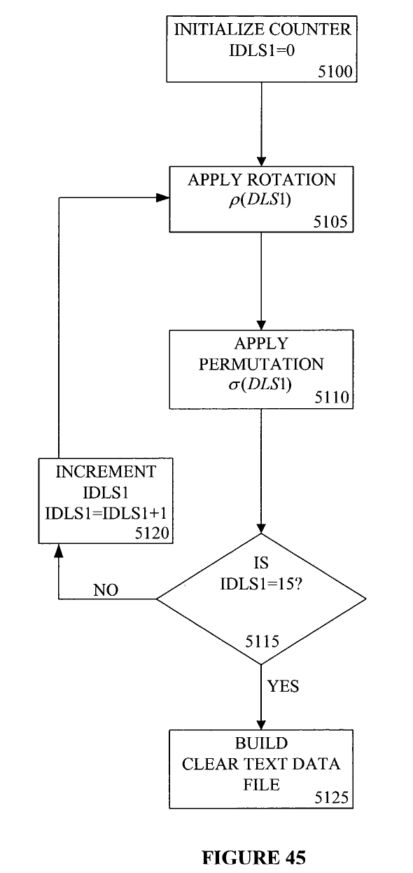

Referring again to FIG. 35, the next segment in the decryption mode for the cryptographic engine is the module DLS1 4040. An overview of the processing by this module is contained in FIG. 45.

Referring to FIG. 45, the processing is initiated by initializing the counter, IDLS1. This is accomplished by setting IDLS1=0 5100.

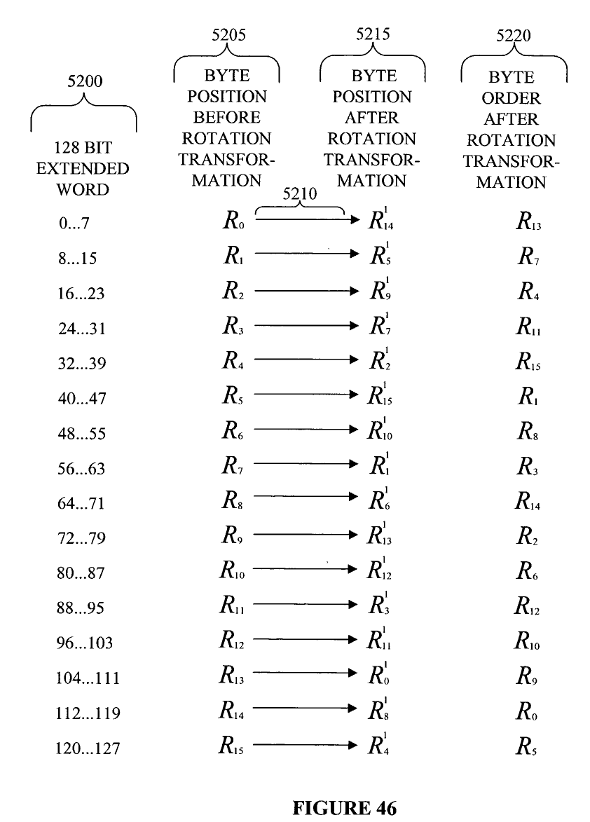

The next step in the procedure is to apply the rotational transformation, ρ_{DLS1} 5105. The detailed description of this rotational transformation is contained in FIG. 46.

Referring to FIG. 46, a 128-bit word 5200 comprises 16 8-bit words (each 1 byte) 5205. The rotation transformation is applied 5210 and the byte position after rotation, R′, is given 5215. The actual order of the bytes after rotation 5220 is also illustrated. The transformation is called out in the following equation:

EXBD=ρ_{DLS1}∘EXBD

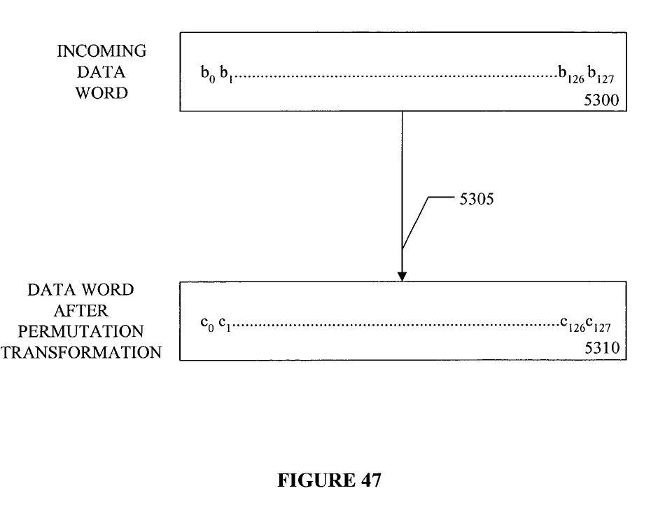

Referring again to FIG. 45, the next step in the procedure is to apply the permutation transformation, σ_{DLS1} 5110. This permutation transformation is illustrated in FIG. 47.

Referring to FIG. 47, an incoming data word 5300 is operated on by transformation σ_{DLS1} 5305 resulting in a new data word 5310. The transformation products are set forth below:

cᵢ=bᵢ₋₁₅ 0≦i≦15

ci=bᵢ₋₄₇ 16≦i≦31

ci=bᵢ₋₇₉ 32≦i≦47

ci=bᵢ₋₁₁₁ 48≦i≦63

ci=bᵢ₋₁₄₃ 64≦i≦79

ci=bᵢ₋₁₇₅ 80≦i≦95

ci=bᵢ₋₂₀₇ 96≦i≦111

ci=bᵢ₋₂₃₉ 112≦i≦127

The transformation is called out in the following equation:

EXBD=σ_{DLS1}∘EXBD

Referring again to FIG. 45, a check is made to determine if the iterative loop has completed processing. This is accomplished by checking if IDLS1=15 5115. If the answer is yes, then the iterative loop for DLS1 is complete and the processing continues with the building of a clear text file 5125. If the answer is no, then the counter IDLS1 is incremented by one 5120 and the iterative processing continues 5105.

This completes the decryption of the exemplary decryption embodiment. Referring again to FIG. 35, the last step in the process is to output the clear text data 4045.

A non-algebraic method of encrypting and decrypting data has now been illustrated. As described herein, the non-algebraic method of encrypting and decrypting provides low entropy and extremely fast decrypting speeds making the present invention suitable for wideband data applications. It will be understood by those skilled in the art of the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. A method of encrypting data utilizing an encryption key, the method comprising:
determining a solution space of a nonlinear equation, the nonlinear equation having as a solution space an attractor;
constructing a route along a trajectory of the attractor;
determining the intersection coordinates of the route and the attractor; and
applying a logical arithmetic operation to the data, the encryption key, and the intersection coordinates so as to produce cipher text data.

2. The method according to claim 1 wherein the nonlinear equation is selected from the group consisting of nonlinear differential equations, nonlinear partial differential equations and nonlinear difference equations.

3. The method according to claim 1 wherein the attractor is selected from the group consisting of Rossler attractors, Hernon attractors, and Lorenz strange attractors.

4. The method according to claim 1 wherein the solution space of the differential equation is determined using a numerical integration technique.

5. The method according to claim 4 wherein the numerical integration technique is selected from the group consisting of Runge-Kutta, Euler, and Heun.

6. The method according to claim 1 wherein the logical arithmetic operation comprises XORing the encryption key, the data, and the intersection coordinates.

7. The method according to claim 1 wherein the encryption key is selected from a file of exchanged encryption keys.

8. The method according to claim 1 wherein the data is a block of digital data.

9. The method according to claim 8 wherein the length of the block of digital data is greater than the length of the encryption key.

10. The method according to claim 1 further comprising:
prior to applying the at least one logical arithmetic operation to the data, the encryption key and the coordinates to produce cipher text of the data, applying at least one smoothing function to the data.

11. The method according to claim 10 wherein the at least one smoothing function comprises a linear smoothing operation.

12. The method according to claim 10 wherein the at least one smoothing function comprises a nonlinear smoothing operation.

13. The method according to claim 1 further comprising after applying the at least one logical arithmetic operation to the data, the encryption key and the coordinates to produce cipher text of the data, applying at least one smoothing function to the cipher data.

14. The method according to claim 13 wherein the at least one smoothing function comprises a linear smoothing operation.

15. The method according to claim 13 wherein the at least one smoothing function comprises a nonlinear smoothing operation.

16. A method of decrypting cipher text data that has been encrypted using an encryption process that utilizes an encryption key and intersection coordinates between a route and an attractor, the attractor being a solution space of a nonlinear equation, the route having been constructed along a trajectory of the attractor, the method comprising:
receiving the cipher text data;
obtaining the intersection coordinates;
applying a decrypt logical arithmetic operation to the cipher text data, the encryption key and the intersection coordinates, wherein the decrypt logical arithmetic operation reverses an encrypt logical arithmetic operation according to which the cipher text data was produced.

17. The method of claim 16, wherein the obtaining of the intersection coordinates is effected by receiving the intersection coordinates.

18. The method of claim 16, wherein the obtaining of the intersection coordinates is effected based on received seed data.

19. A system for sending and receiving data comprising:
a customer device interface adapted to connect to a customer device;
a communication interface adapted to connect to a communication channel;
a cryptographic module connected between the customer device interface and the communication interface, the cryptographic module comprising:
an encryption processor bearing software instructions adapted to enable the encryption processor to:
receive clear text data from the customer device interface;
apply an encrypt logical arithmetic operation to the clear text data, an encryption key, and intersection coordinates between a route and an attractor, the attractor being a solution space of a nonlinear equation, the route having been constructed along a trajectory of the attractor the intersection coordinates, so as to produce cipher text data from the clear text data; and
send the cypher text data to the channel interface;
a decryption processor bearing software instructions adapted to enable the encryption processor to:
receive cypher text data from the communication interface;
apply a decrypt logical arithmetic operation to the cipher text data, the encryption key and the intersection coordinates, wherein the decrypt logical arithmetic operation reverses the encrypt logical arithmetic operation according to which the cipher text data was produced so as to produce clear text data; and
send the clear text data to the customer device interface.

20. The system in accordance with claim 19 wherein the channel to which the communications interface is adapted is selected from the group consisting of a point-to-point connection, a wired network, a wireless network, a cable network, a satellite network, and a hybrid network.

21. The system in accordance with claim 19 wherein the communications interface comprises a modem and the network comprises the public switched telephone network.

22. The system in accordance with claim 19 wherein the communications interface comprises a cable modem and the network comprises a cable network.

23. The system in accordance with claim 19 wherein the communications interface comprises a firewall and the customer device interface comprises a network interface card.

24. A system for decrypting cipher text data that has been encrypted using an encryption process that utilizes an encryption key and intersection coordinates between a route and an attractor, the attractor being a solution space of a nonlinear equation, the route having been constructed along a trajectory of the attractor, the system comprising:
a customer device interface adapted to connect to a customer device;
a media interface adapted to read tangible media bearing the cypher text data;
a decrypt processor connected between the customer device interface and the media interface, the decrypt processor bearing software instructions adapted to enable the decrypt processor to:
receive cypher text data from the media interface;
apply a decrypt logical arithmetic operation to the cipher text data, the encryption key and the intersection coordinates, wherein the decrypt logical arithmetic operation reverses the encrypt logical arithmetic operation according to which the cipher text data was produced so as to produce clear text data; and
send the clear text data to the customer device interface.

25. The system of claim 24, wherein the obtaining of the intersection coordinates is effected by receiving the intersection coordinates.

26. The system of claim 24, wherein the obtaining of the intersection coordinates is effected based on received seed data.

27. The system of claim 24, wherein the tangible media is a DVD and the media interface is a DVD reader.

28. A method of securing data comprising an encryption process and decryption process, wherein the encryption process comprises:
selecting an encryption key;
selecting a nonlinear equation having as a solution space an attractor;
determining a solution space of the nonlinear equation;
constructing a route along a trajectory of the attractor;
determining the intersection coordinates of the route and the attractor;
storing the nonlinear equation, the solution space of the nonlinear equation, the route, and the intersection coordinates in an ancillary data file;
applying to the data, the encryption key and the coordinates data a first logical arithmetic operation to produce cipher text; and
wherein the decryption process comprises:
obtaining the cipher text data;
obtaining the encryption key;
obtaining the intersection coordinates from the ancillary data file; and
applying to the cipher text data, the encryption key and the coordinates a second logical arithmetic operation to produce clear text data, wherein a logical arithmetic operation reverses the first logical operation.

29. The method according to claim 28 wherein the nonlinear equation is selected from the group consisting of nonlinear differential equations, nonlinear partial differential equations and nonlinear difference equations.

30. The method according to claim 28 wherein the solution space of the differential equation is determined using a numerical integration technique.

31. The method according to claim 28 wherein the encryption process further comprises generating a file of exchanged encryption keys using a key exchange protocol, and saving the key exchange protocol in the ancillary data file, and wherein the decryption process further comprises obtaining the key exchange protocol from the ancillary data file, generating a list of exchanged encryption keys, and acquiring the encryption key from the list of exchanged encryption keys.

32. The method according to claim 28 wherein the data is a block of digital data.

33. The method according to claim 28 wherein the length of the block of digital data is greater than the length of the encryption key.

34. The method according to claim 28 wherein the encryption process further comprises applying a first smoothing process to the data prior to applying the first logical arithmetic operation and applying a second smoothing process after applying the first logical arithmetic operation and wherein the decryption process further comprises applying the second smoothing process prior to applying the second logical arithmetic operation and applying the first smoothing process after applying the logical arithmetic operation.

35. The method according to claim 34 wherein as to the encryption process the first and second smoothing operations each comprise a linear smoothing operation followed by a nonlinear smooth operation and wherein as to the decryption process the first and second smoothing operations each comprise a nonlinear smoothing operation followed by a linear smoothing operation.

36. The method according to claim 28 where in selecting an encryption key, selecting a nonlinear equation having as a solution space an attractor, determining a solution space of the nonlinear equation, constructing a route along a trajectory of the attractor, and determining the intersection coordinates of the route and the attractor occurs in advance of applying to the data, the encryption key and the coordinates data a first logical arithmetic operation to produce cipher text.
